(19) United States
(12) Patent Application Publication
(10) Pub. No.: US 2016/0171540 A1
(43) Pub. Date: Jun. 16, 2016

(54) Dynamic Omnichannel Relevant Content And Services Targeting In Real Time

(71) Applicants: Suryanarayana Mangipudi, Fremont, CA (US); Baskaran Manivannan, Fremont, CA (US)

(72) Inventors: Suryanarayana Mangipudi, Fremont, CA (US); Baskaran Manivannan, Fremont, CA (US)

(21) Appl. No.: 14/692,741

(22) Filed: Apr. 22, 2015

Related U.S. Application Data
(60) Provisional application No. 62/091,008, filed on Dec. 12, 2014.

(51) Int. Cl. G06Q 30/02

(52) U.S. Cl. CPC G06Q 30/0255; G06Q 30/0261; G06Q 30/0269

(57) ABSTRACT

A computer implemented method and a content determination and targeting system (CDTS) dynamically target time, event and inventory based, location-specific, and behavior relevant content and services to users in an omnichannel environment. The CDTS identifies target users using user characteristic information, item information, and event information received from information sources. The CDTS determines a target item based on each item's item relevancy score and item relevancy priority generated based on an analysis of the user characteristic information, the item information, the event information, user intent dimensions, user interest dimensions, and global interest dimensions. The CDTS generates and targets relevant content associated with the target item and service information to the identified target users based on recommendations dynamically generated based on a content relevancy score, a content relevancy priority, targeting triggers, and the analysis of the user characteristic information, the item information, and the event information using content selection parameters.

### CROSS-REFERENCE TO RELATED APPLICATIONS

This application claims priority to and the benefit of provisional patent application No. 62/091,008 titled “Real-time micro-location targeting across Omni Channel with personalized and relevant contents in the context of time and location based on customer behavioral & interest data with data coming POS, Mobile, Online, Inventory, Customer Support and Social channels”, filed in the United States Patent and Trademark Office on Dec. 12, 2014. The specification of the above referenced patent application is incorporated herein by reference in its entirety.

### BACKGROUND

Businesses depend on promotions, offers, and delivery, for example, of generic videos, recipe videos, service content, etc., in various forms to increase their sales and revenue and also to create a long lasting impact in public memory. Offering relevant products and services is becoming increasingly significant for companies to allow them to effectively attract and retain customers. A significant challenge that a company faces is to present customers with relevant advertising and promotional content that will interest the customers sufficiently based on their recent or current interests to make the customers purchase their products and/or services. Most of the time, the presented advertising and promotional content is either generic or irrelevant, and hence, is ineffective in capturing a customer's attention towards the products or services advertised.

Companies typically face decision complexity in effectively determining which of their products and services should be offered to customers. Invisibility of interests and shopping preferences of customers leads to ineffective marketing and merchandising strategies. Despite current advancements in the field of content targeting, most commerce analytic data warehouses fail to provide companies with the ability to determine and launch high performance campaigns by effectively determining what to offer fickle minded customers and the means of targeting them based on their interests and preferences. Marketers prefer targeted advertisements because they reach specific customers, thereby eliminating wastage of resources and increasing advertising efficiency. Some conventional targeting methods target advertising content which are pre-calculated and analyzed weeks and months in advance. However, these conventional targeting methods do not take into account recent customer interests and behaviors. These conventional targeting methods do not generate advertising content which reflect customers' recent interests.

Moreover, most of the conventional targeting solutions are provided by search and advertising networks which have a limited view of customer characteristics and depend mostly on online behavior. Furthermore, these targeting solutions do not work efficiently for retail stores, grocery stores, and other stores that have a low online presence and also do not provide sufficient control to merchants for running their day to day campaigns and operations.

Hence, there is a long felt but unresolved need for a computer implemented method and system that dynamically targets time, event and inventory based, location-specific, and behavior relevant content and services to users in an omnichannel environment. Moreover, there is a need for a computer implemented method and system that provides personalized and relevant content and services in which a user, for example, a customer is currently interested and shows recent intent on purchasing. Furthermore, there is a need for a computer implemented method and system that determines relevant content and services for advertising and promotion of products and services, for example, based on past purchases, recent customer interests, current intent across various commerce channels such as social media, etc., and for targeting relevant content and services to customers at the right time, for example, based on events, place, time, location, etc. Furthermore, there is a need for a computer implemented method and system that provides a wide view of customer characteristics to provide sufficient control to merchants for running their day to day campaigns and operations.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above mentioned need for dynamically targeting time, event and inventory based, location-specific, and behavior relevant content and services to users in an omnichannel environment. Moreover, the computer implemented method and system disclosed herein provides personalized and relevant content and services in which a user, for example, a customer is currently interested and/or shows recent intent on purchasing. Furthermore, the computer implemented method and system disclosed herein determines relevant content and services for advertising and promotion of products and services, for example, based on past purchases, recent customer interests, current intent across various commerce channels such as social media platforms, etc., and for targeting relevant content and services to customers at the right time, for example, based on events, place, time, location, etc. Furthermore, the computer implemented method and system disclosed herein provides a wide view of customer characteristics to provide sufficient control to merchants for running their day to day campaigns and operations.

The computer implemented method disclosed herein employs a content determination and targeting system comprising at least one processor configured to execute computer program instructions for dynamically targeting time, event and inventory based, location-specific, and behavior relevant content and services to users in an omnichannel environment. The content determination and targeting system dynamically receives user characteristic information, item information of multiple items engaged by the users, and event information from multiple information sources in the omnichannel environment. The content determination and targeting system identifies one or more target users for dynamically targeting the time, event and inventory based, location-specific, and behavior relevant content and services using the dynamically received user characteristic information, the item information, and the event information. The content determination and targeting system analyzes the dynamically received user characteristic information, the item information, and the event information using one or more of multiple analytical parameters. The content determination and targeting system determines user intent dimensions, user interest dimensions, and global interest dimensions based on the analysis of the dynamically received user characteristic information, the item information, and the event information. The content determination and targeting system generates an item relevancy score and an item relevancy priority for each item based on the analysis of the dynamically received user characteristic information, the item information, the event information, the determined user intent dimensions, the determined user interest dimensions, and the determined global interest dimensions. The content determination and targeting system determines a target item for dynamically targeting the time, event and inventory based, location-specific, and behavior relevant content and services to the identified target users based on the generated item relevancy score and the generated item relevancy priority of each item.

The content determination and targeting system generates and associates relevant content with the determined target item and determines service information of multiple services to be provided to the identified target users, in communication with one or more of multiple content sources. The content determination and targeting system generates a content relevancy score and a content relevancy priority for the generated relevant content associated with the determined target item based on the analysis of the dynamically received user characteristic information, the item information, the event information, the determined user intent dimensions, the determined user interest dimensions, and the determined global interest dimensions. The content determination and targeting system dynamically generates recommendations for dynamically targeting the generated relevant content associated with the determined target item and the determined service information of the services to the identified target users based on the generated content relevancy score, the generated content relevancy priority, one or more of multiple targeting triggers, and the analysis of the dynamically received user characteristic information, the item information, and the event information using one or more of multiple content selection parameters. The content determination and targeting system dynamically targets the generated relevant content associated with the determined target item and the determined service information of the services to the identified target users in the omnichannel environment based on the dynamically generated recommendations.

In one or more embodiments, related systems include but are not limited to circuitry and/or programming for effecting the methods referenced herein; the circuitry and/or programming can be any combination of hardware, software, and/or firmware configured to effect the herein-referenced methods depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIGS. 1A-1B exemplarily illustrate a computer implemented method for dynamically targeting time, event and inventory based, location-specific, and behavior relevant content and services to users in an omnichannel environment.

FIG. 2 exemplarily illustrates a flow diagram showing collection of user feedback for determination of user intent by a content determination and targeting system.

FIG. 3 exemplarily illustrates a flow diagram showing steps performed by the content determination and targeting system for extracting data elements from user characteristic information, item information, and event information received from point of sale databases.

FIG. 4 exemplarily illustrates a flow diagram showing steps of an analysis of point of sale data received from point of sale databases by the content determination and targeting system.

FIG. 5 exemplarily illustrates a flow diagram showing steps performed by the content determination and targeting system for determining user intent for an item.

FIG. 6 exemplarily illustrates a flow diagram showing steps performed by the content determination and targeting system for determining user interest towards items.

FIG. 7 exemplarily illustrates a flow diagram showing steps of time series forecasting performed by the content determination and targeting system.

FIG. 8 exemplarily illustrates a flow diagram showing steps of a collaborative probability analysis performed by the content determination and targeting system.

FIG. 9 exemplarily illustrates a flow diagram showing steps of a discretionary or non-discretionary analysis performed by the content determination and targeting system for determining spending habits of users.

FIG. 10 exemplarily illustrates a flow diagram showing steps of a lifetime analysis of an item, performed by the content determination and targeting system for determining a future need of a user for the same item or for similar items.

FIG. 11 exemplarily illustrates a flow diagram showing steps performed by the content determination and targeting system for generating an association between an item and relevant content and generating recommendations for targeting the relevant content associated with the item and services to one or more target users.

FIG. 12 exemplarily illustrates a flow diagram showing steps performed by an item resolver of the content determination and targeting system for generating associations between items and relevant content.

FIG. 13 exemplarily illustrates a flow diagram showing steps performed by the content determination and targeting system for recommending relevant content and services to one or more target users.

FIG. 14 exemplarily illustrates a flow diagram showing steps performed by the content determination and targeting system for dynamically targeting time, event and inventory based, location-specific, and behavior relevant content and services to users in an omnichannel environment.

FIG. 15 exemplarily illustrates a flow diagram showing steps performed by the content determination and targeting system for generating and enriching relevant content and associating the generated relevant content with an item.

FIG. 16 exemplarily illustrates a flow diagram showing steps performed by the content determination and targeting system for receiving and analyzing user characteristic information, item information, and event information from multiple different information sources for identifying and targeting relevant content and services to users in real time in an omnichannel environment.

FIG. 17 exemplarily illustrates a flow diagram showing steps performed by the content determination and targeting system for analyzing user characteristic information, item information, and event information.

FIG. 18 exemplarily illustrates a flow diagram showing a recommendation and targeting stage of the computer implemented method for dynamically targeting time, event and inventory based, location-specific, and behavior relevant content and services to users in an omnichannel environment.

FIG. 19 exemplarily illustrates a merchant data model.

FIG. 20 exemplarily illustrates an identity management data model.

FIG. 21 exemplarily illustrates an item catalog.

FIG. 22 exemplarily illustrates a point of sale data model.

FIGS. 23-24 exemplarily illustrate point of sale intelligence data models.

FIG. 25 exemplarily illustrates a content data model.

FIG. 26 exemplarily illustrates a content relevancy data model.

FIG. 27 exemplarily illustrates a targeting data model.

FIG. 28 exemplarily illustrates a digital intelligence data model.

FIG. 29 exemplarily illustrates a computer implemented system for dynamically targeting time, event and inventory based, location-specific, and behavior relevant content and services to users in an omnichannel environment.

FIG. 30 exemplarily illustrates an implementation of the hardware architecture of the content determination and targeting system employed for dynamically targeting time, event and inventory based, location-specific, and behavior relevant content and services to users in an omnichannel environment.

FIG. 31 exemplarily illustrates the hardware architecture of the content determination and targeting system employed for dynamically targeting time, event and inventory based, location-specific, and behavior relevant content and services to users in an omnichannel environment.

FIG. 32 exemplarily illustrates dynamic targeting of relevant content and services by the content determination and targeting system to a target user in a merchant store.

FIGS. 33A-33B exemplarily illustrate dynamic targeting of messages by the content determination and targeting system to a user in a merchant store.

FIG. 34 exemplarily illustrates dynamic targeting of relevant content and services by the content determination and targeting system to users to encourage a visit to merchant stores in their vicinity.

FIG. 35 exemplarily illustrates an implementation of the content determination and targeting system for encouraging users to purchase items recommended in the relevant content targeted to the users.

### DETAILED DESCRIPTION OF THE INVENTION

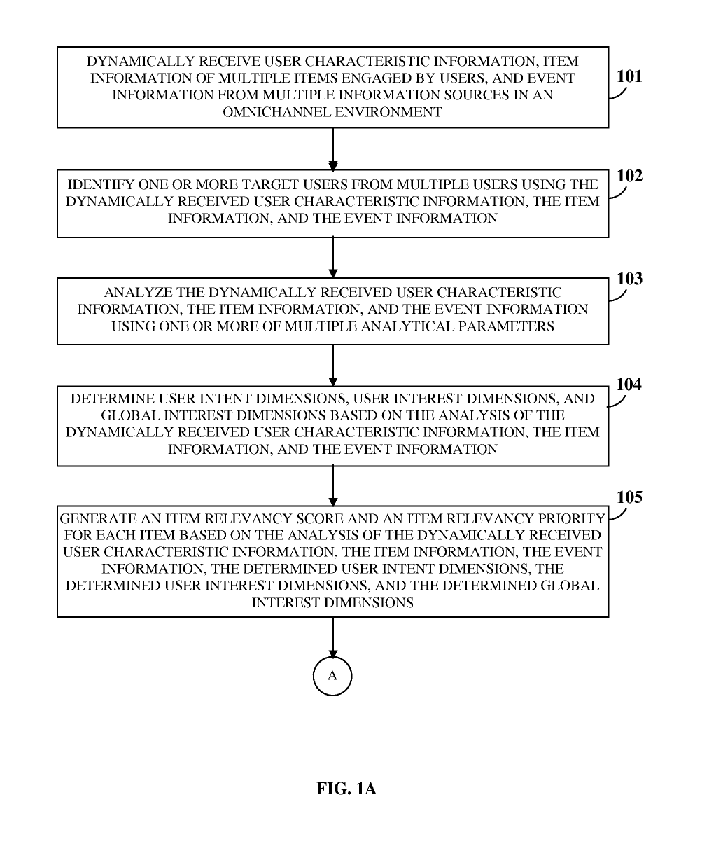

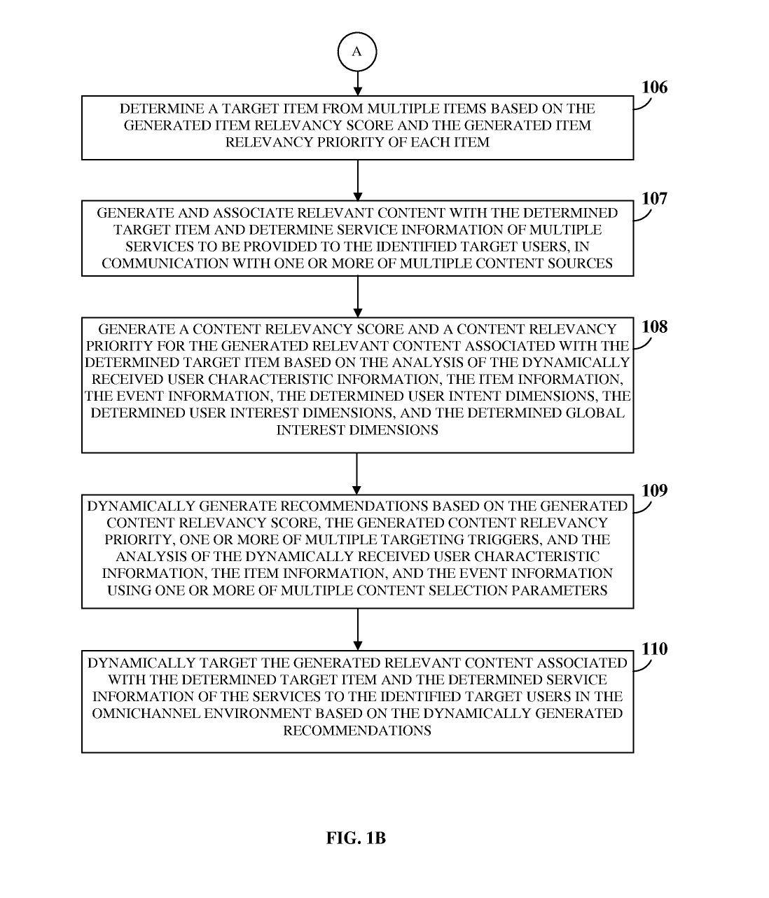

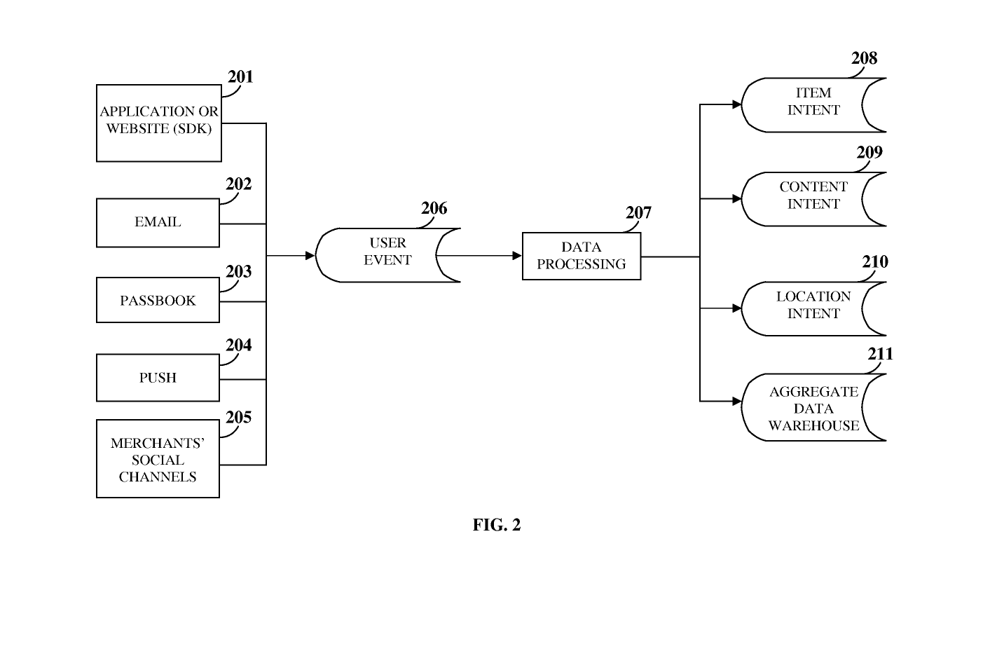

FIGS. 1A-1B exemplarily illustrate a computer implemented method for dynamically targeting time, event and inventory based, location-specific, and behavior relevant content and services to users in an omnichannel environment. As used herein, the term “content” refers to information associated with items such as products and/or services. The content comprises, for example, item information, advertisements, offers, promotional information, videos, etc., associated with multiple items. As used herein, the term “items” refers to products and/or services provided, for example, by merchants, retailers, service providers, etc., to users. The services comprise, for example, personalized services such as exclusive offers and exclusive services provided to loyal customers at an entrance of a store, ability to dynamically interact with a customer service at a specific aisle in the store via a mobile application, sending specific relevant offers based on external events, for example, weather, games, sporting events, company events, etc., to users. Also, as used herein, the term “users” refers to recipients of items such as products and/or services and associated information provided by merchants, retailers, service providers, etc. The users are, for example, customers, clients, consumers, patients, etc. Also, as used herein, “omnichannel environment” refers to an advertising and marketing environment where merchants, retailers, or service providers use multiple customer interaction channels such as the internet, computers, brick-and-mortar stores, online stores, mobile stores, mobile application stores, television, radio, telephone, electronic mail, point of sale databases, item catalogs, etc., via a network for receiving user characteristic information, item information of multiple items such as products and/or services, and event information from users, and for encouraging user interaction and engagement with the items by rendering relevant content and services to the users.

The computer implemented method disclosed herein performs real time micro-location targeting across omnichannel platforms with personalized and relevant content in the context of time and location and based on user behavioral and interest data. The computer implemented method disclosed herein generally relates to user identification and content targeting. The computer implemented method disclosed herein particularly identifies users, for example, customers and targets relevant content and services to user devices of the right customers in the right moment and at the right location. The computer implemented method disclosed herein provides personalized relevant content and services in which a user is interested and shows recent intent. The computer implemented method disclosed herein employs a content determination and targeting system comprising at least one processor configured to execute computer program instructions for dynamically targeting time, event and inventory based, location-specific, and behavior relevant content and services to users in an omnichannel environment. The content determination and targeting system predicts and determines the relevant content, for example, based on past purchases, recent interests, current intent across various channels such as social media, etc., and targets the relevant content and services at the right time to right users based on events, place, time, and location.

In an embodiment, the content determination and targeting system dynamically targets time, event and inventory based, location-specific, and behavior relevant content and services to users in an omnichannel environment in three stages comprising, for example, a content related data collection stage, a data analysis stage, and a recommendation and targeting stage. In the content related data collection stage, the content determination and targeting system dynamically receives 101 user characteristic information, item information of multiple items engaged by the users, and event information from multiple information sources in the omnichannel environment. For example, the content determination and targeting system receives user purchase history from point of sale (POS) databases, user activity information received from merchants' applications, merchants' mobile applications, websites, mobile web platforms, merchants' social media portals, etc. As used herein, “user characteristic information” refers to user information and information associated with user interactions with items such as products and/or services. The user characteristic information comprises, for example, user purchase behavior, user demographic information such as age group, gender, etc., user behavior, user preferences, user intent, user interests, location history, activity information associated with multiple user activities in the omnichannel environment, time information associated with the user activities, etc., or any combination thereof. The user characteristic information comprising, for example, information associated with user activities is used to identify user intent and user interests in content associated with multiple items. For example, the content determination and targeting system determines whether a user is interested in a product, a service, or a piece of content from the user's activity of clicking on certain categories of products, services, or content. Also, as used herein, “item information” refers to information of items such as products and services provided by merchants, retailers, or service providers to users. The item information comprises, for example, size, shape, color, specifications, features, warranty period, etc. Also, as used herein, “event information” refers to information of multiple external events such as weather, holidays, sports events, etc., that can affect user purchase behavior.

The information sources comprise, for example, local memory of user devices such as mobile phones, online activity data, multiple sensor devices, point of sale databases, electronic commerce platforms, social networking platforms comprising, for example, blogs such as Slogger, LiveJournal® of Primordial Soup Ltd., Open Diary, TypePad® of The Endurance International Group, Inc., WordPress® of WordPress Foundation, Vox® and VOXopolis® of Voxopolis, Inc., ExpressionEngine® of EllisLab, Inc., etc.; micro-blogging and presence applications comprising, for example, Twitter® of Twitter, Inc., Plurk, Tumblr.® of Tumblr, Inc., Jaiku® of Google, Inc., etc.; social networking websites such as Facebook® of Facebook, Inc., Linkedin® of Linkedin Corporation, MySpace® of MySpace Inc., Orkut® of Google, Inc., etc.; social network aggregation applications such as NutshellMail, FriendFeed® of Facebook, Inc., Pinterest® of Pinterest, Inc., etc., data repositories managed by the content determination and targeting system, inventory management systems, etc., or any combination thereof. The sensor devices, for example, a gyroscope, a barometer, etc., provide information, for example, associated with multiple gestures such as a drag and drop action, a click action, a double click action, a click and a hold action, a tap action, a tap and a hold action, a hold and a swipe action, a touch action, a slide action, a glide action, a scrolling action, etc., proximity information, user movement activities such as running, driving, etc., weather condition information, etc., for generating recommendations for dynamically targeting time, event and inventory based, location-specific, and behavior relevant content and services to users in an omnichannel environment. In an embodiment, the content determination and targeting system cleanses the dynamically received user characteristic information, the item information, and the event information by identifying and correcting discrepancies in the dynamically received user characteristic information, the item information, and the event information.

The content determination and targeting system identifies 102 one or more target users from multiple users for dynamically targeting the time, event and inventory based, location-specific, and behavior relevant content and services using the dynamically received user characteristic information, the item information, and the event information. In an embodiment, the content determination and targeting system tags the dynamically received user characteristic information with user identification attributes for the identification of the target users for the dynamic targeting of the time, event and inventory based, location-specific, and behavior relevant content and services. For example, the content determination and targeting system tags, for example, user interest activities with an interest time stamp and a device identifier that can be used to trace the user.

In an embodiment, the content determination and targeting system extracts data elements from the dynamically received user characteristic information, the item information, and the event information. As used herein, “data elements” refer to fragments of information associated with user characteristics, items, and events, that are extracted from the user characteristic information, the item information, and the event information respectively to facilitate analysis of the user characteristic information, the item information, and the event information. The data elements comprise, for example, user intent, user interest, user activity, content categories, item categories, etc. The content determination and targeting system extracts, for example, user interest activities associated with a product or product categories, a service or service categories, content or content categories, etc., from the user characteristic information, the item information, and the event information dynamically received from the information sources.

In an embodiment, the content determination and targeting system assigns a weight to each extracted data element based on one or more content selection parameters, comprising, for example, campaign goals, a campaign selection parameter, etc., that define marketing campaign objectives. The content selection parameters are defined at a content level or a global level. For example, the content determination and targeting system assigns an associated campaign objective to each extracted data element, where the campaign objective defines the content selection parameter for assigning the weight to each extracted data element. The campaign objective is, for example, up sell, cross-sell, increate profitability, increase sales, product/brand awareness, etc. As used herein, the term “weight” refers to a value assigned to each item that facilitates evaluation of importance of one item over another item. For example, each user activity is assigned a weight. For example, the content determination and targeting system assigns a higher weight to a buying activity than a browsing activity.

In the data analysis stage, the content determination and targeting system analyzes 103 the dynamically received user characteristic information, the item information, and the event information using one or more of multiple analytical parameters. As used herein, “analytical parameters” refer to analytical criteria for analyzing the user characteristic information, the item information, and the event information to determine relevant content and services associated with a target item for a target user. The analytical parameters comprise, for example, a purchase activity predictability parameter, a purchase periodicity predictability parameter, an item lifetime predictability parameter, a predictability parameter based on a discretionary customer habit or a non-discretionary customer habit also referred to as a “discretionary or non-discretionary (DND) predictability parameter”, a purchase behavior pattern predictability parameter, personal attributes, location attributes, etc., and any combination thereof. As used herein, “purchase activity predictability parameter” refers to an analytical criterion that analyzes the user characteristic information to determine a probability of future purchases by a user. Also, as used herein, “purchase periodicity predictability parameter” refers to an analytical criterion that analyzes the user characteristic information, the item information, and the event information to determine a periodicity and frequency of purchases of items to be made by users. Also, as used herein, “item lifetime predictability parameter” refers to an analytical criterion that analyzes the item information to determine a lifetime of items. Also, as used herein, “discretionary or non-discretionary (DND) predictability parameter” refers to an analytical criterion that analyzes the user characteristic information, the item information, and the event information to determine discretionary and non-discretionary customer habits also referred to as discretionary and non-discretionary spending habits. Also, as used herein, “purchase behavior pattern predictability parameter” refers to an analytical criterion that analyzes the user characteristic information, the item information, and the event information to determine a pattern of purchase behavior of users. The personal attributes comprise, for example, natural preferences, desired price ranges for purchasing items, spending limits, etc. The location attributes comprise, for example, proximity to a merchant store, availability of desired items at a particular store, location preferences, etc.

The content determination and targeting system executes multiple algorithms and dimensions on the dynamically received user characteristic information, the item information, and the event information to identify and target relevant content and services to users in an omnichannel environment. For example, the content determination and targeting system analyzes the dynamically received user characteristic information, the item information, and the event information for determining a habitual time series, determining recurrence based predictability, generating interest graphs based on product or service affinity, determining product and promotion behavior based on buy patterns of items, user feedback from user events, etc., performing collaborative pattern matching to predict next best action and next best content, clustering users to match users with best product or services for personalized content, determining personal attributes, natural attributes, preferences such as preferred price or spending limits, etc., performing location intelligence and attribution for determining proximity, availability, preferences, etc.

The content determination and targeting system determines 104 user intent dimensions, user interest dimensions, and global interest dimensions based on the analysis of the dynamically received user characteristic information, the item information, and the event information. As used herein, “user intent dimensions” refer to digital feedback information associated with user activities that define each user's immediate interest towards items, thereby facilitating targeting of relevant content and services to users to encourage further interactions with the items. Also, as used herein, “user interest dimensions” refer to statistical information associated with user purchase behavior that defines a user's interest towards items, thereby facilitating targeting of relevant content and services to users to encourage further interactions with the items. Also, as used herein, “global interest dimensions” refer to statistical information associated with generic purchasing trends of items that are consistent across multiple users. In an embodiment, the user interest dimensions comprise the user intent dimensions. In an embodiment, the content determination and targeting system categorizes the users based on the analyzed user characteristic information, the analyzed item information, the analyzed event information, user feedback associated with the items received by the content determination and targeting system, the determined user intent dimensions, the determined user interest dimensions, and the determined global interest dimensions for the identification of the target users for the dynamic targeting of the time, event and inventory based, location-specific, and behavior relevant content and services as disclosed in the detailed description of FIG. 4.

The content determination and targeting system generates 105 an item relevancy score and an item relevancy priority for each item based on the analysis of the dynamically received user characteristic information, the item information, the event information, the determined user intent dimensions, the determined user interest dimensions, and the determined global interest dimensions. As used herein, “item relevancy score” refers to a final relevancy score of an item that represents relevancy of an item with respect to other items. The content determination and targeting system calculates the item relevancy score based on preliminary scores determined using a weight schema from various user events. In an embodiment, the content determination and targeting system calculates the item relevancy score, for example, using time information associated with a user activity based on a decreasing exponential series defined by the following equation, where “t” is elapsed time defined as a current time minus an event time, “F” is frequency, and “b” is a constant to control a curve:

F*e^{-bt}

Also, as used herein, “an item relevancy priority” refers to a priority assigned to each of the items based on predetermined criteria, for example, how much money a user spends on an item or items in an immediate item category, a parent category, or a department of the item. In an embodiment, the content determination and targeting system normalizes the generated item relevancy score and the generated item relevancy priority for each item for facilitating generation of recommendations for the dynamic targeting of the generated relevant content associated with a target item and service information to the identified target users. In an embodiment, the content determination and targeting system normalizes the generated item relevancy score and the generated item relevancy priority for each item during the analysis of the dynamically received user characteristic information, the item information, and the event information or after the generation of the item relevancy score and the item relevancy priority for each item.

The content determination and targeting system determines 106 a target item from multiple items for dynamically targeting the time, event and inventory based, location-specific, and behavior relevant content and services to the identified target users based on the generated item relevancy score and the generated item relevancy priority of each item. For example, the content determination and targeting system selects the item with the highest item relevancy score and the highest item relevancy priority as the target item. The content determination and targeting system generates and associates 107 relevant content with the determined target item and determines service information of multiple services to be provided to the identified target users, in communication with one or more of multiple content sources. In an embodiment, the content determination and targeting system associates each piece of relevant content with one or more target items that are relevant to an identified target user. The content sources comprise, for example, content repositories of merchants, files exported from the merchants' content repositories, files generated within the content determination and targeting system, content transmitting by the merchants to the content determination and targeting system, etc. The content determination and targeting system generates 108 a content relevancy score and a content relevancy priority for the generated relevant content associated with the determined target item based on the analysis of the dynamically received user characteristic information, the item information, the event information, the determined user intent dimensions, the determined user interest dimensions, and the determined global interest dimensions. In an embodiment, the content determination and targeting system calculates the content relevancy score and the content relevancy priority for each piece of the relevant content, for example, based on the associated target items, campaign parameters, weightages, and other content selection parameters.

In the recommendation and targeting stage, the content determination and targeting system dynamically generates 109 recommendations for dynamically targeting the generated relevant content associated with the determined target item and the determined service information of the services to the identified target users based on the generated content relevancy score, the generated content relevancy priority, one or more of multiple targeting triggers, and the analysis of the dynamically received user characteristic information, the item information, and the event information using one or more of multiple content selection parameters. As used herein, “targeting triggers” refer to parameters that trigger targeting of relevant content and services to users by the content determination and targeting system. The targeting triggers comprise, for example, time triggers, geolocation triggers, in-store triggers, for example, beacon triggers or Wi-Fi® triggers, manual target now triggers, user activity triggers, etc., and any combination thereof. Also, as used herein, “content selection parameters” refer to criteria defined for analyzing the user characteristic information, the item information, and the event information for generating recommendations for targeting relevant content and services to users. The content selection parameters comprise, for example, campaign goals, a campaign selection parameter, a location analysis parameter, an event analysis parameter, an inventory analysis parameter, a targeting history parameter, etc., and any combination thereof.

The content determination and targeting system executes various relevancy algorithms on the generated relevant content to identify time, event and inventory based, location-specific, and behavior relevant content and services. The content determination and targeting system implements relevancy algorithms that use external events, for example, weather, sporting events, company events, etc., to dynamically switch the generated recommendations. For example, when the external event indicates the weather is warm, the content determination and targeting system assigns a high weight to cold items, for example, ice cream, etc., and recommends the cold items. The content determination and targeting system comprises an analytics engine configured as a predictive engine and a near real time behavior analyzer that feeds results of the analysis as inputs to a recommendation engine. The recommendation engine of the content determination and targeting system takes into account various inputs from various analyses performed by the analytics engine and determines the relevant content for targeting. The relevant content comprises, for example, identified location, time, external events, etc.

In an embodiment, the content determination and targeting system performs a time, event and inventory based activity analysis to identify a common time when a user positively interacts and engages with targeted content, determines a user's past activity and attribution based on channels used in the omnichannel environment, performs external event attribution, for example, based on weather, holidays, events, etc., identifies a current location of a user based on last known location of the user and real time information associated with a user's movement received from multiple information sources, etc. The content determination and targeting system feeds in results of the analysis to the recommendation engine for generating recommendations for targeting of relevant content and services to users. The recommendation engine recommends relevant items to users using the generated recommendations. Consider another example where a user shows intent for buying Coke® of The Coca-Cola Company based on an interaction in a mobile application or an online website, compared to a regular purchase of Pepsi® of PepsiCo, Inc. In this example, the recommendation engine of the content determination and targeting system recommends Coke® to the user based on a higher weightage assigned for recentness. The recommendation engine triggers the generation of recommendations based on geo location tracking, for example, via beacons and global positioning systems (GPSs).

Further in the recommendation and targeting stage, the content determination and targeting system dynamically targets 110 the generated relevant content associated with the determined target item and the determined service information of the services to the identified target users in the omnichannel environment based on the dynamically generated recommendations. In an embodiment, the content determination and targeting system leverages industry standard data models such as association for retail technology standards (ARTS) and employs an ensemble model that analyzes user intent, user interest, external events, micro-segmentation strategies, dynamic ranking of content, associations and attributions with positive or negative user sentiment, etc., to target time, event and inventory based, location-specific, and behavior relevant content and services to users in an omnichannel environment and perform channel optimization in the omnichannel environment with a closed loop solution.

In an embodiment, the content determination and targeting system dynamically analyzes inventory information associated with the items stored in one or more inventory management systems for facilitating dynamic revenue generation and profit optimization. The content determination and targeting system analyzes information received from the inventory management systems and generates dynamic relevant offers based on item availability and merchant centric revenue and profit optimization rules. For example, the content determination and targeting system tracks information associated with perishable items and excess inventory received from the inventory management systems, and dynamically proposes offers and discounts for the perishable items and excess inventory via algorithms employed by the content determination and targeting system.

In an embodiment, the content determination and targeting system dynamically analyzes inventory information associated with the items stored in one or more inventory management systems, regenerates the relevant content associated with the determined target item based on the dynamic analysis of the inventory information, and updates the generated content relevancy score and the generated content relevancy priority for the regenerated relevant content associated with the determined target item for the dynamic generation of recommendations for the dynamic targeting of the regenerated relevant content associated with the determined target item to the identified target users. Consider an example where a perishable item, for example, milk has a coupon discount of 10% and is about to expire soon. The content determination and targeting system receives inventory information about the perishable item from one or more inventory management systems via an inventory application programming interface (API) and increases the discount from 10% to 15% to facilitate an increase in sales of the perishable item. When the discount changes, the content determination and targeting system regenerates relevant content comprising, for example, text and an image associated with the perishable item and also changes the generated content relevancy score and the generated content relevancy priority for the regenerated relevant content.

FIG. 2 exemplarily illustrates a flow diagram showing collection of user feedback for determination of user intent by the content determination and targeting system. The content determination and targeting system receives user activity information, for example, via an application or a website software development kit (SDK) 201 employed by the content determination and targeting system, or from a user's activity of opening or clicking on content in an electronic mail (email) 202, or from a passbook 203 stored on a user device, or from activities performed on content sent via targeting channels or via a push notification 204, or via crawling merchants' social channels 205. The content determination and targeting system generates user events 206 based on the received user activity information. The content determination and targeting system collects user feedback by processing 207 the generated user events 206. The content determination and targeting system logically categorizes the collected user feedback into categories comprising, for example, item intent 208, content intent 209, and location intent 210. The content determination and targeting system determines item intent 208 when a user interacts with a merchant's application or website and performs activities, for example, clicks, opens, searches, or scans an item. The content determination and targeting system determines content intent 209 when a user performs activities, for example, views, opens, clicks, or includes content sent to him/her via a targeting channel. The content determination and targeting system determines location intent 210, for example, via geo location tracking, via beacons, or via Wi-Fi® tracking. The content determination and targeting system stores the categorized user feedback in an aggregate data warehouse 211. The content determination and targeting system collects social activities and events by integrating with merchants' social networking platforms and crawling for user characteristic information, item information, and event information. The content determination and targeting system stores the received user characteristic information, the received item information, and the received event information in a data repository and in the aggregate data warehouse 211.

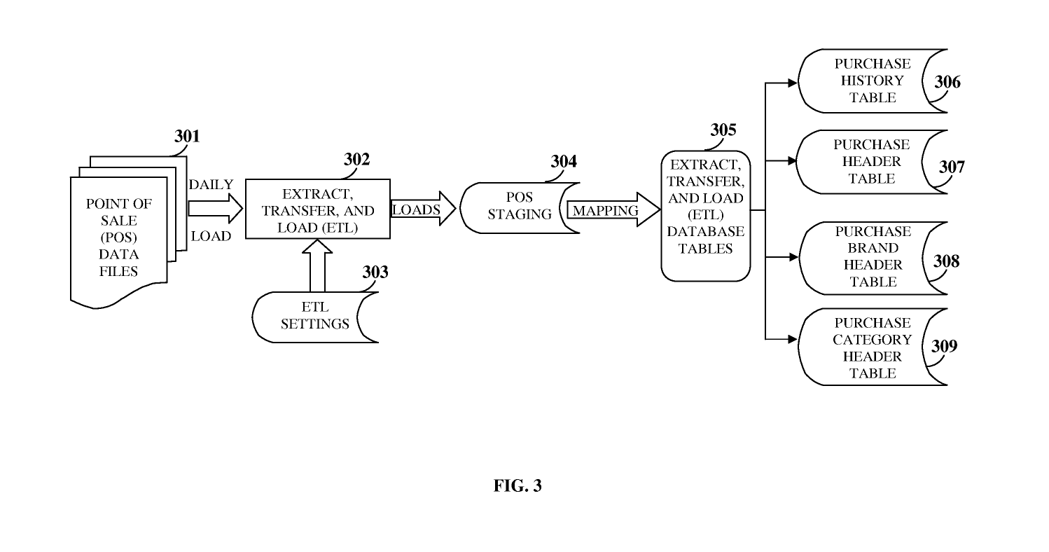

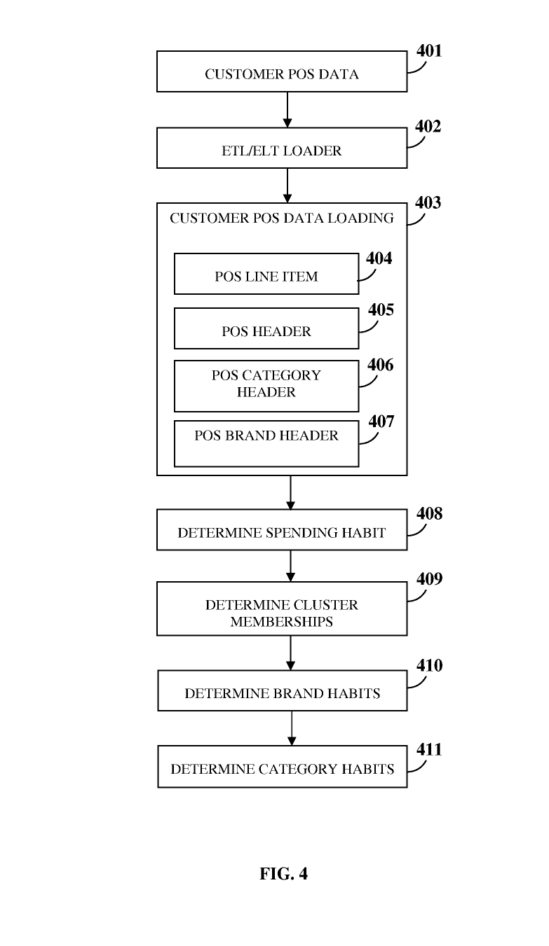

FIG. 3 exemplarily illustrates a flow diagram showing steps performed by the content determination and targeting system for extracting data elements from user characteristic information, item information, and event information received from point of sale (POS) databases. POS data files 301 are used to generate POS intelligence, for example, about users' buying behavior. The POS data files 301 are loaded into the content determination and targeting system via extract, transform, and load (ETL) or extract, load, and transform (ELT) processes performed by the content determination and targeting system. The ETL and ELT processes are different for different merchants depending on the features and customization of their respective POS systems. In the ETL process, the content determination and targeting system extracts the POS data files 301 from the POS databases, transforms the POS data files 301 for storage in a predefined format or a predefined data structure for querying and analysis purposes, and loads the transformed POS data files 301 into a data repository. In the ELT process, the content determination and targeting system extracts the POS data files 301 from the POS databases, loads the POS data files 301 in a data repository, and then performs transformation of the POS data files 301 on demand. In the ELT process, the POS data files 301 are not processed on entry into the content determination and targeting system, which enables fast loading times, but are processed later to carry out the transformation on demand.

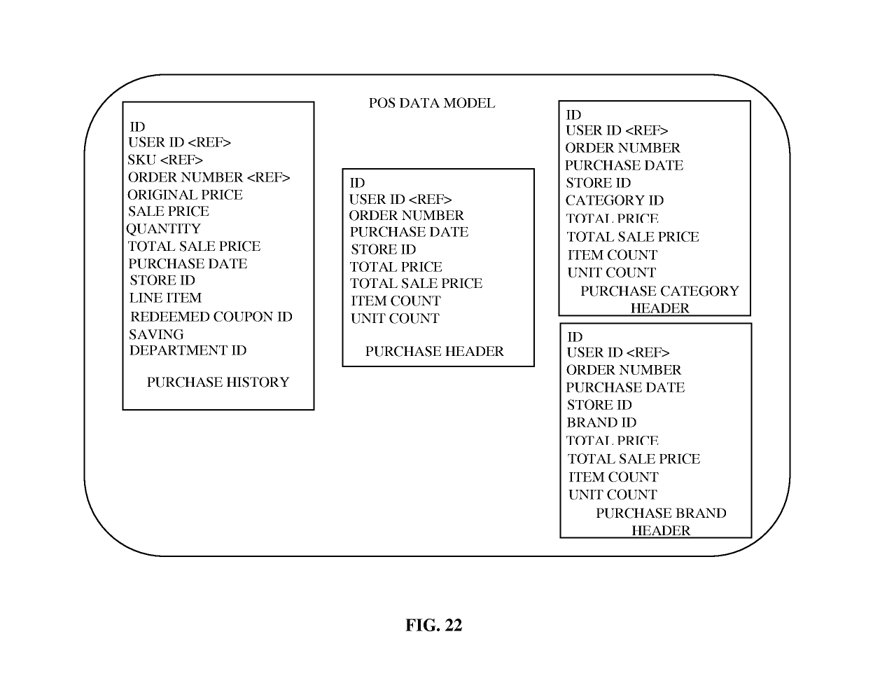

The extract, transform, and load (ETL) process 302 may be triggered on a daily basis or a weekly basis based on availability of the point of sale (POS) data files 301 or POS off line replication files hereafter referred to as “POS data files”. In an embodiment, the content determination and targeting system does not provide a direct access to a POS system, as the POS system is critical for a merchant's business, and any mistake or load during business hours may have a negative effect on the merchant's entire POS system. The content determination and targeting system stores access locations of the POS data files 301, that is, from where to read or access the POS data files 301 in ETL settings 303. As exemplarily illustrated in FIG. 3, the content determination and targeting system applies the ETL settings 303 and performs the ETL process 302 to load the POS data files 301. The content determination and targeting system performs POS staging 304 and maps the POS data files 301 into ETL database tables 305 comprising, for example, a purchase history table 306, a purchase header table 307, a purchase brand header table 308, and a purchase category header table 309. The POS data model for the data stored in the purchase history table 306, the purchase header table 307, the purchase brand header table 308, and the purchase category header table 309 is exemplarily illustrated in FIG. 22.

FIG. 4 exemplarily illustrates a flow diagram showing steps of an analysis of point of sale (POS) data 401 received from POS databases by the content determination and targeting system. The content determination and targeting system receives POS data 401 associated with users, for example, customers from the POS databases. The content determination and targeting system uses an extract, transform, and load (ETL) or extract, load, and transform (ELT) loader 402 for loading the received POS data 401 into the content determination and targeting system. The ETL or ELT loader 402 implements conventional ETL or ELT tools that perform POS data loading 403 by executing data transformation and aggregation of the POS data 401 as disclosed in the detailed description of FIG. 3. The ETL or ELT loader 402 loads and categorizes the POS data 401, for example, under a POS line item 404, a POS header 405, a POS category header 406, and a POS brand header 407, and stores the categorized POS data 401 in the purchase history table 306, the purchase header table 307, the purchase category header table 309, and the purchase brand header table 308 respectively, as exemplarily illustrated in FIG. 3.

Consider an example where the content determination and targeting system first imports attributes of individual point of sale (POS) line items 404 from the received POS data 401 as exemplarily illustrated in the table below:

| | | | Order | | | Unit | | Total | Coupon |
|---|---|---|---|---|---|---|---|---|---|
| User # | Order # | Store # | date | Item | Qty | price | Discount | price | code |
| 1 | 1000 | 100 | 2/5/2013 | SKU 1 | 10 | 1 | 0.2 | 8 | 111222-333 |
| 1 | 1000 | 100 | 2/5/2013 | SKU 2 | 2 | 5 | 0 | 10 | 0 |

The content determination and targeting system then imports point of sale (POS) header attributes 405 for purchase orders for each item as exemplarily illustrated in the table below:

| User | Order | Store | Order | | | | |
|---|---|---|---|---|---|---|---|
| # | # | # | date | Items | Total | Discount | Coupons |
| 1 | 1000 | 100 | 2/5/2013 | 12 | 18 | 2 | 1 |

The content determination and targeting system then transforms the point of sale (POS) line items 404 on a per category basis as exemplarily illustrated in the table below:

| User | Order | Store | Order | | | | Dis- | |
|---|---|---|---|---|---|---|---|---|
| ID | ID | ID | date | Category | Items | Total | count | Coupons |
| 1 | 1000 | 100 | 2/5/2013 | Dairy | 10 | 8 | 2 | 1 |
| 1 | 1000 | 100 | 2/5/2013 | Bakery | 2 | 10 | 0 | 0 |

The content determination and targeting system then transforms the point of sale (POS) line items 404 on a per brand basis as exemplarily illustrated in the table below:

| User | Order | Store | Order | | | | Dis- | Cou- |
|---|---|---|---|---|---|---|---|---|
| # | # | # | date | Brand | Items | Total | count | pons |
| 1 | 1000 | 100 | 2/5/2013 | Brand 1 | 10 | 8 | 2 | 1 |
| 1 | 1000 | 100 | 2/5/2013 | Brand 1 | 2 | 10 | 0 | 0 |

After a phase of POS data loading 403, the content determination and targeting system performs data processing, for example, at least once a day as follows. The content determination and targeting system determines 408 spending habits of users. The content determination and targeting system calculates average, minimum, and maximum spending limits of users, for example, on a daily, a weekly, a bi-weekly, a monthly, a quarterly, or a half-yearly basis. Depending on industry verticals and lifetime of an item, the content determination and targeting system determines an effective period for calculation of the spending limits for each item. The content determination and targeting system uses the determined spending habits and effective period of calculation for the items in analytics and for targeting relevant content and services to users. In an embodiment, the content determination and targeting system uses monthly or quarterly averages of spending limits for relevancy calculation. The table below exemplarily illustrates information associated with spending habits of a user:

| | | Av- | | Av- | Av- | | |
|---|---|---|---|---|---|---|---|
| User | Time | erage | Maximum | erage | erage | Cou- | Average |
| ID | period | spend | spend | units | items | pons | Discount |
| 1 | last | 10 | 10 | 7 | 7 | 3 | 3 |
| | day | | | | | | |
| 1 | week | 7 | 12 | 6 | 6 | 5 | 3 |
| 1 | Month | 7.5 | 12 | 6 | 6 | 8 | 2.7 |
| 1 | Quarter | 7.5 | 12 | 6 | 6 | 8 | 2.7 |
| 1 | Overall | 7.5 | 12 | 6 | 6 | 8 | 2.7 |

Further in the data processing phase, the content determination and targeting system categorizes users in clusters and determines 409 cluster memberships of users based on the determined spending habits of the users. Cluster analysis or clustering is a task of grouping a set of objects in such a way that objects in the same cluster are more similar to each other than to those in other clusters. In an embodiment, the content determination and targeting system implements the K-means clustering algorithm to create 3 or more clusters, depending on the requested granularity, mainly comprising, for example, a high cluster, a medium cluster, and a low cluster for each purchase dimension as exemplarily illustrated in the table below. In an embodiment, the content determination and targeting system implements the K-means clustering algorithm based on the type of platform used, for example, Apache Mahout on the Apache MapReduce platform of the Apache Software Foundation, Weka® libraries of WaikatoLink Limited. The table exemplarily illustrated below provides examples of granular entries, for example, for a Monday shopper, a Tuesday shopper, etc., based on merchant requirements and can be extended:

| User | Time | | Cluster | User |
|---|---|---|---|---|
| #1 | Period | Cluster Type | Name | Value |
| 1 | Quarter | High spend | Medium | 30 |
| 1 | Quarter | High frequency | Low | 3 |
| 1 | Quarter | High volume | Low | 12 |
| 1 | Quarter | Bulk | Low | 10 |
| 1 | Quarter | Average spend | Medium | 3 |
| 1 | Quarter | Weekday shopper | Low | 3 |
| 1 | Quarter | Weekend shopper | High | 12 |
| 1 | Quarter | Morning shopper | Low | 0 |
| 1 | Quarter | Noon shopper | Low | 0 |
| 1 | Quarter | Evening shopper | High | 8 |
| 1 | Quarter | Night shopper | Low | 3 |
| 1 | Quarter | On sale | High | 10 |
| 1 | Quarter | Offer | Medium | 5 |

The content determination and targeting system categorizes users in clusters based on brands for determining 410 brand habits of users. In an embodiment, the content determination and targeting system implements the K-means clustering algorithm for clustering users on a per brand basis as exemplarily illustrated in the table below:

| User | Time | | | Cluster | User |
|---|---|---|---|---|---|
| #1 | Period | Brand | Cluster Type | Name | Value |
| 1 | Quarter | B1 | High spend | Medium | 30 |
| 1 | Quarter | B1 | High frequency | Low | 3 |
| 1 | Quarter | B1 | High volume | Low | 12 |
| 1 | Quarter | B1 | Bulk | Low | 10 |
| 1 | Quarter | B1 | Offer | Low | 3 |
| 1 | Quarter | B1 | On sale | High | 12 |

The content determination and targeting system categorizes users in clusters based on categories of items to determine 411 category habits of users. In an embodiment, the content determination and targeting system implements the K-means clustering algorithm for clustering users on a per category basis as exemplarily illustrated in the table below:

| User | Time | | | Cluster | User |
|---|---|---|---|---|---|
| #1 | period | Category | Cluster Type | Name | Value |
| 1 | Quarter | Dairy | High spend | Medium | 30 |
| 1 | Quarter | Dairy | High frequency | Low | 3 |
| 1 | Quarter | Dairy | High volume | Low | 12 |
| 1 | Quarter | Dairy | Bulk | Low | 10 |
| 1 | Quarter | Dairy | Offer | Low | 3 |
| 1 | Quarter | Dairy | On sale | High | 12 |

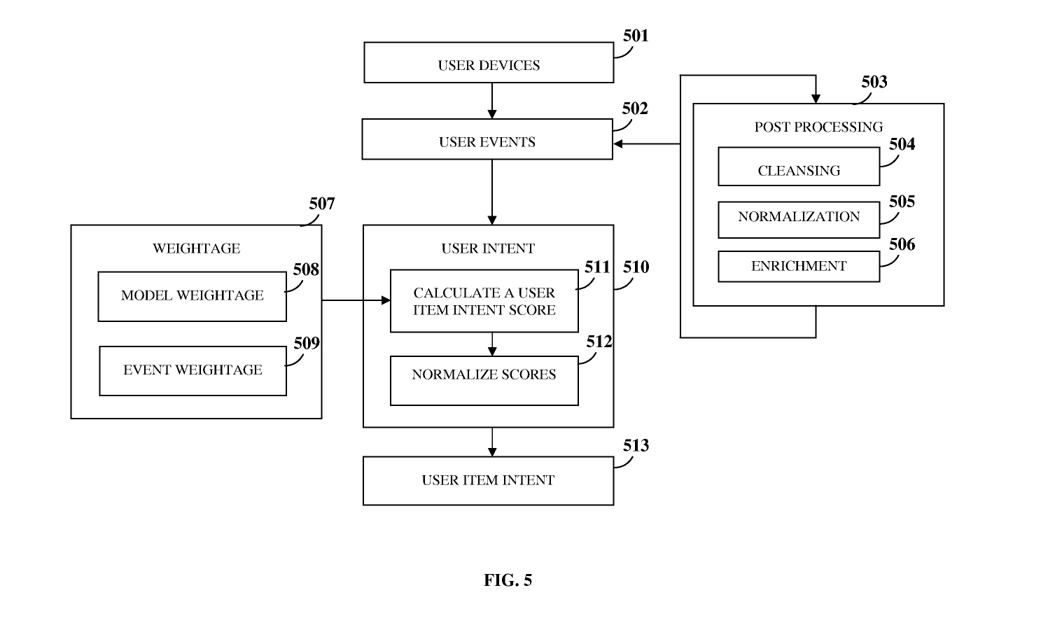

FIG. 5 exemplarily illustrates a flow diagram showing steps performed by the content determination and targeting system for determining user intent 510 for an item. The content determination and targeting system generates user events 502 based on information received from user devices 501 such as smart phones, laptops, desktops, tablets, wearable mobile devices, etc. The user events 502 are captured via a software development kit (SDK) integrated with the user devices 501. The SDK is integrated, for example, with the user devices 501, applications, or website applications. In an embodiment, the SDK is written in native languages, for example, Objective-C® of Apple Inc., for Apple user devices 501, Java programming language for Android based user devices 501, or JavaScript® for browser based applications. The content determination and targeting system transmits the captured user events 502 to a backend server of the content determination and targeting system. The SDK captures user events 502 and gestures and sends the captured user events 502 and gestures to the backend server for storage and analysis. The user events 502 are stored in an event table of a data repository of the content determination and targeting system for further analysis.

The backend server receives and stores the received user events 502 and gestures in a raw format for 100 percent fidelity and performance. The backend server does not perform any transformations on the received user events 502 and gestures. A subset of user event attributes that are stored in data repositories of the content determination and targeting system is exemplarily illustrated in the table below. The table exemplarily illustrated below comprises the user events 502 as raw data received by the content determination and targeting system.

| Event | Time | User | Device | Device | | | Application | Object | Object | | Device |
|---|---|---|---|---|---|---|---|---|---|---|---|
| Type | Stamp | ID | Type | OS | Wi-Fi ® | Net | Type | ID | Type | Token | ID |
| OPEN | T1 | 1 | iPhone | iOS | N | ATT | APP | 1 | PROD | TOK1 | UUID1 |
| CLICK | T2 | 1 | iPhone | iOS | N | ATT | APP | 1 | PROD | TOK1 | UUID1 |
| ADD | T3 | null | iPhone | iOS | N | ATT | APP | 1 | PROD | TOK1 | UUID1 |
| OPEN | T4 | null | iPhone | iOS | N | ATT | APP | 1 | PROD | TOK1 | UUID1 |
| VIEW | T4 | null | iPhone | iOS | N | ATT | APP | 1 | PROD | TOK1 | UUID1 |

| | | Agent | Session | | | Content | Context | Brand | Category | Department |
|---|---|---|---|---|---|---|---|---|---|---|
| LAT | LONG | Type | ID | $ | Context | T | ID | ID | ID | ID |
| 13.1 | 101.5 | B1 | #123 | 10 | NOTI | | | | | |
| 13.1 | 101.5 | B1 | #123 | 10 | CAT | | | | | |
| 13.1 | 101.5 | B1 | #150 | 10 | PROD | | | | | |
| 13.1 | 101.5 | B1 | #150 | 10 | PROD | | | | | |
| 13.1 | 101.5 | B1 | #150 | 10 | PROD | | | | | |

Once a user event 502 is stored in the content determination and targeting system, the content determination and targeting system performs post processing 503 steps of cleansing 504, normalizing 505, and enriching 506 of the stored user events 502. In an embodiment, the content determination and targeting system processes the user events 502 in a delta mode. In an embodiment, the content determination and targeting system stores a last processing time in an audit information table and processes records of user events 502 with a timestamp later than the last audit time.

In the cleansing phase 504 of post processing 503, the content determination and targeting system populates missing information using multiple algorithms. For example, the content determination and targeting system scans for a device identifier (UUID) in a user device table and an event history table and locates the latest user ID against a given device identifier for updating a missing user ID. In another example, the content determination and targeting system scans for a device token from the user device table and the event history table and locates the latest user ID to populate the missing user ID. In another example, the content determination and targeting system scans for a same session ID in the event history table and locates the latest user ID to populate the missing user ID. In another example, the content determination and targeting system determines a missing price for an item. For example, if the object type is a product, the content determination and targeting system checks whether inventory and point of sale (POS) integration is available, retrieves the missing price information via an application programming interface (API), and updates the missing price information. The table below exemplarily illustrates the missing information highlighted in bold that is retrieved after cleansing 504 the user events 502.

| Event | Time | User | Device | Device | | | Application | Object | Object | Device | Device |
|---|---|---|---|---|---|---|---|---|---|---|---|
| Type | Stamp | ID | Type | OS | Wi-Fi ® | Net | Type | ID | Type | Token | ID |
| OPEN | T1 | 1 | iPhone | iOS | N | ATT | APP | 1 | PROD | TOK1 | UUID1 |
| CLICK | T2 | 1 | iPhone | iOS | N | ATT | APP | 1 | PROD | TOK1 | UUID1 |
| ADD | T3 | 1 | iPhone | iOS | N | ATT | APP | 1 | PROD | TOK1 | UUID1 |
| OPEN | T4 | 1 | iPhone | iOS | N | ATT | APP | 1 | PROD | TOK1 | UUID1 |
| VIEW | T4 | 1 | iPhone | iOS | N | ATT | APP | 1 | PROD | NULL | UUID1 |

| | | Agent | | | | | | | | |
|---|---|---|---|---|---|---|---|---|---|---|
| | | Type/ | Session | | | Content | Context | Brand | Category | Department |
| LAT | LONG | ID | ID | $ | Context | Text | ID | ID | ID | ID |
| 13.1 | 101.5 | B1 | #123 | 10 | NOTI | | | | | |
| 13.1 | 101.5 | B1 | #123 | 10 | CAT | | | | | |
| 13.1 | 101.5 | B1 | #150 | 15 | PROD | | | | | |
| 13.1 | 101.5 | B1 | #150 | 8 | PROD | | | | | |
| 13.1 | 101.5 | B1 | #150 | 7 | PROD | | | | | |

In the normalization phase 505 of post processing 503, for example, if a device operating system (OS) type is not populated or populated incorrectly, then the content determination and targeting system parses the device OS type and updates the correct entries. The content determination and targeting system performs this update multiple times since there are a lot of new user devices 501 and/or browsers and it is difficult to release patches to keep up with them. In the enrichment phase 506 of post processing 503, the content determination and targeting system enriches 506 the user events 502. The enriched user events 502 are attributes that are augmented to the received user events 502 to make the received user events 502 more useful and to improve various performance aspects. For example, content text, brand identifier (ID), category ID, and department ID are examples of attributes that constitute a set of enriched user events 502. For example, if the object type of an item is a product, then the object ID can be an item ID or a stock keeping unit (SKU). The content determination and targeting system checks for the SKU first in an item catalog and updates the event table for brand ID, category ID, and department ID. The content determination and targeting system also checks with the item ID, populates the above fields, and updates content text. In another example, if the object type of the item is an offer, an advertisement, or a coupon, then the content determination and targeting system checks for the item ID or the SKU in an item content table and parses the information to update with the correct entries in the event table. In another example, the content determination and targeting system updates a missing category ID for a product object type or a user event 502 as “Category_Click”. In another example, the content determination and targeting system updates city, state, and store ID in the event table. In another example, if latitude and longitude are available, the content determination and targeting system translates the latitude and longitude to city and state using latitude and longitude services such as Google geo-coding application programming interfaces (APIs). In this example, the content determination and targeting system stores the resolved information in a location table for future optimization and analysis. In another example, if an agent type is beacon or Wi-Fi® of Wi-Fi Alliance Corporation, the content determination and targeting system updates store ID based on the agent ID. Enriched user events 502 are exemplarily illustrated in bold in the table below.

| Event | Time | User | Device | Device | | | Application | Object | Object | Device | Device |
|---|---|---|---|---|---|---|---|---|---|---|---|
| type | stamp | ID | type | OS | Wi-Fi ® | Net | Type | ID | type | token | ID |
| OPEN | T1 | 1 | iPhone | iOS | N | ATT | APP | 1 | OFFR | TOK1 | UUID1 |
| CLICK | T2 | 1 | iPhone | iOS | N | ATT | APP | 1 | PROD | TOK1 | UUID1 |
| ADD | T3 | 1 | iPhone | iOS | N | ATT | APP | 1 | PROD | TOK1 | UUID1 |
| OPEN | T4 | 1 | iPhone | iOS | N | ATT | APP | 1 | CAT | TOK1 | NULL |
| VIEW | T4 | 1 | iPhone | iOS | N | ATT | APP | 1 | PROD | NULL | NULL |

| | | Agent | | | | | | | | |
|---|---|---|---|---|---|---|---|---|---|---|
| | | Type/ | Session | | | Content | Context | Brand | Category | Department |
| LAT | LONG | ID | ID | $ | Context | Text | ID | ID | ID | ID |
| 13.1 | 101.5 | B1 | #123 | 2 | NOTI | | | | | |
| 13.1 | 101.5 | B1 | #123 | 10 | CAT | | | 3 | 2 | 1 |
| 13.1 | 101.5 | B1 | #150 | 15 | PROD | | | 4 | 2 | 1 |
| 13.1 | 101.5 | B1 | #150 | 8 | PROD | | | | 3 | 1 |
| 13.1 | 101.5 | B1 | #150 | 7 | PROD | | | 5 | 3 | 1 |

The content determination and targeting system determines user intent 510 towards certain products, brands, or categories. The content determination and targeting system implements a set of algorithms that calculate 511 a set of user item intent scores. The content determination and targeting system generates a certain set of user events 502 during a user's interaction with an item. The user events 502 are used to generate user item intent 513. The tabled below exemplarily illustrates item related user events 502:

| Group | Event Type |
|---|---|
| CLICK | ITEM_OPEN |
| SEARCH | SEARCH |
| ADD | ADD_ITEM |
| SCANNED | SCAN_BARCODE, SCAN_ITEM |
| CATEGORY | CATEGORY_CLICK |
| BRAND | BRAND_CLICK |

| | Category | Department | Item | Item | |
|---|---|---|---|---|---|
| Date | ID | ID | name | SKU | Event_Type |
| Jan. 2, 2015 | 2 | 1 | organic | 111 | CLICK |
| | | | wheat | | |
| | | | bread | | |
| Jan. 3, 2015 | 2 | 1 | bread | 222 | SEARCH |
| Jan. 2, 2015 | 5 | 2 | bananas | 333 | ADD |
| Jan. 3, 2015 | 5 | 2 | carrots | 444 | ADD |
| Jan. 3, 2015 | 120 | 7 | animal | 888 | SCANNED |
| | | | crackers | | |

The content determination and targeting system determines user item intent 513 for each item. In an embodiment, the content determination and targeting system calculates an intent score based on two criteria comprising, for example, recentness and frequency. For example, the content determination and targeting system determines that a user's interest for an item is higher for a more recent user event 502. The recentness is incorporated as an exponential component defined in the following formula:

F*e^{-bt}

where “t” is elapsed time defined as a current time minus an event time, “F” is frequency, and “b” is a constant to control the curve. Values for the constant “b” can be varied based on a merchant's preference and are used for the user item intent 513 and the user item interest. Furthermore, the content determination and targeting system determines how many times an item was clicked, searched, or scanned, to determine the frequency. Due to granularity issues with a continuous time function for calculating frequency, the unit of the time is made coarse and 6 hours is taken as 1 time unit. Hence, frequency is calculated over this period of time. The new formula for recentness is defined, for example, with:
T=number of time units calculated as:
T=1+floor (time_difference_in_hours (now, event_time)/6)
F=frequency of a given user event 502 within the above time units
F=count of user events 502, where t>T−6 and <T
b=−1.333

The recentness is calculated using the overall formula below:

Event Score (Eₛ)=1000*F*e^{-1.333T}

The event score is calculated for each user event 502 and each item. Once the content determination and targeting system performs the above calculation, the content determination and targeting system produces an intermediate output as exemplarily illustrated in the table below:

| User | | Item | Event | |
|---|---|---|---|---|
| ID | Date | SKU | Type | Score |
| 1 | Feb. 1, 2015 | 111 | CLICK | 5251 |
| 1 | Jan. 26, 2015 | 111 | ADD | 527 |
| 1 | Jan. 1, 2015 | 222 | SCAN | 21.2 |
| 1 | Jan. 1, 2015 | 222 | CLICK | 21.2 |

The code snippet disclosed below describes a database implementation for calculating an event score:

select USER_ID, PRODUCT_SKU, EVENT_TYPE, 1000*FREQ/POW(1.333,
t.SCORE) as SCORE
from
(
select USER_ID, EVENT_TYPE, PRODUCT_SKU,
(1+FLOOR(TIMESTAMPDIFF(HOUR, FROM_UNIXTIME(RT.TIMESTAMP),
now( ))/6)) as SCORE,
COUNT((l+FLOOR(TIMESTAMPDIFF(HOUR,
FROM_UNIXTIME(RT.TIMESTAMP), now( ))/6))) AS FREQ from USER_EVENT
where OBJECT_TYPE = “PRODUCT” AND FROM_UNIXTIME(RT.TIMESTAMP) >
(now( ) - INTERVAL 7 DAY) group by 1,2,3,4)

The content determination and targeting system determines weightage 507 comprising, for example, a model weightage 508 and event weightage 509. The content determination and targeting system calculates an item relevancy score for a target item for a target user by aggregating all corresponding user to item mapped user events 502. However, not all user events 502 can be treated equally. For example, the content determination and targeting system may assign a higher weightage to a scan user event 502 than a search user event 502. Moreover, based on sales and marketing strategies employed by merchants, the event weightage 509 and relative importance of the event weightage 509 may not remain the same. For example, in some models a scan user event 502 may have less weightage than a search user event 502. The content determination and targeting system assigns model weightage 508 for items as exemplarily illustrated in the table below:

| Content | Model | | Weightage |
|---|---|---|---|
| Type | ID | Event Type | (E_{wt}) |
| Product | Retention | SEARCH | 0.3 |
| Product | Retention | OPEN | 0.3 |
| Product | Retention | ADD | 0.5 |
| Product | Retention | FAVORITE | 0.8 |
| Product | Retention | LIKED | 0.7 |
| Product | Retention | CLICK | 0.3 |
| Product | Retention | SCAN | 0.6 |
| Product | Retention | BUY_LOC | 0.6 |
| Product | Retention | BUY_ONL | 0.4 |

The content determination and targeting system uses the determined weightage 507 for calculating a total raw item relevancy score for each item based on an active model. For example, the content determination and targeting system calculates total raw item relevancy score for an item using the formula below:

Total raw item relevancy score={u,i}ΣEₛ*E_{wt}

That is, for a given user-item combination represented by {u,i} in the formula above, the total raw item relevancy score is a sum of event score*event weightage.

The content determination and targeting system calculates an item relevancy priority for an item based on how much money a user spends on the item or items in an immediate category, a parent category, or a department of the item. The calculated item relevancy priority is used to re-prioritize an order of relevant content such as offers, advertisements, services, etc., that have the same item relevancy score for a target item. The table below exemplarily illustrates calculation of item relevancy priority (Rₚ) based on a minimum, an average or a maximum amount of money, for example, in terms of dollars ($) spent by a user on an item, in an item subcategory, in an item category, or in a department:

| User | Item | | |
|---|---|---|---|
| ID | SKU | Score | Rₚ |
| 1 | 111 | 5251.31 *0.3 + 527*0.5 + 21.2 | 12 |
| | | *0.6 + 21.2 *0.3 = 1858 | |

The content determination and targeting system defines a relevancy model configured to determine whether to use a maximum amount of money spent or an average amount of money spent on an item for determining item relevancy priority. The content determination and targeting system further defines an intent model configured to determine item relevancy priority of user intent 510 for a user. The content determination and targeting system uses the intent model to calculate a maximum user item intent score, a minimum amount, an average amount, and a maximum amount spent on a category or a subcategory of similar items for the user. Disclosed below is a code snippet of a database implementation for the intent model of the content determination and targeting system.

[select USER_ID, MAX(SCORE) from USER_INTENT group by USER_ID]
[select USER_ID, MIN_SPEND, MAX_SPEND, AVG_SPEND from
CLUSTER_SHOPPING where ....group by USERID]

The user item intent score generated by implementation of the intent model can vary in a predetermined range and also may be in a completely different scale from the preliminary scores generated via other models and processes. Alternatively, it is difficult to determine if 5476 is a high score or a low score, if the range is unknown. Hence, the content determination and targeting system determines a well-defined range of scores that can be used for aggregation and comparison purposes. Hence, the content determination and targeting system normalizes 512 the generated user item intent score, for example, in a range from 0 to 100. The content determination and targeting system calculates a normalized user item intent score also referred to as a “digital intent score”, for example, using the following formula:

Normalized user item intent score (Dᵢₙ)=Raw item relevancy score*100/Max score

The content determination and targeting system generates an item relevancy priority for the normalized user item intent score, for example, using the following formula configured in the relevancy model:

Item relevancy priority (Dᵢₙᵣₚ)=Average money spent on an item subcategory

The content determination and targeting system stores the normalized user item intent score in a format as exemplarily illustrated in the table below:

| | | | Normalized | Item | |
|---|---|---|---|---|---|
| | | Raw item | user item | Relevancy | |
| User | Item | relevancy | intent score | Priority | |
| ID | SKU | score | (Dᵢₙ) | (Dᵢₙᵣₚ) | Type |
| 1 | 111 | 5239 | 100 | 12 | DIN |
| 1 | 222 | 680 | 12.98 | 12 | DIN |
| 1 | 333 | 320 | 6.10 | 18 | DIN |
| 1 | 444 | 440 | 8.40 | 18 | DIN |

The content determination and targeting system stores the final user item intent score for a subsequent usage and determines the user item intent 513 from the stored user item intent score.

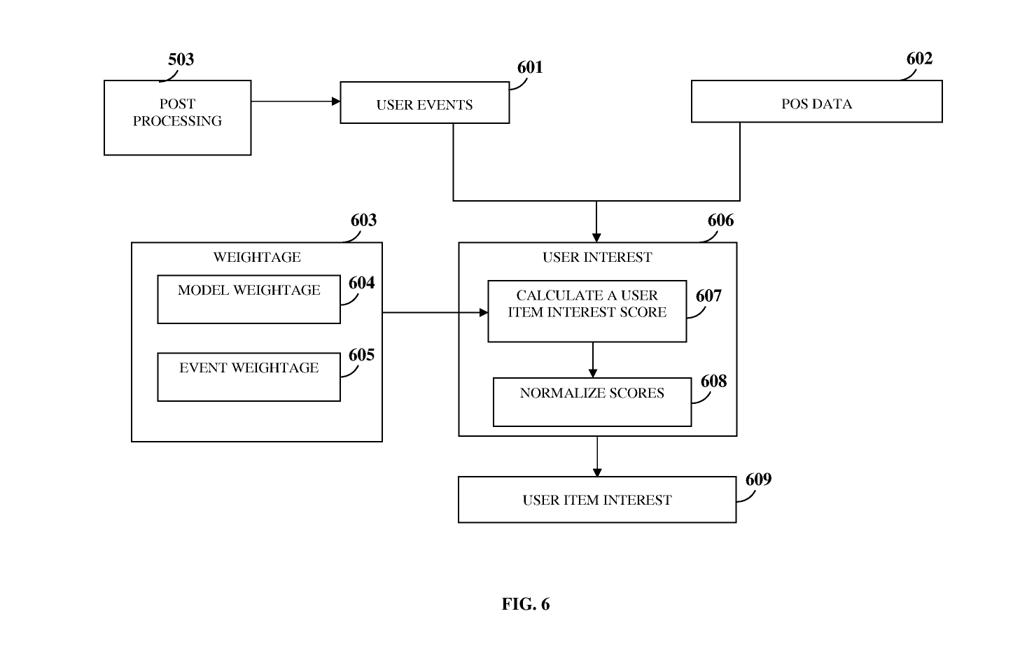

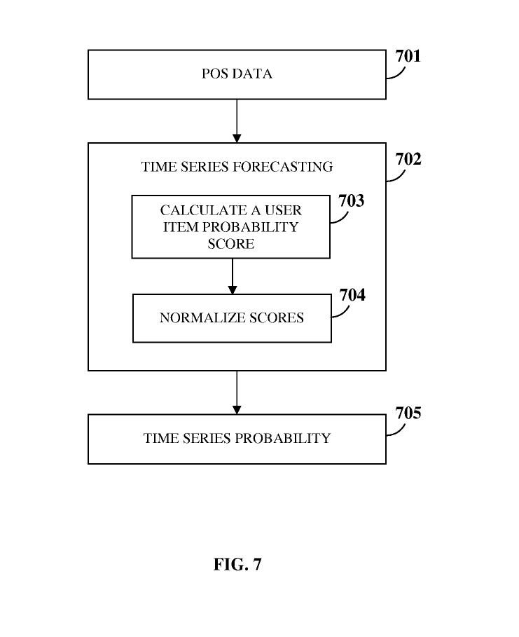

FIG. 6 exemplarily illustrates a flow diagram showing steps performed by the content determination and targeting system for determining user interest 606 towards items. The content determination and targeting system performs the post processing 503 steps of cleansing 504, normalizing 505, and enriching 506 of the stored user events 601 as disclosed in the detailed description of FIG. 5. The content determination and targeting system analyzes user events 601 to determine a user's interest towards certain items, brands, or categories. In an embodiment, the determination of user interest 606 is similar to the determination of user intent as disclosed in the detailed description of FIG. 5. The main difference between user intent and user interest 606 is that user intent is a short term but strong sentiment. For example, if a user is searching for a “white shirt” on a mobile application, then this user activity indicates that the user's intent is to buy a shirt preferably white in color. On the other hand, user interest 606 is a long term preference. For example, if a user purchased a white shirt, then this user activity indicates the user wears shirts and white is the user's color of choice. The content determination and targeting system determines user interest 606 for an item by calculating 607 a user item interest score for each item using weightage 603 comprising, for example, model weightage 604 and event weightage 605. In an embodiment, the content determination and targeting system determines the user item interest score based on point of sale (POS) data 602 and user events 601. The content determination and targeting system calculates the user's POS interest score by using the following formula and parameters:

POS interest score (Pₛ)=1000*F*e^{-0.2T}

T=1+floor (time_difference_in_week(now, order_time))
F=frequency of a given user event happening within the above time units
F=count of POS entries
t>T−1 week and <T

In the above formula, the slope is made less steep and hence, e^{-0.2T} is configured as a buying pattern that is a habit not an impulse buying pattern. The content determination and targeting system determines a total raw item relevancy score, for example, using the following formula:

Total raw item relevancy score={u,i}ΣPₛ*Weightage(BUY_LOC),

where the weightage is obtained from the weightage table disclosed in the detailed description of FIG. 5.

The content determination and targeting system normalizes 608 the total raw item relevancy score to determine the user item interest 609, for example, using the following formula:

Normalized score (Pᵢₜ)=Total raw item relevancy score*100/Maximum score

The content determination and targeting system determines an item relevancy priority, for example, using the following formula configured in the relevancy model:

Item relevancy priority (Pᵢₜᵣₚ)=Average money spent on an item category

The content determination and targeting system determines an event interest score, for example, using the following formulae:

Event interest score (Eᵢₜₛ)=1000*F*e^{-0.2T}

T=1+floor (time_difference_in_day(now, order_time))
F=frequency of a given event within the above time units
F=count of event entries
where t>T−1 day and <T

In the above formula, the slope is made less steep and hence, e^{-0.2T} is configured as a buying pattern that is a habit not an impulse buying pattern. The content determination and targeting system determines a total raw event relevancy score, for example, using the following formula:

Total raw event relevancy score={u,i}ΣEᵢₜₛ*E_{wt}

The content determination and targeting system normalizes the total raw event relevancy score to generate a normalized event relevancy score also referred to as a “digital interest score”, for example, using the following formula:

Normalized event relevancy score (Dᵢₜ)=Raw event relevancy score*100/Maximum score

The content determination and targeting system determines an item relevancy priority, for example, using the following formula configured in the relevancy model:

Item relevancy priority (Dᵢₜᵣₚ)=Average money spent on an item category

The table below exemplarily illustrates the item relevancy priorities calculated based on the event interest analysis used to determine 609 the user item interest.

| | | Raw | Normalized | Item | |
|---|---|---|---|---|---|
| | | event | event | relevancy | |
| User | Item | relevancy | relevancy | priority | |
| ID | SKU | score | score | (Dᵢₜᵣₚ) | Type |
| 1 | 111 | 5239 | 100 | 56 | PIT |
| 1 | 222 | 680 | 12.98 | 56 | PIT |
| 1 | 333 | 320 | 6.108 | 78 | PIT |
| 1 | 444 | 3789 | 100 | 78 | DIT |
| 1 | 444 | 440 | 11.61 | 778 | DIT |

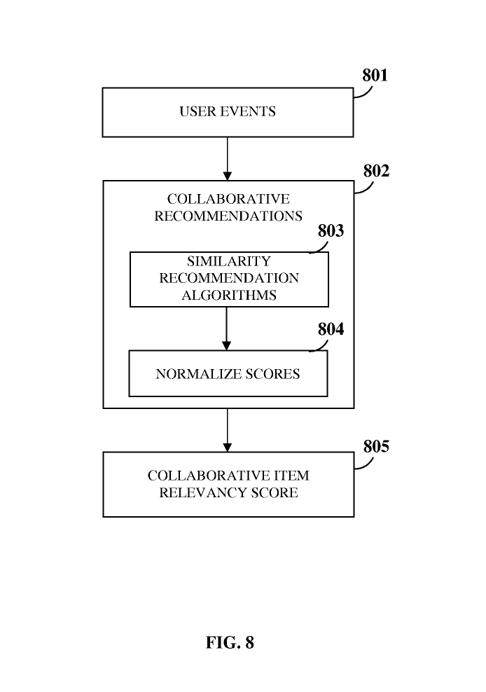

FIG. 7 exemplarily illustrates a flow diagram showing steps of time series forecasting performed by the content determination and targeting system. Time series forecasting is a process of using a model to generate predictions or forecasts for future user activities or actions based on known past user events. Time series data has a natural temporal ordering. Time series forecasting is commonly used for many forecasting applications. The content determination and targeting system determines purchase probability of an item on a given day based on past purchase history and periodicity of purchase by using conventional time series regression based implementations such as the Weka® software, Apache Mahout, etc. As exemplarily illustrated in FIG. 7, the content determination and targeting system performs time series forecasting of point of sale (POS) data 701. The content determination and targeting system performs time series forecasting 702 by executing time series forecasting algorithms and generates forecasts for 1 week for each user and each item. The content determination and targeting system generates 703 a time series score as a user item probability score in a range from 0 to 1, for example, using the following formula:

User item probability score=Probability*100

The content determination and targeting system normalizes 704 the user item probability score in a range from 0 to 100, for example, using the following formula:

Normalized user item probability score (Tₛ)=User item probability score*100/Maximum score

The content determination and targeting system generates an item relevancy priority for the normalized user item probability score for determining time series probability 705, for example, using the following formula configured in the relevancy model:

Item relevancy priority (Tₛᵣₚ)=Average money spent on an item subcategory

The table below exemplarily illustrates time series forecasting 702 implemented by the content determination and targeting system:

| | | | Normalized | | |
|---|---|---|---|---|---|
| | | | user item | Item | |
| | | | probability | relevancy | |
| User | Item | Forecast | score | priority | |
| ID | SKU | day | (Tₛ₎ | (Tₛᵣₚ) | Type |
| 1 | 111 | Feb. 1, 2015 | 12 | 12 | TS |
| 1 | 111 | Feb. 2, 2015 | 20 | 12 | TS |
| 1 | 111 | Feb. 3, 2015 | 80 | 12 | TS |
| 1 | 111 | Feb. 4, 2015 | 100 | 12 | TS |
| 1 | 111 | Feb. 5, 2015 | 60 | 12 | TS |

FIG. 8 exemplarily illustrates a flow diagram showing steps of a collaborative probability analysis performed by the content determination and targeting system. The content determination and targeting system implements relevancy algorithms for analyzing a set of item attributes and recommending relevant content to users who have similar preferences. The relevancy algorithms are a set of similarity based recommendation algorithms 803. For example, the recommendation engine of the content determination and targeting system applies a similarity function on a subset of users in a dataset and returns a value between 0 and 1, with 1 representing two completely similar items and 0 representing completely dissimilar items. For example, Apache Mahout provides Tanimoto coefficient similarity and user based recommendation implementation. In an embodiment, the user events 801 used by the content determination and targeting system to generate 802 collaborative recommendations comprise, for example, user ratings, likes, favorites, shares, etc. In an embodiment, the recommendation engine generates a score between 0 and 1 which is scaled in a range from 0 to 100. The content determination and targeting system determines a collaborative item relevancy score 805, for example, using the following formula:

Raw collaborative item relevancy score=Probability*100

The content determination and targeting system normalizes 804 the raw collaborative item relevancy score to obtain the normalized collaborative item relevancy score 805, for example, using the following formula configured in the relevancy model:

Normalized collaborative item relevancy score (Cₛ)=Raw collaborative item relevancy score*100/maximum score

The content determination and targeting system calculates an item relevancy priority for the normalized collaborative item relevancy score 805, for example, using the following formula:

Collaborative item relevancy priority (Cₛᵣₚ)=Average money spent on an item subcategory

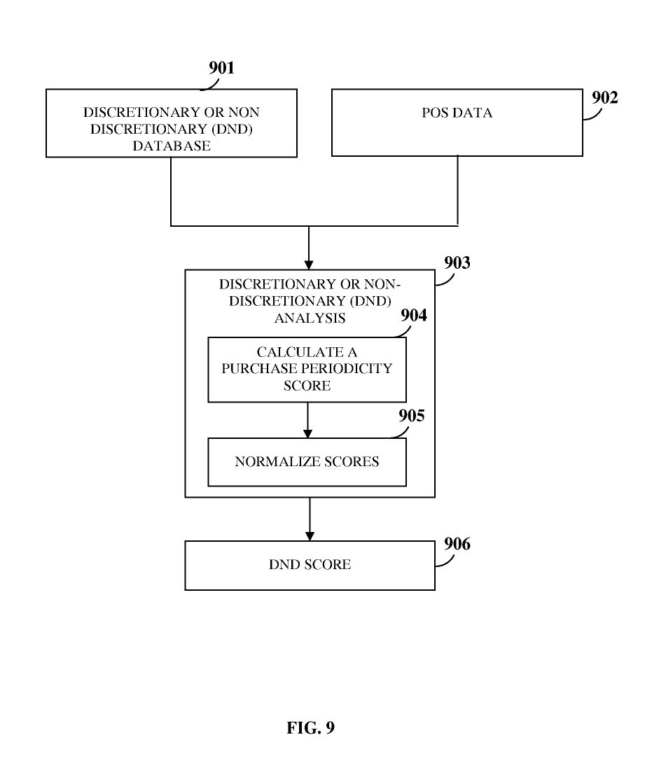

FIG. 9 exemplarily illustrates a flow diagram showing steps of a discretionary or non-discretionary (DND) analysis 903 performed by the content determination and targeting system for determining spending habits of users. Spending habits of users are classified, for example, as discretionary spending habits and non-discretionary spending habits. Discretionary spending habits refer to occasional spending based on external factors, for example, weather, mood, and other external factors. Non-discretionary spending habits refer to regular spending, for example, spending for groceries, that retailers need to promote to increase a shopping cart size. Non-discretionary spending habits are predictive and do not change. The DND nature of an item is available in a DND database 901. The content determination and targeting system checks for the availability of the DND database 901 and checks for availability of an item in the DND database 901. If the item is available, then the DND analysis 903 is not performed and standard values from the DND database 901 are used for the item relevancy score and item relevancy priority. The DND analysis 903 is a modified time series analysis that calculates 904 a purchase periodicity score of an item by a user. The content determination and targeting system performs the DND analysis 903, for example, on point of sale (POS) data 902.

The content determination and targeting system calculates 904 a purchase periodicity score that defines the periodicity of purchase, for example, using the following formula:

Purchase periodicity score=(Number of visits to a store)/(Number of weeks since a first purchase)

If the purchase periodicity score is high, then the content determination and targeting system determines that the item is a non-discretionary item. If the purchase periodicity score is low, then the content determination and targeting system determines that the item is a discretionary item. In an embodiment, the content determination and targeting system normalizes 905 the generated purchase periodicity score, for example, using the following formula to generate a normalized discretionary or non-discretionary (DND) score 906:

Normalized discretionary or non-discretionary (DND) score (D_{NDs})=Purchase periodicity score*100/Maximum score

The content determination and targeting system determines an item relevancy priority for the normalized discretionary or non-discretionary (DND) score 906, for example, using the following formula configured in the relevancy model:

Item relevancy priority (D_{NDrp})=Maximum money spent on an item subcategory

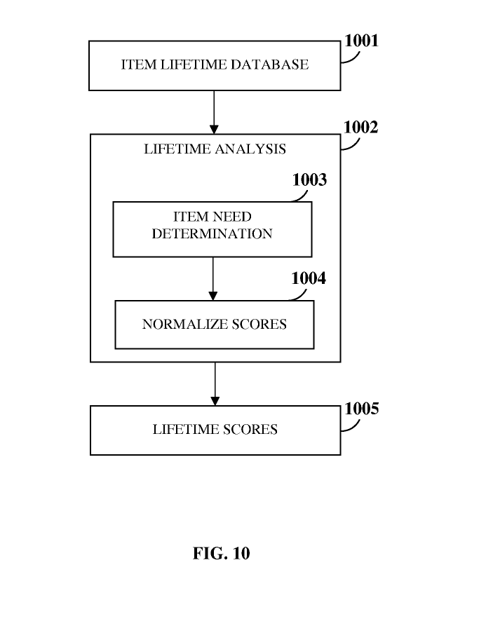

FIG. 10 exemplarily illustrates a flow diagram showing steps of a lifetime analysis 1002 of an item performed by the content determination and targeting system for determining a future need of a user for the same item or for similar items. As used herein, “lifetime of an item” refers to a valid life of an item before a user purchases similar items. Each of the items, for example, product and services has a certain lifetime. For example, some items have a short lifetime and some items have a long lifetime. The content determination and targeting system determines a lifetime of an item and compares the item's lifetime with other similar items' lifetimes to generate an item lifetime predictability score for each item. The table below exemplarily illustrates multiple items and their respective lifetimes in comparison with the lifetimes of similar items or categories:

| | | Similar item or |
|---|---|---|
| Item | Lifetime | category lifetime |
| Milk | 1 week | 0 |
| Television (TV) | 4-5 years | 4-5 years |
| A particular book | Forever | 0 |

The content determination and targeting system stores information associated with the items' lifetimes in an item lifetime database 1001. The content determination and targeting system retrieves information associated with each item's lifetime from the item lifetime database 1001 and applies a lifetime analysis algorithm to perform lifetime analysis 1002 on the item. The content determination and targeting system determines 1003 need for an item. The output of the lifetime analysis algorithm is an item lifetime probability score defined, for example, by the following formula:

$$\begin{matrix}Item lifetime probability score = - 1 * {e}^{- 1.33 / z} for z > 0 \\ = 0 for z \\ = 0\end{matrix}$$

where Z is a total remaining lifetime in weeks of an item or a service.

The content determination and targeting system normalizes 1004 the item lifetime probability score in a range from 0 to 100 to obtain the lifetime scores 1005, for example, by using the following formula:

Normalized item lifetime probability score (P_{lf})=Item lifetime probability score*100/abs(Minimum score)

The lifetime scores obtained from the lifetime analysis 1002 are negative and hence the content determination and targeting system selects a minimum score instead of a maximum score. That is, the content determination and targeting system calculates the maximum lifetime score based on the absolute value of the item lifetime probability scores.

The content determination and targeting system determines an item relevancy priority for each lifetime score, for example, using the following formula configured in the relevancy model:

Item relevancy priority (P_{lfrp})=Average money spent on an item subcategory

The table below exemplarily illustrates results of the lifetime analysis 1002 of the items performed by the content determination and targeting system:

| | | | Normalized | | |
|---|---|---|---|---|---|
| | | | item | | |
| | | Item | lifetime | Item | |
| | | lifetime | probability | relevancy | |
| User | Item | probability | score | priority | |
| ID | SKU | score | (P_{lf}) | (P_{lfrp}) | Type |
| 1 | 111 | −0.1 | −10 | 3 | PLF |
| 1 | 222 | −0.5 | −52 | 2 | PLF |
| 1 | 333 | −0.99 | −100 | 0 | PLF |
| 1 | 444 | −0.7 | −71 | 2 | PLF |

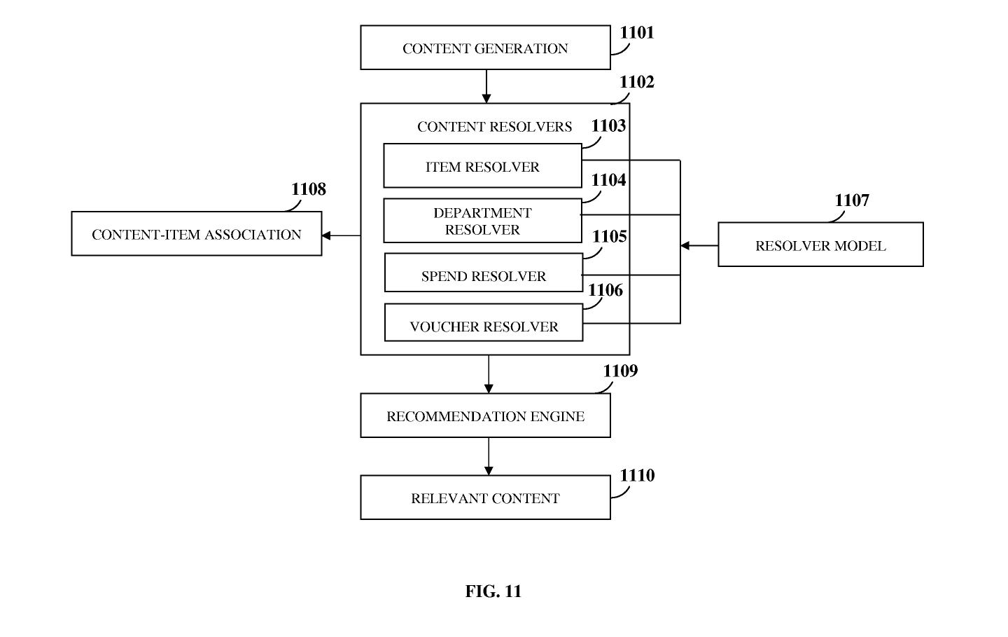

FIG. 11 exemplarily illustrates a flow diagram showing steps performed by the content determination and targeting system for generating an association between an item and relevant content and generating recommendations for targeting the relevant content associated with the item and services to one or more target users. The content determination and targeting system generates 1101 relevant content. During content generation 1101, the content determination and targeting system configures, for example, a content type, an offer type, store availability information such as which store provides an offer or a service, audience information such as age, gender, spending habits, purchase frequency, campaign objectives, etc. The content type comprises, for example, an advertisement type, an offer type, a service type, etc. The offer type comprises, for example, a product discount offer, a departmental discount offer, a generic free discount offer, etc. The generated content is provided to content resolvers 1102 of the content determination and targeting system.

The content resolvers 1102 are configured to analyze the user characteristic information, the item information, and the event information and generate associations between the generated content and one or more items comprising, for example, products and/or services. The content determination and targeting system comprises, for example, an item resolver 1103, a department resolver 1104, a spend resolver 1105, and a voucher resolver 1106. Although the detailed description refers to an item resolver 1103, a department resolver 1104, a spend resolver 1105, and a voucher resolver 1106, the scope of the computer implemented method and system disclosed herein is not limited to the item resolver 1103, the department resolver 1104, the spend resolver 1105, and the voucher resolver 1106, but may be extended to include other functionally equivalent resolvers and additional resolvers. The item resolver 1103 is configured to generate associations between one or more items and the generated content. The department resolver 1104 is configured to resolve the generated content to all items in a given department, and associate the generated content with department information. In an embodiment, the department resolver 1104 communicates with a pre-processing content resolver to identify different departments. The spend resolver 1105 is configured to associate the generated content with spending habits of users. The voucher resolver 1106 is configured to associate the generated content to vouchers and offers provided by a merchant store. The spend resolver 1105 and the voucher resolver 1106 are runtime or target time resolvers that associate users to relevant content 1110 by inserting an artificial record to indicate all users, for example, by assigning a user ID equal to a value of −1. The spend resolver 1105 and the voucher resolver 1106 do not resolve content to items comprising products and/or services. A resolver model 1107 is configured to invoke a one of the content resolvers 1102 for a given offer type as exemplarily illustrated in the table below:

| ID | OFFER_TYPE | RESOLVER |
|---|---|---|
| 1 | DPCS | DEPARTMENTAL_RESOLVER |
| 2 | BACS | CATEGORY_SPEND_RESOLVER |
| 3 | BAXP | CATEGORY_SPEND_RESOLVER |
| 4 | DPXP | DEPARTMENTAL_RESOLVER |
| 5 | FRPR | PROD_RESOLVER |
| 6 | PROD | PROD_RESOLVER |
| 7 | VOCH | VOUCHER_RESOLVER |

The content resolvers 1102 receive the resolver model 1107 as input to generate content-item associations 1108. The content-item associations 1108 are associations between the generated content and the items comprising, for example, products and/or services. The content resolvers 1102 transmit the generated content-item associations 1108 to the recommendation engine 1109. The recommendation engine 1109 generates relevant content 1110 based on the generated content relevancy scores, the generated content relevancy priorities, one or more targeting triggers, the analysis of the user characteristic information, the item information, and the event information.

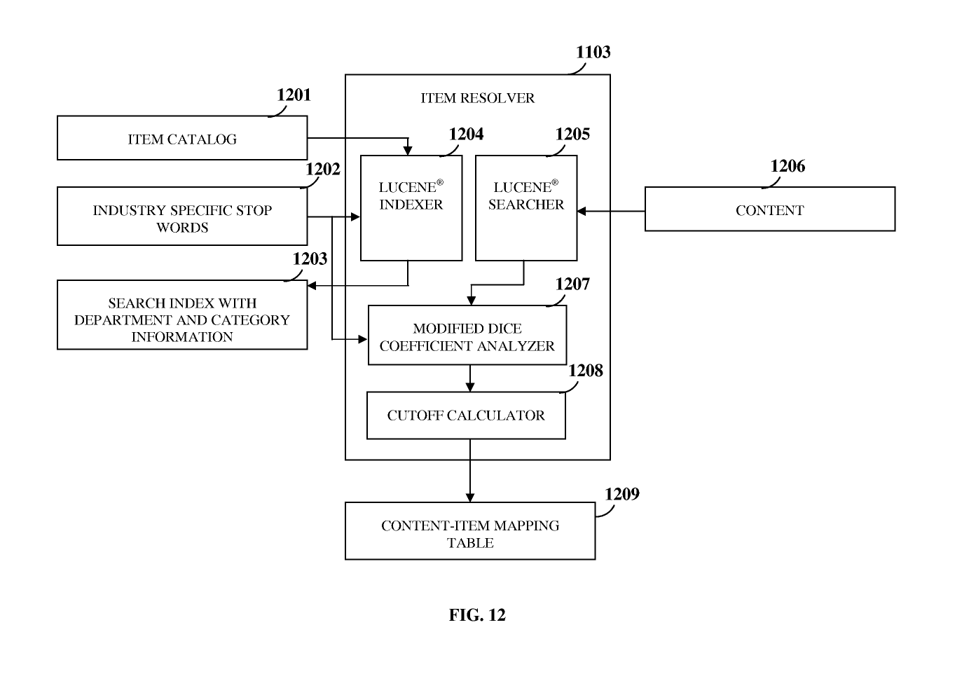

FIG. 12 exemplarily illustrates a flow diagram showing steps performed by the item resolver 1103 of the content determination and targeting system for generating associations between items comprising, for example, products and/or services and relevant content. The item resolver 1103 is configured to generate associations between the items and relevant content. The item resolver 1103 resolves the relevant content to one or more items, for example, based on a title, a description, keywords, etc., of the relevant content. The item resolver 1103 receives item information from an item catalog 1201. In an embodiment, the content determination and targeting system uses industry specific stop words 1202 to remove noise from the received item information. The industry specific stop words 1202 comprise, for example, free, save, any, up to, personal, limit, promotion, etc. The item resolver 1103 comprises, for example, a Lucene® indexer 1204 of The Apache Software Foundation configured to create indexes for the items based on the received item information. In an embodiment, the Lucene® indexer 1204 updates the created indexes only when the item catalog 1201 is updated. While generating the indexes, the Lucene® indexer 1204 applies boost factors, for example, for a category name, subcategory names, department names, etc. In an embodiment, the Lucene® indexer 1204 searches 1203 the created indexes with department and category information. The content determination and targeting system disclosed herein further comprises a Lucene® searcher 1205 configured to resolve content 1206 received from content sources. The content determination and targeting system further comprises a modified dice coefficient analyzer 1207 configured to provide artificial boosts to categories and brands of items to facilitate effective matching of items to relevant content.

In an embodiment, the content determination and targeting system further comprises a cutoff calculator 1208 configured to apply a cutoff criterion to ignore non-matching items. The content determination and targeting system stores the output of the cutoff calculator 1208 in a content-item mapping table 1209. The output, for example, matching scores generated by the content determination and targeting system are used for dynamic filtering of content when there are certain offer limits on items. An example of the content-item mapping table 1209 is exemplarily illustrated below:

| Content | Item | Matching |
|---|---|---|
| ID | SKU | score |
| 1 | 111 | 30 |
| 1 | 222 | 56 |
| 1 | 444 | 1034 |

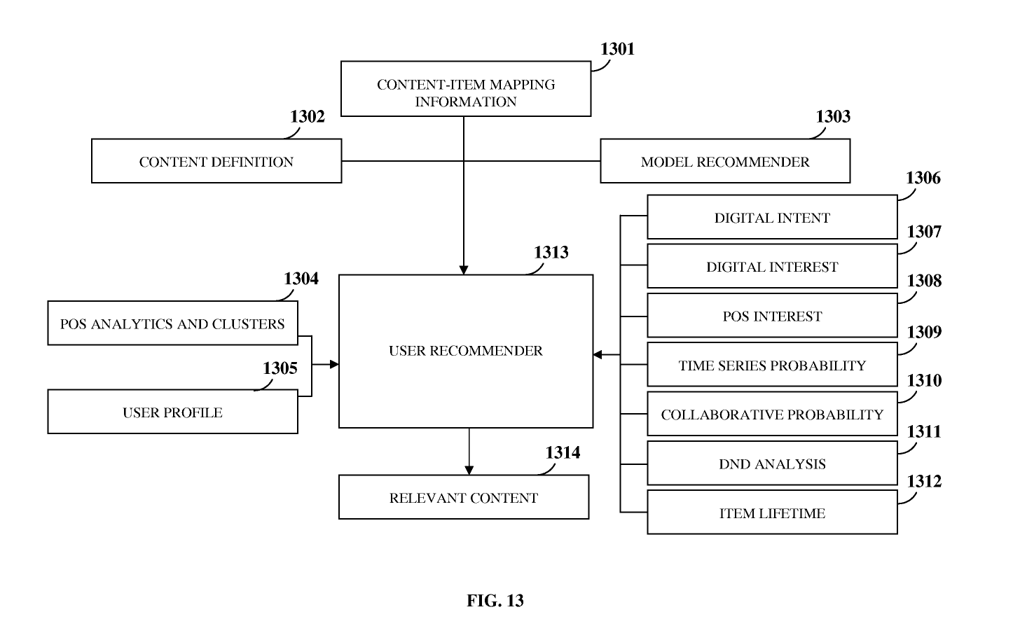

FIG. 13 exemplarily illustrates a flow diagram showing steps performed by the content determination and targeting system for recommending relevant content and services to one or more target users. The content determination and targeting system disclosed herein comprises a user recommender 1313 configured to recommend relevant content and a service to one or more target users based on the analysis of the user characteristic information, the item information, and the event information. The user recommender 1313 receives, for example, content-item mapping information 1301, content definition 1302, model recommendations from a model recommender 1303, point of sale (POS) analytics and clustering information 1304, user profile information 1305, digital intent information 1306, digital interest information 1307, POS interest information 1308, time series probability information 1309, collaborative probability information 1310, discretionary or non-discretionary (DND) analysis information 1311, and item lifetime information 1312. In an embodiment, the content-item mapping information 1301 maintains an association between a content and an item comprising, for example, a product and/or a service which is, for example, a 1:n mapping.

The content definition 1302 comprises information associated, for example, with an offer type, audience age, gender, spending habits, characteristics, etc. In an embodiment, the audience information is translated as a filter that excludes users who do not fit a given criteria. In an embodiment, audience information comprising, for example, age and gender information is stored in a user profile table. Information stored in a clustering analytics table is exemplarily illustrated below:

| User | Time | | Cluster | User |
|---|---|---|---|---|
| #1 | period | Cluster type | name | value |
| 1 | Quarter | High spend | medium | 30 |
| 1 | Quarter | High frequency | low | 3 |
| 1 | Quarter | High volume | low | 12 |
| 1 | Quarter | Bulk | low | 10 |
| 1 | Quarter | Average spend | medium | 3 |
| 1 | Quarter | Weekday shopper | low | 3 |
| 1 | Quarter | Weekend shopper | high | 12 |
| 1 | Quarter | Morning shopper | low | 0 |
| 1 | Quarter | Noon shopper | low | 0 |
| 1 | Quarter | Evening shopper | high | 8 |
| 1 | Quarter | Night shopper | low | 3 |
| 1 | Quarter | On sale | high | 10 |
| 1 | Quarter | Offer | medium | 5 |

An implementation of qualified users is explained in a code snippet disclosed below:

Select USERID from ALL_USERS where GENDER = ‘MALE’ AND AGE BETWEEN
13, 65 AND USERID IN (SELECT
USERID from CLUSTER where CLUSTER_TYPE = ‘HIGH_SPEND’ AND
CLUSTER_NAME = ‘HIGH’

The content determination and targeting system further comprises a model recommender 1303 that determines a model and corresponding weightage, for example, based on an offer type and/or based on a campaign objective. The tables below exemplarily illustrate multiple models recommended by the model recommender 1303 based in the offer type and corresponding weightages:

| ID | OFFER_TYPE | MODELS |
|---|---|---|
| 1 | DPCS | POS_TS, MOB_INT, MOB_INRST, SPND_MOD |
| 2 | BACS | SPND_MOD |
| 3 | BAXP | SPND_MOD |
| 4 | DPXP | POS_TS, MOB_INT, MOB_INRST, SPND_MOD |
| 5 | FRPR | POS_TS, MOB_INT, MOB_INRST |
| 6 | PROD | POS_TS, MOB_INT, MOB_INRST |
| 7 | VOCH | POS_TS, MOB_INT, MOB_INRST, SPND_MOD |

| Content type | Model name | Code | Weightage |
|---|---|---|---|
| PROD | Digital Intent | Din | 0.5 |
| PROD | Digital Interest | Dit | 0.3 |
| PROD | POS Interest | Pit | 0.2 |
| PROD | Time Series | Ts | 0.1 |
| PROD | Collaborative Score | Cs | 0 |
| PROD | Item Lifetime | Plf | 0 |
| PROD | DND | D_{NDs} | 0 |

The user recommender 1313 analyzes, for example, content-item mapping information 1301, applicable models, and model weightage for content, and applies user filters for determining target users for the relevant content 1314. The user recommender 1313 calculates a content relevancy score for each target user, for example, using the following formula:

Content relevancy score=sum of item weightage scores for all applicable models for a given user.

Results of a content relevancy score calculation performed by the user recommender 1313 are exemplarily illustrated in the tables below:

| Content ID | Item SKU |
|---|---|
| 1 | 111 |
| 1 | 222 |

| | | | | | User | Collab- | | |
|---|---|---|---|---|---|---|---|---|
| | | | | | item | orative | | |
| | | Digital | Digital | POS | prob- | item | | |
| | | intent | interest | interest | ability | relevancy | | |
| User | Item | score | score | score | score | score | DND | |
| ID | SKU | (Dᵢₙ) | (Dᵢₜ) | (Pᵢₜ) | (Tₛ) | (Cₛ) | score | P_{lf} |
| 1 | 111 | 50 | 40 | 10 | 12 | 5 | 0 | 0 |
| 1 | 222 | 30 | 12 | 15 | 5 | 9 | 0 | 0 |

As disclosed in the tables above, for a content ID=1 and user ID=1, the content relevancy score is calculated by the formulae disclosed below:

Score for 111+Score for 222

Score for 111=50*D_{inwt}+40*D_{itwt}+10*P_{itwt}+12*T_{swt}+5*C_{swt}=25+12+2+1+0=40

Score for 222=30*Dᵢₙ+12*Dᵢₜ+15*Pᵢₜ+5*Tₛ+9*Cₛ=15+4+3+0+=22

where D_{inwt}, P_{itwt}, T_{swt}, and C_{swt} are model weightages. In an embodiment, if the model weightages are excluded for a given content type, then the model weightages are considered as 0. Hence, the content relevancy score is calculated as 66 and stored as exemplarily illustrated in the table below:

| | | Content | Content |
|---|---|---|---|
| Content | | relevancy | Relevancy |
| ID | User ID | score | priority |
| 1 | 1 | 66 | XXX |

The relevant content 1314 can be linked to various items and hence different item categories. The content relevancy priority is used to order the relevant content 1314 with the same scores or within the same range of scores also referred to as a “score band”. The content determination and targeting system calculates final content relevancy priority for the content, for example, using the following formula:

Content relevancy priority=exp(d)*Fx(Dᵢₙᵣₚ,Dᵢₜᵣₚ,Tₛᵣₚ,D_{ndrp}, . . . )

where d=discount percentage applied to the content represented in decimal, for example, 5%=0.05
exp=an expression involving a discount, for example, (1+d)
Fx=one of the statistical functions, for example, minimum, maximum, mean, median average, weightage average, etc.

“Fx” can be one of the statistical functions disclosed above to generate a minimum content relevancy priority, a maximum content relevancy priority, a mean content relevancy priority, an average content relevancy priority, or a weightage average content relevancy priority based on the same weightage given to score calculation models or any other statistical function which can be applied to a set of data. “exp” refers to an expression which uses a discount. The content determination and targeting system selects “Fx” and “exp” globally or based on a content selection parameter, for example, a campaign objective. For example, if the campaign objective is profitability, the expression can be (1-d), and if the campaign objective is maximum sales, the expression can be (1+d). In an embodiment, the content determination and targeting system calculates the content relevancy priority as a weighted average along with an applicable discount. The applicable discount in the content relevancy priority provides a linear boost to the content. For example, when two sets of content are in the same relevancy band, the content determination and targeting system prefers the content with more discount. Since it is difficult to predict exact user mood and what a user may like at any given point of time, a score of 98 and a score of 96 may not translate into user liking or buying an item with a score of 98. The content determination and targeting system arranges all scores within a given score band in an ascending order based on their corresponding content relevancy priority, which in turn has linear dependency on the discount, that is, an item with more discount is more likely to be purchased.

The content determination and targeting system calculates the content relevancy score and the content relevancy priority, both statically and dynamically at runtime. The content determination and targeting system statically generates the content relevancy score during content generation. The content determination and targeting system uses the content relevancy score for analyzing the targeting reach and campaign effectiveness of the content. The content determination and targeting system performs a runtime calculation when one of the targeting triggers invokes the content determination and targeting system for targeting relevant content. During the runtime calculation, the content determination and targeting system also executes inventory analysis and external event analysis modules to dynamically change discounts and content relevancy scores for effective targeting.

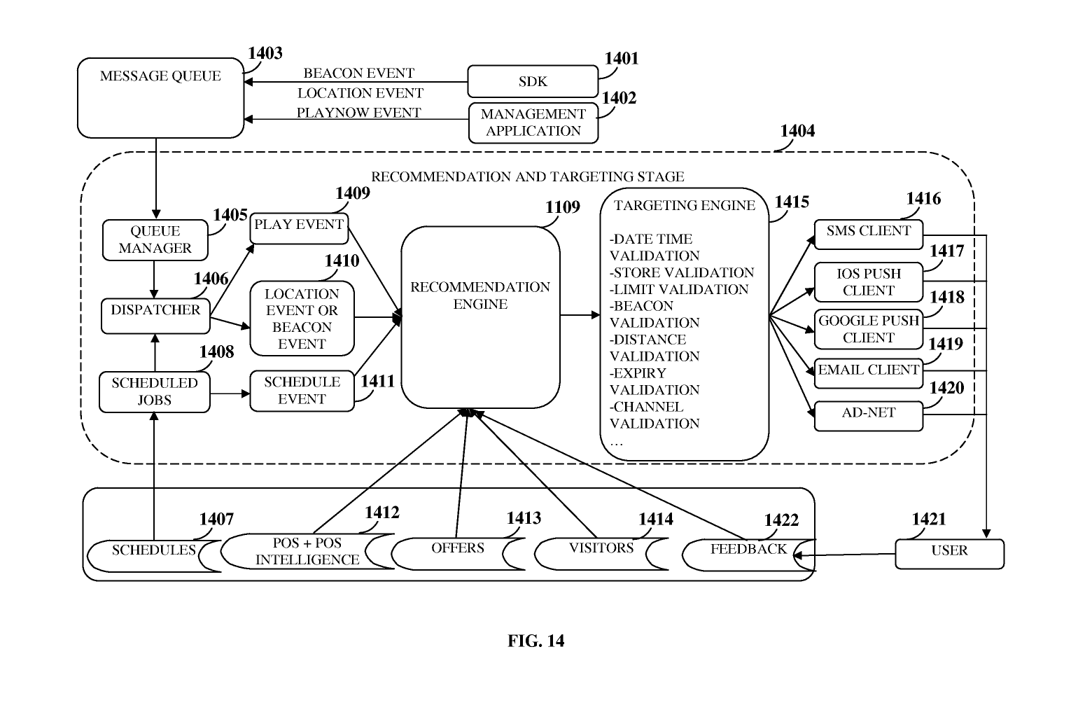

FIG. 14 exemplarily illustrates a flow diagram showing steps performed by the content determination and targeting system for dynamically targeting time, event and inventory based, location-specific, and behavior relevant content and services to users 1421 in an omnichannel environment. FIG. 14 exemplarily illustrates a recommendation and targeting stage 1404 of the computer implemented method disclosed herein. An end user software development kit (SDK) 1401 or an administration and management console application 1402 triggers an event, for example, a beacon event, a location event, a play event, etc. In an embodiment, the events can trigger other tasks that may not invoke recommendation and targeting of relevant content associated with target items and services to a target user 1421. The event is added to a message queue 1403. One or more recommendation and targeting platforms running on one of many nodes dynamically check status of the message queue 1403. The recommendation and targeting platforms peak the message queue 1403 and select an event to process. The content determination and targeting system implements an elaborate message queue blocking algorithm and a delivery mechanism such that the same event is not processed by multiple recommendation and targeting platforms. A queue manager 1405 running in a recommendation and targeting platform server processes and selects an event and determines either to process the event or discard the event. If the event is discarded, the event is still available in the message queue 1403 and other recommendation and targeting platform servers can select the event after a predetermined period of time.

If a recommendation and targeting platform server decides to process the event, then the recommendation and targeting platform server deletes the event from the message queue 1403 after successfully processing the event. The queue manager 1405 sends the events from the message queue 1403 to a dispatcher 1406. The dispatcher 1406 receives events from various trigger sources such as schedules 1407 to generate scheduled jobs 1408 or from the message queue 1403 and sends the events to a corresponding event listener. The event listener is a listener, for example, for a play event 1409, a location event or a beacon event 1410, or a Wi-Fi® event or a schedule event 1411. The event listeners invoke the recommendation engine 1109 with a set of configuration parameters such as point of sale (POS)+POS intelligence 1412, offers 1413, visitor information 1414, feedback 1422, etc. As used herein, “POS+POS intelligence” refers to a cumulative intelligence gathered by processing POS data, for example, user intent, user interest, user behavior, etc., as disclosed in the detailed description of FIGS. 2-6. The recommendation engine 1109 uses the configuration parameters for dynamically generating recommendations. The recommendation engine 1109 creates an algorithm flow and weightage model based on the configuration parameters. The recommendation engine 1109 reads content, user characteristic information, and feedback 1422 to calculate a score for relevant content for each user 1421, thereby creating an ordered list of relevant content, for example, offers, advertisements, etc., and services for each user 1421.

The recommendation engine 1109, in the recommendation and targeting stage 1404, transmits the relevant content to a targeting engine 1415. The targeting engine 1415 performs date time validation, store validation, limit validation, beacon validation, distance validation, expiry validation, channel validation, etc. The targeting engine 1415 selects the relevant content for a target item, for example, based on various validation rules, targeting channels, targeting history, targeting settings, targeting preferences, etc. Once the targeting engine 1415 selects the relevant content, the targeting engine 1415 transmits the relevant content to a target user 1421 via one or more targeting channel clients comprising, for example, the iOS push notification client 1417 of Apple Inc., the Google push notification client 1418, an electronic mail (email) client 1419, a short message service (SMS) client 1416, an advertising network (ad-net) 1420, etc. The content determination and targeting system optimizes each of the targeting channel clients to send a substantial amount of relevant content to one or more target users 1421. Once a target user 1421 receives the dispatched relevant content, he/she may or may not view or click on the dispatched relevant content. The content determination and targeting system captures any of these user interactions as feedback 1422. The recommendation engine 1109 uses the received feedback 1422 to determine positive or negative user sentiments towards the target item.

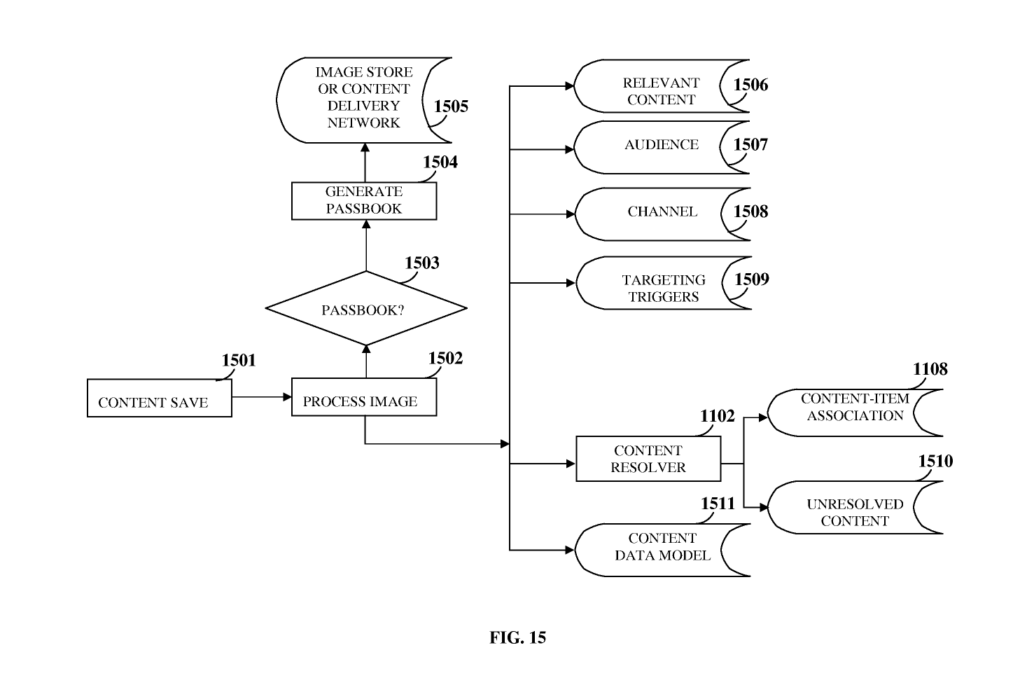

FIG. 15 exemplarily illustrates a flow diagram showing steps performed by the content determination and targeting system for generating and enriching relevant content 1506 and associating the generated relevant content 1506 with an item. The content determination and targeting system generates or acquires relevant content from multiple content sources and saves 1501 the generated or acquired relevant content in a data repository. In an embodiment, the content determination and targeting system generates an image for the generated or acquired relevant content. In another embodiment, the content determination and targeting system retrieves and uses an image of the generated or acquired relevant content that was already saved in the data repository during the content generation process performed by the content determination and targeting system. The content determination and targeting system processes 1502 the image of the generated or acquired relevant content and checks 1503 and generates 1504 a passbook for the generated or acquired relevant content. Once the content determination and targeting system generates 1504 a passbook for the generated or acquired relevant content, the content determination and targeting system stores the generated passbook and the processed image in an image store or in a content delivery network (CDN) 1505. The processed image is used to generate relevant content 1506, determine an audience 1507 for the content, determine a channel 1508 for targeting the generated relevant content, and determine targeting triggers 1509 for initiating generation of recommendations for targeting the generated relevant content.

After processing the image and generating a passbook, the content determination and targeting system returns a uniform resource locator (URL) that references the locations of the processed image and the generated passbook. The content determination and targeting system stores the URL in a content data model 1511. The content saving process 1501 also creates relationships between the content and a merchant store where the relevant content is available. In an embodiment, the content determination and targeting system assigns a store value to the relevant content. For example, if the relevant content is available in all merchant stores or an online merchant store, then a store value for the merchant store is defaulted, for example, to a value of 0 or −1 that represents “All”. Once the generated or acquired relevant content is stored in the content data model 1511, the content determination and targeting system triggers and executes a content resolver 1102 to generate a content-item association 1108 between items and the generated or acquired relevant content. The content that is not resolved by the content resolver 1102 is stored as unresolved content 1510 in an unresolved content table for manual content resolution.

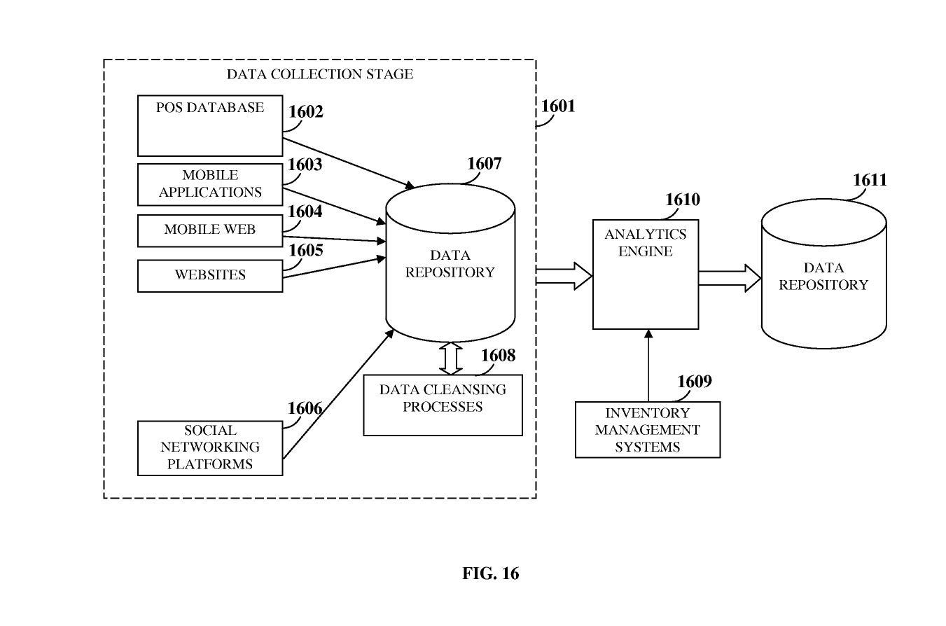

FIG. 16 exemplarily illustrates a flow diagram showing steps performed by the content determination and targeting system for receiving and analyzing user characteristic information, item information, and event information from multiple different information sources for identifying and targeting relevant content and services to users in real time in an omnichannel environment. As exemplarily illustrated in FIG. 16, in the data collection stage 1601, the content determination and targeting system receives data comprising, for example, the user characteristic information, the item information, and the event information from multiple different information sources comprising, for example, a merchant's point of sale (POS) database 1602, mobile applications 1603, mobile web 1604, websites 1605, social networking platforms 1606, etc. As inventory changes frequently, the content determination and targeting system does not store inventory information in a data repository 1607. The content determination and targeting system retrieves the inventory information in near real time and caches the inventory information for a short duration of time which depends on inventory levels. For example, when the inventory level is more, the cache duration is long.

As exemplarily illustrated in FIG. 16, the content determination and targeting system comprises a data repository 1607 for collecting and storing the data comprising, for example, the user characteristic information, the item information, and the event information during the data collection stage 1601 and another data repository 1611 for a data analysis stage. The data repositories 1607 and 1611 can be any storage area or medium that can be used for storing data and files. The data repositories 1607 and 1611 can be, for example, any distributed or relational database or a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc., or any data store or database that stores substantially large amounts of data and has optimal read and write characteristics. In an embodiment, the data repositories 1607 and 1611 can also be a location on a file system. In another embodiment, the data repositories 1607 and 1611 can be remotely accessed by the content determination and targeting system via a network, for example, the internet. In another embodiment, the data repositories 1607 and 1611 are configured as a cloud based databases implemented in a cloud computing environment, where computing resources are delivered as a service over a network, for example, the internet. As used herein, “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. In another embodiment, the content determination and targeting system employs tools comprising, for example, the Apache Cassandra database, the Apache Spark™ engine of The Apache Software Foundation, the MLib machine learning library of The Apache Software Foundation, the Weka® machine learning libraries developed at the University of Waikato, New Zealand, Apache Hadoop® of The Apache Software Foundation, relational databases, etc., and database connectivity techniques such as Java database connectivity (JDBC®) developed by Sun Microsystems, Inc., Cassandra drivers, etc., for data storage in the data repositories 1607 and 1611.

In an embodiment, the content determination and targeting system transforms and normalizes the data received from the point of sale (POS) database 1602. The content determination and targeting system then performs data cleansing processes 1608 on the transformed and normalized data and stores the cleansed data in the data repository 1607. In an embodiment, the content determination and targeting system executes the process of reading the data using conventional industrial data warehousing techniques comprising, for example, extract, transform, and load (ETL) or extract, load, and transform (ELT). The end result of reading the data from the information sources remains the same, irrespective of the industrial data warehousing technique employed by the content determination and targeting system. In an embodiment, the process of collecting the data comprising, for example, the user characteristic information, the item information, and the event information from the POS database 1602 is generally a batch process.

In an embodiment, mobile applications 1603 hosted and managed by merchants are integrated with data acquisition software development kits (SDKs) of the content determination and targeting system. The data acquisition SDKs receive and collect information associated with user interactions with the merchants' mobile applications 1603 and posts the user interaction information that define user events to an application server of the content determination and targeting system located in a cloud computing environment. The application server stores the user events in the data repository 1607. The user events captured by the content determination and targeting system comprise, for example, app_open, app_close, site_open, site_close, login, logout, page_click, tab_click, page_browse, tab_browse for a scrolling action, category_click, product_click, product_open, product_close, offer_click, offer_open, offer_close, product_search, category_search, item_search, item_scan, price_check, add_to_cart, remove_from_cart, buy, add_to_fav, publish_to_social_media, send_email, snap_taken, email_open, pass_view, pass_open, push_view, push_open, etc. In an embodiment, the content determination and targeting system cleanses the user events extracted from the mobile applications 1603 either before storing the user events in the data repository 1607 or as part of batch processing.

In an embodiment, mobile web 1604 and websites 1605 hosted and managed by merchants are integrated with data acquisition software development kits (SDKs) of the content determination and targeting system. The data acquisition SDKs receive and collect information associated with user interaction with the merchants' mobile web 1604 and websites 1605, and posts the user interaction information that define user events to the application server of the content determination and targeting system located in the cloud computing environment. The application server stores the user events in the data repository 1607. In an embodiment, the content determination and targeting system cleanses the user events extracted from mobile web 1604 and websites 1605 either before storing the user events in the data repository 1607 or as part of batch processing. In an embodiment, the merchants' mobile web 1604 and websites 1605 use cookies and third party services to identify and track user activities on the merchants' mobile web 1604 and websites 1605.

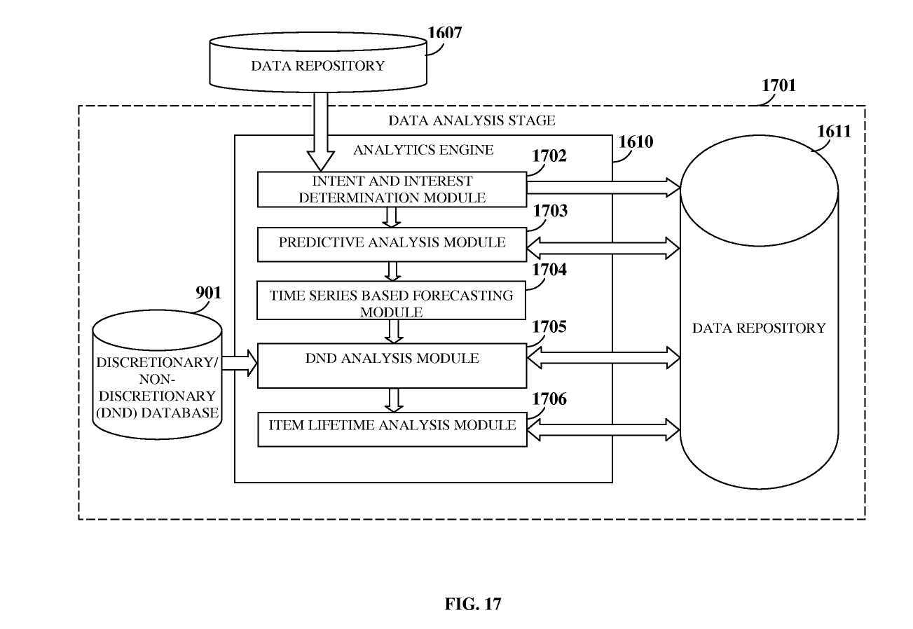

In an embodiment, the content determination and targeting system integrates with merchants' social networking platforms 1606 and crawls for data comprising, for example, user characteristic information, item information, and event information from the social networking platforms 1606. The content determination and targeting system stores the received data from the social networking platforms 1606 in the data repository 1607. In an embodiment, the content determination and targeting system tags each record of data received from the social networking platforms 1606 with the user identification information. The content determination and targeting system further comprises an analytics engine 1610 that analyzes the user characteristic information, the item information, and the event information retrieved from the data repository 1607 based on multiple analytical parameters as disclosed in the detailed description of FIG. 17. In an embodiment, the analytics engine 1610 communicates with inventory management systems 1609 for analyzing inventory information to provide, for example, dynamic relevant offers based on item availability and create dynamic offers for revenue and profit optimization with consideration to the users, for example, customers and merchants. For example, the analytics engine 1610 tracks perishable items, excess inventory, etc., and dynamically proposes offers and prices. The content determination and targeting system stores the analyzed user characteristic information, item information, event information, and inventory information in the data repository 1611.

FIG. 17 exemplarily illustrates a flow diagram showing steps performed by the content determination and targeting system for analyzing user characteristic information, item information, and event information. FIG. 17 exemplarily illustrates a data analysis stage 1701 of the computer implemented method disclosed herein. As exemplarily illustrated in FIG. 17, the analytics engine 1610 of the content determination and targeting system receives the user characteristic information, the item information, and the event information from the data repository 1607. The analytics engine 1610 implements multiple out of the box algorithms to analyze user behavior based on the received user characteristic information, the item information, and the event information and create clusters. In an embodiment, the analytics engine 1610 processes user events from two perspectives, for example, user behavior or user intent/user interest and user feedback. For example, when the analytics engine 1610 receives information associated with a user's clicking action on certain items or categories and content associated with the items, the analytics engine 1610 determines that the user is interested in those items or categories and the content associated with those items. In another example, if a user clicks on an item, service, or content targeted to him/her, the analytics engine 1610 determines a positive feedback or a positive sentiment for the item, service, or content from the clicking action. If the user does not click on an item, service, or content targeted to him/her, the analytics engine 1610 determines the lack of a clicking action as a negative feedback or a negative sentiment for the item, service, or content. In an embodiment, in the absence of point of sale (POS) data, the above analysis is useful in determining user interest dimensions and global interest dimensions and generating an item relevancy score and an item relevancy priority for each item.

As exemplarily illustrated in FIG. 17, the analytics engine 1610 comprises an intent and interest determination module 1702, a predictive analysis module 1703, a time series based forecasting module 1704, a discretionary or non-discretionary (DND) analysis module 1705, an item lifetime analysis module 1706, etc. The intent and interest determination module 1702 analyzes the user characteristic information, the item information, and the event information received from the data repository 1607 for determining, for example, user intent dimensions, user interest dimensions, and global interest dimensions. The user intent dimensions and the user interest dimensions comprise, for example, top brands based on point of sale (POS) data analysis, favorite brands based on event information analysis, non-favorite brands based on event information analysis, top stores based on POS data analysis, top favorite timeslots based on event information analysis, top favorite cities based on event information analysis, top favorite stores based on event information analysis, top products, top categories, or top subcategories of products based on POS data analysis, needs for various products based on POS data analysis of buying frequency, preferred days, a preferred category for a day, a minimum order size in terms of dollars ($), a maximum order size in terms of dollars ($), or an average order size in terms of dollars ($), total orders, total items purchased, average number of items purchased, average number of days between purchases, top number of purchases in terms of dollars ($), top shared content, top liked coupons, total number of online purchases, total offers redeemed, a preferred timeslot based on POS data analysis, maximum number of days between purchases, favorite notification channels, most shopped day and customer count on a daily basis, most shopped product of a day, a week, or a month, most shopped category of a day, a week, or a month, most shopped store of a day, a week, or a month, total number of offers reached, viewed, or opened, high spend brands, high spend categories, or high spend locations, top selling brands, top selling categories, or top selling locations, low spend brands, low spend categories, or low spend locations, low selling brands, low selling categories, or low selling locations, total number of geolocation clicks, total number of geo-conquest clicks, excess inventory products, high demand items, etc.

In an embodiment, the intent and interest determination module 1702 generates user interest graphs using the determined user interest dimensions. In an embodiment, the user interest graphs represent, for example, a usage pattern based on a most common date and time in store and online, a buying pattern based on a most common shopping time in store and online, price points based on most comfortable price points such as minimum price points, maximum price points, or average price points, items bought based on top brands, top products, top services, or top styles, user events based on top brands, top products, top services, or top styles, ready to buy items, gender preferences based on item preferences of men, women, or kids, age based preferences, item category and subcategory preferences, time spent by users in mobile applications, websites, a webpage, a product, or a category of items, etc.

In an embodiment, the intent and interest determination module 1702 determines the global interest dimensions at a global level across all users while ignoring user interest dimensions. The global interest dimensions comprise, for example, top brands based on point of sale (POS) data analysis, favorite brands based on event information analysis, non-favorite brands based on event information analysis, top stores based on POS data analysis, top favorite timeslots based on event information analysis, top favorite cities based on event information analysis, top favorite stores based on event information analysis, top products, top categories, or top subcategories based on POS data analysis, needs for products based on POS data analysis of buying frequency, preferred days, preferred category for a day, top shared offers, top liked coupons, average number of offers redeemed in a day, a week, or a month, a preferred day based on POS data analysis, a preferred timeslot based on POS data analysis, maximum number of days between purchases, minimum number of days between purchases, favorite notification channels, most shopped day and customer count daily, most shopped product of a day, a week, or a month, most shopped category of a day, a week, or a month, most shopped store of a day, a week, or a month, total number of offers or content reached, viewed, or opened, high spend brands, high spend categories, or high spend locations, top selling brands, top selling categories, or top selling locations, low spend brands, low spend categories, or low spend locations, low selling brands, low selling categories, or low selling locations, total number of geo-location clicks, total number of geo-conquest clicks, etc.

The user intent dimensions, the user interest dimensions, and the global interest dimensions are used to determine relevancy of content for a target user, and also in other analysis steps performed by the content determination and targeting system as disclosed in the detailed description of FIG. 17, and by the recommendation engine 1109 exemplarily illustrated in FIG. 11, during the targeting phase. The content determination and targeting system uses the global interest dimensions for anonymous users, unidentified users, or for users about whom sufficient information is not available in the content determination and targeting system.

The predictive analysis module 1703 analyzes the received user characteristic information and provides inputs to the recommendation engine 1109 of the content determination and targeting system. In an embodiment, the predictive analysis module 1703 comprises multiple subcomponents (not shown) that generate scores at an item and/or a category level. In an embodiment, each subcomponent can be enabled or disabled and the input to the subcomponents and to the recommendation engine 1109 can be managed. In an embodiment, the subcomponents of the predictive analysis module 1703 comprise a purchase activity prediction module (not shown), a user clustering module (not shown), and a scoring and prioritization module (not shown in FIG. 17). The purchase activity prediction module is a time-series analysis and forecasting module. The purchase activity prediction module analyzes a user's purchase history and predicts what he/she may buy on a daily basis. The purchase activity prediction module generates a daily prediction score for each item (DPpi) as an output. The daily prediction score is determined as a value on a scale of 0 to 100, where the value “0” indicates zero probability of purchase and the value “100” indicates a high probability of purchase.

The user clustering module of the predictive analysis module 1703 generates clusters of users based on user interest dimensions determined by the intent and interest determination module 1702. The clusters comprise, for example, weekend shoppers, weekday shoppers, brand specific shoppers, category specific shoppers, morning shoppers, evening shoppers, high spenders, low spenders, discount grabbers, etc. In an embodiment, each cluster is divided into three or more categories depending upon a requested granularity. The content determination and targeting system uses most of these clusters for filtering purposes to facilitate identification of target users. Even though the clusters have implicit scores such as total dollars spent by one or more users for a particular item of a particular category, the user clustering module does not generate scores for the clusters, as the clusters are used for filtering purposes.

The scoring and prioritization module analyzes user characteristic information of one or more users and matches the users based on various buying patterns. The scoring and prioritization module categorizes the users into various clusters and then provides a predictive insight into what other items a user may like based on the determined clusters. As the number of items (nᵢ) and number of users (nᵤ) can be very high, the collaborative analysis performed nᵢ×nᵤ times by the scoring and prioritization module can be time consuming and central processing unit (CPU) intensive. The scoring and prioritization module avoids the problem of wastage CPU cycles by executing a relevancy algorithm for a set of users categorized into well-defined clusters having matching user interest dimensions. In an embodiment, the set of user interest dimensions are preset. In another embodiment, the user interest dimensions can be dynamically controlled via external inputs received by the content determination and targeting system. In an example, the scoring and prioritization module executes the relevancy algorithm for users, for example, who are high spenders, who like the same category of items, who are discount grabbers, etc. In an embodiment, the scoring and prioritization module receives external inputs, for example, an offer or an offer campaign that defines goals or criteria for a campaign determined by merchants or retailers. The output of the scoring and prioritization module is an item relevancy score and an item relevancy priority, where the scoring and prioritization module generates the item relevancy score and the item relevancy priority based on daily prediction scores of the items determined based on individual user interest dimensions for the selection of the items. For example, a normalized price point can be a score for a high spender, a normalized aggregated spending score for a given category of items is used for determining category cluster scores, etc. The item relevancy score generated by the scoring and prioritization module for each item is a normalized score aggregated across all input clusters and/or user interest dimensions. In an embodiment, the item relevancy score is normalized to a score of 0 to 100.

The time series based forecasting module 1704 performs time series forecasting as disclosed in the detailed description of FIG. 7. The discretionary or non-discretionary (DND) analysis module 1705 is a modified time series analysis module that determines purchase periodicity of an item. The DND analysis module 1705 predicts, for example, two types of spending habits based on general user behavior. The spending habits comprise, for example, non-discretionary spending habits and discretionary spending habits. The non-discretionary spending habits refer to spending habits of users who frequently spend on items such as groceries. The non-discretionary spending habits are predictive and generally users do not change their non-discretionary spending habits, and hence, most of the time, retailers do not need to work hard for this part of customer business. The discretionary spending habits refer to spending habits of users who spend occasionally based on weather, mood, and other external factors. Retailers need to emphasize on promoting their items to users with discretionary spending habits to increase their shopping cart size. The DND analysis module 1705 determines users with non-discretionary spending habits and/or discretionary spending habits and helps retailers to concentrate on the users who can bring them more business. A user can be associated with non-discretionary spending habits and/or discretionary spending habits based on a cluster to which the user belongs. Information on whether an item is discretionary or non-discretionary is stored in the DND database 901 exemplarily illustrated in FIG. 9. The information stored in the DND database 901 is used to control and overwrite the algorithm used for the DND analysis. If the DND database 901 is available and the item is available in the DND database 901, the DND analysis module 1705 ignores a DND item relevancy score and uses DND characteristics of the items from the DND database 901 for the item relevancy score and item relevancy priority. In the absence of the DND database 901 or the item in the DND database 901, the content determination and targeting system uses the DND item relevancy score along with a predefined score above which scores are treated as non-discretionary and below which scores are treated as discretionary. The DND analysis module 1705 generates a DND score for each item. For example, the DND analysis module 1705 generates a high DND score for non-discretionary items and low DND scores for discretionary items. The value of the DND score is inversely proportional to a purchase periodicity of an item. The DND analysis module 1705 normalizes the DND score across all users, for example, in a range from 0 to 100.

The item lifetime analysis module 1706 determines a lifetime of an item and compares the item lifetime with lifetimes of other similar items to generate an item lifetime predictability score for each item. In an embodiment, the item lifetime analysis module 1706 normalizes the generated probability score for each item, for example, in a range from 0 to 100.

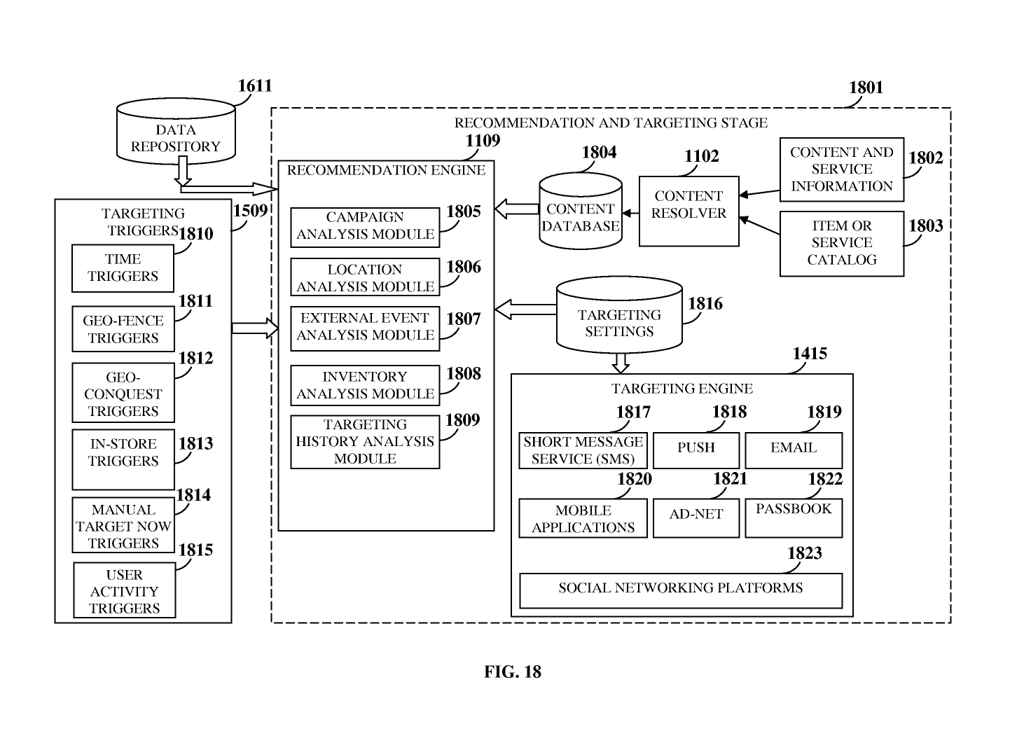

FIG. 18 exemplarily illustrates a flow diagram showing a recommendation and targeting stage 1801 of the computer implemented method for dynamically targeting time, event and inventory based, location-specific, and behavior relevant content and services to users in an omnichannel environment. The recommendation engine 1109 of the content determination and targeting system comprises multiple analytics subcomponents, for example, a campaign analysis module 1805, a location analysis module 1806, an external event analysis module 1807, an inventory analysis module 1808, and a targeting history analysis module 1809. The recommendation engine 1109 receives the user characteristic information, the item information, and the event information from the data repository 1611. The content determination and targeting system receives content and service information 1802 and item or service catalogs 1803 from content sources, and stores the received content and service information 1802, and the item or service catalogs 1803 in a content database 1804. The content resolvers 1102 resolve the received content and service information 1802 and the item or service catalogs 1803. The recommendation engine 1109 acquires the received content and service information 1802 and the received item or service catalogs 1803 from the content database 1804.

The recommendation engine 1109 dynamically generates recommendations for dynamically targeting relevant content and services to target users using one or more targeting triggers 1509 comprising, for example, time triggers 1810, geolocation triggers such as geo-fence triggers 1811 and geo-conquest triggers 1812, in-store triggers 1813 such as Wi-Fi® triggers, manual target now triggers 1814, user activity triggers 1815, etc. A time trigger 1810 triggers the recommendation engine 1109, for example, every day at 10 a.m. for generating a recommendation of relevant content and services for targeting to users via an electronic mail (email) 1819 service. A geolocation trigger triggers the recommendation engine 1109 to generate a recommendation of relevant content and services for transmission to a user device, for example, via a short message service (SMS) 1817 when a user is near a retailer's store. Such a geolocation trigger is called a geo-fence trigger 1811. A geo-conquest trigger 1812 triggers the recommendation engine 1109 to generate a recommendation of relevant content and services for transmission to a user device, for example, via a push notification 1818 when a user shops at a competitor's store. An in-store trigger 1813 such as a Wi-Fi® trigger triggers the recommendation engine 1109 to recommend an offer to a user, for example, located in a wine aisle of a retail store.

Manual target now triggers 1814 refer to immediate triggers that are invoked manually based on a function to be performed. Consider an example where a store manager finds excess stock of an item such as milk that is going to expire soon in his/her store. The store manager creates an item discount offer for the item and presses a “send now” button provided on a graphical user interface of the content determination and targeting system, to send the item discount offer to user devices of target users. When the store manager presses the “send now” button, the manual target now trigger 1814 triggers the recommendation engine 1109 to recommend the item discount offer to the target users to facilitate stock clearance of the item before expiration. Other triggers are automatic and are triggered when conditions are met. For example, scheduled triggers are triggered when a scheduled time condition is met. A user activity trigger 1815 triggers the recommendation engine 1109 to generate a recommendation of relevant content and services to a user, for example, when the user is browsing the mobile web or a customer web portal. The targeting triggers 1509 do not determine an actual channel or content for a user. The targeting triggers 1509 start a recommendation process by transmitting a notification to the recommendation engine 1109, and the recommendation engine 1109 dynamically generates recommendations for dynamically targeting relevant content and services to users based on the targeting triggers 1509.

The recommendation engine 1109 executes the campaign analysis module 1805, the location analysis module 1806, the external event analysis module 1807, the inventory analysis module 1808, and the targeting history analysis module 1809 to generate a final list of ordered content which is passed to the targeting engine 1415. The campaign analysis module 1805 analyzes user characteristic information, item information, and event information, for example, based on content selection parameters comprising, for example, campaign goals and predetermined selection criteria. The campaign analysis module 1805 executes a set of algorithms for calculating a weighted relevancy score to be assigned to relevant content based on the campaign goals and the predetermined selection criteria as disclosed in the detailed descriptions of FIG. 5-13. The campaign analysis module 1805 executes intent analysis on a near real time basis to take into account latest user feedback and uses the score for the final aggregation and to arrive at a content relevancy score as disclosed in the detailed description of FIG. 13.

The location analysis module 1806 generates recommendations for targeting relevant content and services to one or more target users based on geo-fence triggers 1811, geo-conquest triggers 1812, and in-store triggers 1813, for example, beacons, Wi-Fi®, etc. The location analysis module 1806 is activated for location based triggering of relevant content and services. The location analysis module 1806 filters relevant content that is meant for location based targeting. The external event analysis module 1807 analyzes the received characteristic information, the item information, and the event information based on external events comprising, for example, weather related events, sports related events, traditional holiday events, weekends, etc. The external events and a corresponding relevancy boost factor are stored in an item catalog database. The external event analysis module 1807 analyzes the applicable external events and dynamically adjusts the content relevancy score of the corresponding content. Relevancy boost factors associated with the external events are greater than 1 (>1), and hence the content relevancy score of the content to which these relevancy boost factors are applied gets a boost. Once the recommendation engine 1109 executes the external event analysis module 1807, the contents are reordered to ensure that the content with the highest content relevancy score is positioned at the top.

The inventory analysis module 1808 triggers the recommendation engine 1109 to generate recommendations for targeting relevant content and services to one or more target users, for example, to handle excess inventory, perishable items, and high demand items, and dynamically recommend items and services for revenue generation and management and profit optimization. The inventory analysis module 1808 also tags the content for regeneration and the content is regenerated with new discount information before final targeting. The targeting history analysis module 1809 receives targeting settings 1816 and targeting history as input and filters content that do not match the targeting settings 1816. The targeting settings 1816 comprise, for example, sending relevant content on a short message service (SMS) channel only once a day; daily, weekly, monthly, and lifetime limits of any campaign; daily, weekly, monthly, and lifetime limits of a selected campaign; a total send limit of a campaign such as a send limit of about first 1000 users; daily, weekly, or monthly limits per channel for each user; daily, weekly, or monthly limits across multiple channels per user; transmitting relevant content to target users between 3 pm and 6 pm, etc. The targeting history analysis module 1809 facilitates localized, contextual, and personalized content delivery, for example, via omnichannels, in-store beacons, etc.

The filtered content from each of the campaign analysis module 1805, the location analysis module 1806, and the external event analysis module 1807 are sorted based on their content relevancy scores and content relevancy priorities and transmitted to the targeting engine 1415 that sends the relevant content to one or more target users through a selected channel. The targeting engine 1415 sends relevant content to user devices of one or more target users, for example, via short message service (SMS) 1817, push notifications 1818, an electronic mail (email) service 1819, mobile applications 1820, an advertising network (ad-net) 1821, a passbook 1822, social networking platforms 1823, etc.

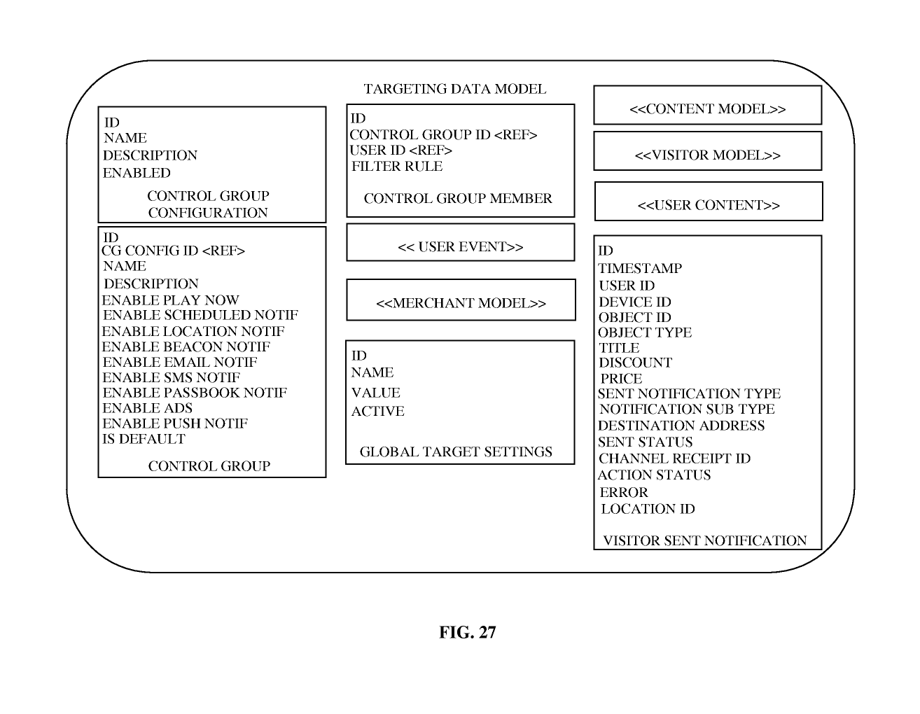

Time triggers 1810 scan for high scored content available during a day and reserves a send slot for the high scored content. The targeting engine 1415 uses a targeting data model, exemplarily illustrated in FIG. 27, to first check whether the high scored content can be sent, and only then sends the content. For example, if there is electronic mail (email) content for a 3:00 pm targeting schedule for a day and there is a high scored content for a 4:00 pm targeting schedule, then the targeting data model does not trigger the targeting of the email content with the 3:00 pm targeting schedule, and instead triggers the targeting of the higher scored content for the 4:00 pm targeting schedule. In another example, if an offer can be sent to only 100 users, then the targeting data model reserves the dispatching of the offer before the actual dispatch occurs.

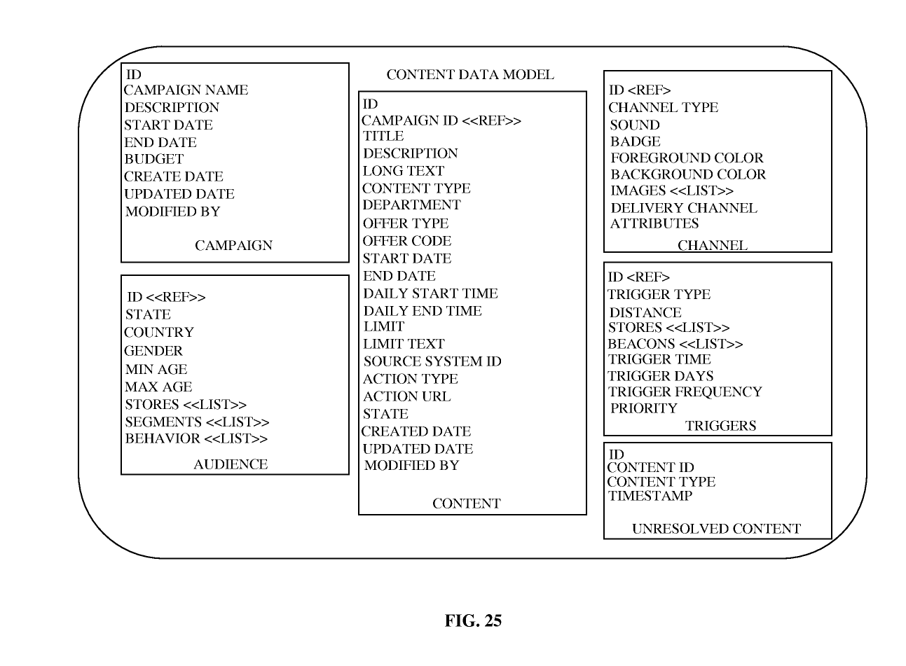

In an embodiment, the targeting engine 1415 receives content from the content data model, exemplarily illustrated in FIG. 25, as an ordered list of content. The targeting data model, exemplarily illustrated in FIG. 27, enables passes through various validation and settings in the targeting settings 1816 and visitor sent notification entities defined by the targeting data model for past dispatches. The targeting engine 1415 formats the content for channel limits and a form factor of a targeting channel, before dispatching the content. The targeting engine 1415 executes the pseudocode disclosed below for checking, for example, daily channel limits, time limits, content send limits, trigger channel opt in, control group enablement, store and distance validations, minimum time gaps between notifications, etc.:

```
ForEach user in userList
  globalConfig.validateDailyStartEndTime( ); exit;
  settings.validateMinTimeGapBetweenSends(user); exit;
  ForEach content in contentList
    content.isContentExpited( ); loop;
    isSendCountReached( ); exit;
    ifLocationChangeTrigger_ValidateStore( );loop;
    user.isChannelOptIn(content.channel) &&
controlGroup.isChannelEnabled_For(user, content.channel);
    validateDailyMaxPerchannelForUser(user); loop;
    content.validateRetireAfterCount(user); loop;
    ForTimebased:
      content.validateTimeTriggerEnabled( );
      content.validateTriggerTime( );loop;
      content.validateDaysAndFrequency( );loop;
      content.isReservedForFuture( ); loop;
    Location Based:
      content.validateLocationbeaconTriggerEnabled( );
      content.validateMin_distance( );
    Join:
      contenthasSendLimit( )->ReserveLimit( );loop;
      SendContentViaSelectedChannel( );
    End
  End
```

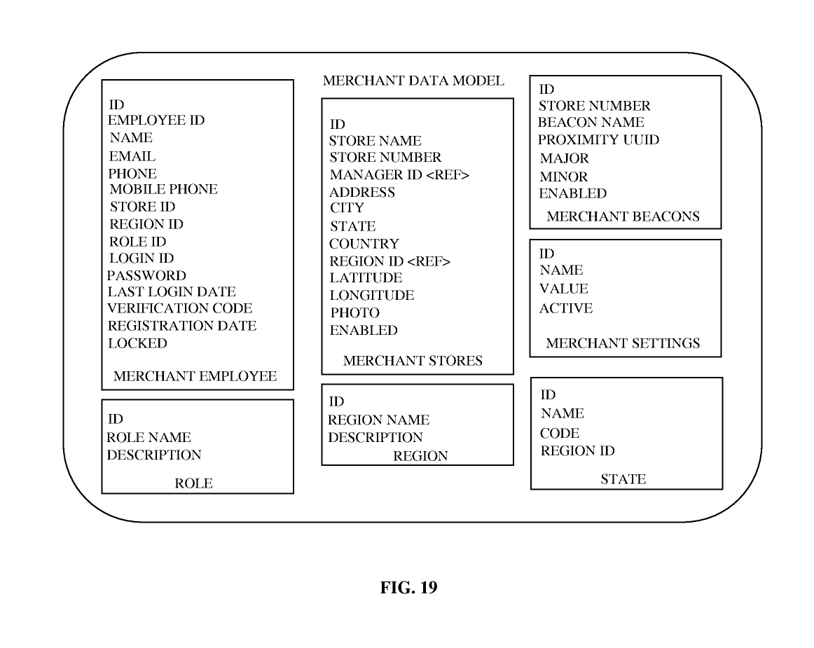

FIGS. 19-28 exemplarily illustrate logical representations of different data models used in the content determination and targeting system. In an embodiment, each logical data model disclosed in the detailed description of FIGS. 19-28, comprises one or more logical data entities. Physical structure and names of the data entities may vary depending on a data storage medium used by the content determination and targeting system and other considerations. For example, a single logical data entity may be saved as multiple tables if a relational database is used and the content determination and targeting system may execute a 3^{rd} form or a 4^{th} form of normalization. In an embodiment, for the purpose of query optimization of big data such as in the case of MySQL® clusters, many logical data entities may be stored together as a single physical table. As physical storage is a deployment specific decision, the data models disclosed in the detailed description of FIGS. 19-28 are explained in terms of logical data models and logical data entities.

FIG. 19 exemplarily illustrates a merchant data model. The merchant data model comprises data entities that are used for general management of merchant resources, in communication with, for example, an identity management data model, a point of sale (POS) data model, a POS intelligence data model, a content data model, a content relevancy data model, a targeting data model, and a digital intelligence data model. The data entities comprise, for example, employee data entities, role data entities, store data entities, region data entities, beacon and Wi-Fi® data entities, settings data entities, state data entities, etc. The employee data entities and the role data entities are used to define authentication and authorization to manage the merchant resources. The state data entities define information associated with states where merchants have stores or presence. The region data entities divide multiple states into groups for resource and cost management. The store data entities and beacon data entities can be enabled or disabled as needed to put them out of service. If a store data entity or a beacon data entity is disabled, then the content determination and targeting system cannot use the disabled store or the beacon data entity for generating relevant content for a target item. If the relevant content is already stored in the data repository 1611, then the disabled store data entity or the beacon data entity does not allow triggering of the stored relevant content based on store location or beacon proximity. The beacon data entity includes information of Wi-Fi® devices.

The region data entities, the state data entities, the beacon data entities, and the store data entities are used by the content determination and targeting system for targeting relevant content and services to one or more target users. For example, the beacon data entities and the store data entities are used to define targeting rules and identify proximity of users to merchant stores or to an aisle in a merchant store. The settings data entities comprise merchant specific configuration information. The settings data entities define configuration settings to update a merchant's security and other connectivity credentials. The table below exemplarily illustrates the settings data entities:

| Name | Value | Description |
|---|---|---|
| Merchant Name | urStore | Name of a merchant as the |
| | | name should show up |
| Logo Image | http://.... | URL or a path for a logo image |
| Email Content | /deployment/ustror/../ | An email template that is |
| Template | email.html | used to send offers or |
| | | advertisements via email |
| Email Pass | /deployment/ustore/../ | A passbook template |
| Template | pass.html | that is used to |
| | | send passes via email |
| From Email | contact@ustore.com | Sender address to be used |
| | | for the email |
| SMS Account ID | AM227acd5423f9ff8 | Account ID of a cloud service |
| | 2b02f09298a8c13e0d | provider |
| SMS | 1d5rt73df3728c1089 | Password or key to connect |
| Authentication | 29887407cc0c552 | to an SMS service |
| Token | | |
| SMS From | 4087734678 | A number of a sender |
| | | of an SMS |
| Apple Push | /deployment/ustore/a | APNS private key that |
| Notification | pns/abcd.p12 | can be a path to a file or |
| Service (APNS) | | content of the file |
| Private | | |
| Key | | |
| APNS Passphrase | Abcd | Passphrase for an APNS key |
| Google Cloud | . . . | API key for an Android |
| Messaging | | push API |
| (GCM) API Key | | |
| Amazon Web | AKIAIXWERXGJ3 | Amazon Access Key |
| Services | XZPGA | |
| (AWS) Access | | |
| Key | | |
| AWS passkey | Secret | A passkey for the access |
| | | key above |
| URL Shortener | http://tiny.cc/ustore/. | A URL shortener service |
| service | | for pass |

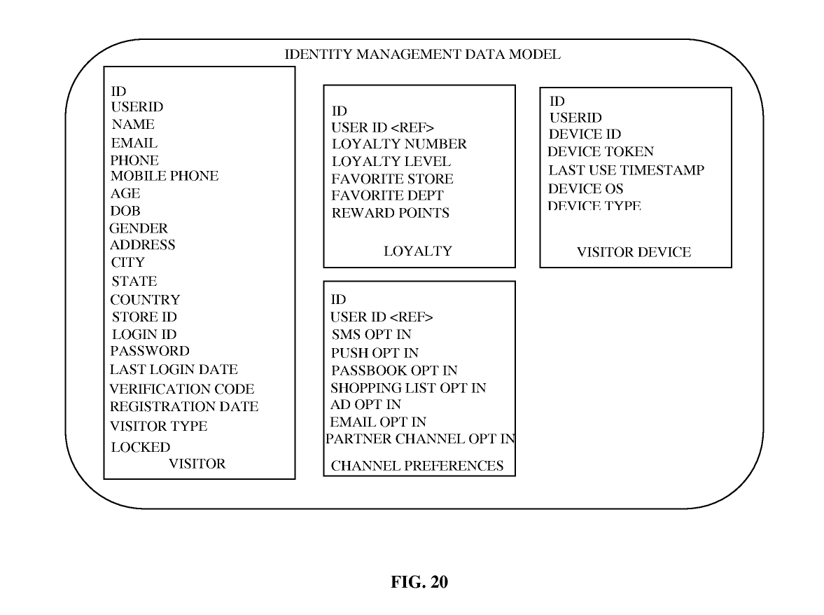

FIG. 20 exemplarily illustrates an identity management data model. In an embodiment, the identity management data model is common to any user based system. The identity management data model comprises information required to understand a merchant's customers. The identity management data model comprises information associated with a merchant's customers to help a merchant to personalize and target relevant content and services to target users on a per user basis. For example, the identity management data model comprises information associated with visitors, age groups, gender, demography, user devices, visitor devices, interaction channels, opt-in preferences, store preferences, department preferences, channel preferences, login information for application users, loyalty management information such as loyalty card information, reward points, etc.

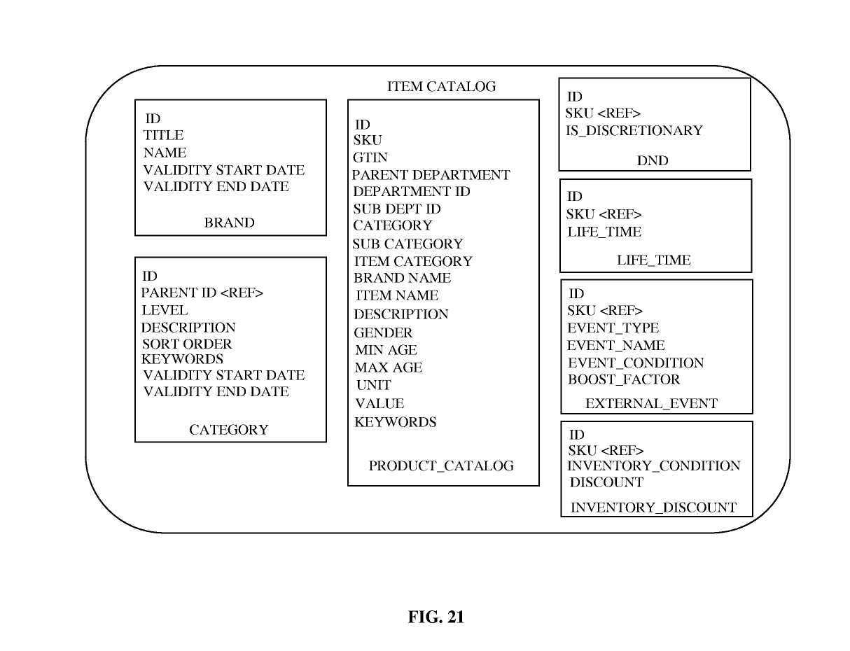

FIG. 21 exemplarily illustrates an item catalog. The item catalog defines items comprising, for example, products and/or services that a merchant sells, item characteristics such as item lifetime, discretionary customer habits, non-discretionary customer habits, and a relevancy and a discount factor which may be applied based on external events, conditions, and inventory levels. In an embodiment, the item catalog does not comprise inventory level information associated with items sold by a merchant. In an embodiment, the inventory level information is accessible via an inventory application programming interface (API) that provides real time or near real time updates about inventory status and inventory levels. In an embodiment, the item catalog is a static inventory that does not provide information regarding the inventory status or the inventory levels. In an embodiment, the content determination and targeting system 2902 dynamically changes discounts on an item based on inventory levels as specified in an inventory discount data entity exemplarily illustrated in FIG. 21. In an embodiment, the content determination and targeting system updates the item catalog less frequently. The item catalog comprises a category data entity and a brand data entity. The category data entity provides information regarding a category hierarchy and sort order within a level of the category hierarchy. Each item has a mapping to its parent category and also to an associated department. Each department is treated as a level 0 or a level 1 category. The brand data entity lists possible brands available in a merchant store. In an embodiment, the item catalog also comprises references to the brands available in the merchant store. In an embodiment, the content determination and targeting system 2902 dynamically alters the item relevancy score and the item relevancy priority based on occurrence of external events as specified in an external event data entity exemplarily illustrated in FIG. 21. The item catalog further comprises a lifetime data entity that defines lifetime information of an item, and a discretionary or non-discretionary (DND) data entity that defines whether a customer's habit is discretionary or non-discretionary as exemplarily illustrated in FIG. 21.

FIG. 22 exemplarily illustrates a point of sale (POS) data model. The POS data model is used to generate POS intelligence about user buying behavior. In an embodiment, the POS data model comprises two sets of tables. The tables are, for example, an item catalog as exemplarily illustrated in FIG. 21, and the POS data model exemplarily illustrated in FIG. 22. The item catalog describes items, their specifications, and their hierarchy in terms of departments and categories. The POS data model comprises tables that support users purchase histories that are used to derive user purchase interests and behaviors. The POS data model comprises four logical tables, for example, a purchase history or line time table, a purchase header, a purchase brand header, and a purchase category header.

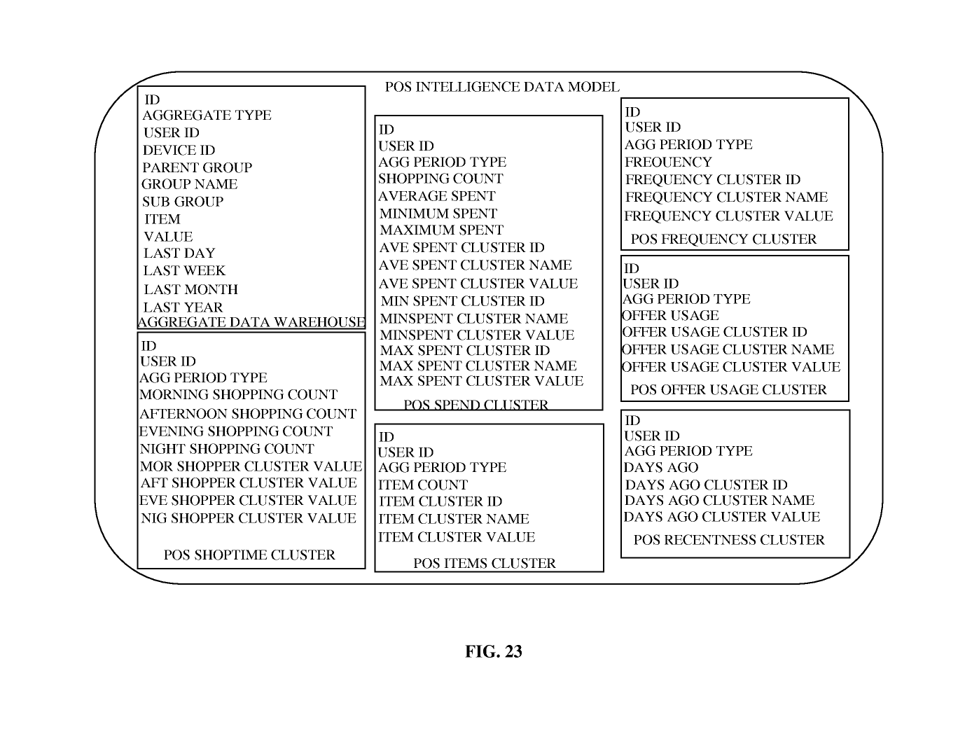

FIG. 23 exemplarily illustrates a point of sale (POS) intelligence data model. The POS data collected from the POS data model is used to identify and define user buying behavior. The POS intelligence data model categorizes users buying patterns, for example, in terms of items, item categories, brands per merchant store, shopping time, shopping days, shopping frequency, buying recentness, quantity of items, quality of purchases, spending patterns, spend limits, offer usage, interest in new items, etc. The POS intelligence data model uses the POS data from the POS data model to deduce other intelligence information, for example, age groups in a family, gender in the family, bulk purchases, etc. As used herein, “user behavior” and “user interest dimensions” are used interchangeably.

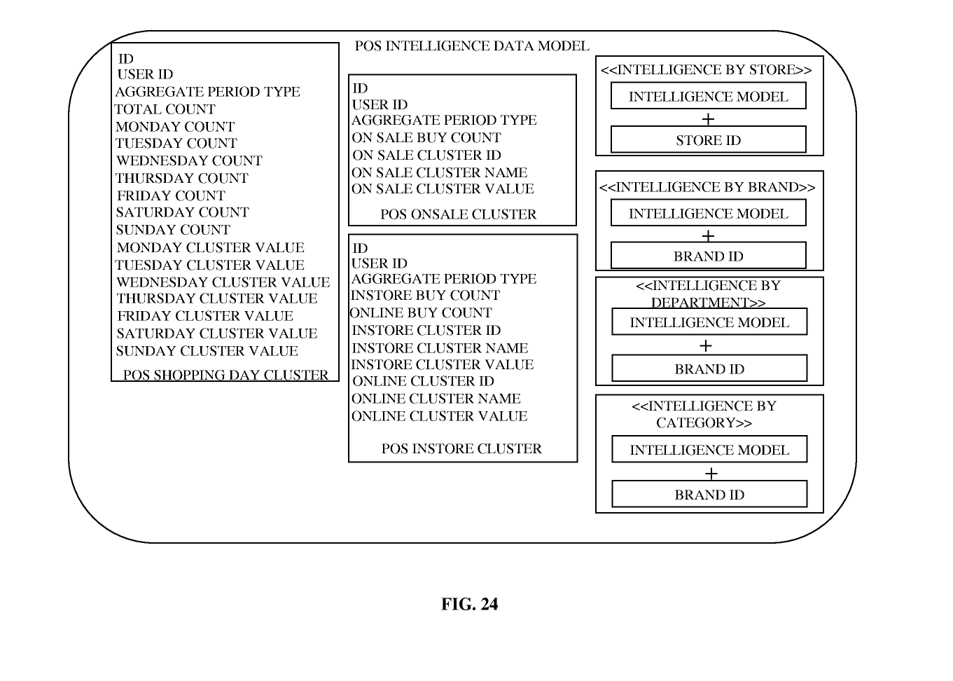

FIG. 24 exemplarily illustrates another point of sale (POS) intelligence data model. The POS intelligence data model comprises multiple logical data entities. In an embodiment, the logical data entities of the POS intelligence data model are stored as separate entities or tables or as a single entity. The POS intelligence data model comprises two main components. The components of the POS intelligence data model are, for example, non-clustered aggregations and clustered aggregations. The non-clustered aggregations are stored in an aggregate data warehouse (DW) table. In an embodiment, the non-clustered aggregations are calculated in a user mode and a group mode. The group mode ignores individual users and treats data as a single group. In the user mode, the calculation is performed at a user level. For example, a maximum order size can be based on an entire data set or can be calculated on a per user basis. The non-clustered aggregations are grouped by queries that may or may not be pushed down to allow, for example, calculation of one dimension of user behavior.

The clustered aggregations are performed on a per user basis but are segmented based on clustering logic. Each user interest dimension or user behavior is divided, for example, into three or more clusters comprising, for example, a high cluster, a medium cluster, and a low cluster. Common clusters are shown in the point of sale (POS) intelligence data model as logical data entities, for example, data entities for a POS shopping day cluster, a POS onsale cluster, and a POS in store cluster. In an embodiment, the POS intelligence data model forms a cluster on a per store basis, or a per brand basis, or a per category basis at multiple levels. The clusters allow a merchant to analyze, for example, “Who are my most spending customers?”, “Who are my most spending customers in store A?”, “Who are my most spending customers for Brand A?”, etc. The clustering allows pre-calculation to facilitate faster analysis of the user characteristic information, the item information, and the event information. For example, in the case of POS data, information associated with user behavior does not change quickly and hence can be pre-calculated to help near real time relevancy and targeting of relevant content and services to target users.

FIG. 25 exemplarily illustrates a content data model. The content data model comprises content that can be of many types, for example, offers, advertisements, services, etc. The content data model comprises data entities such as a campaign data entity, an audience data entity, a content data entity, a channel data entity, a targeting trigger data entity, and an unresolved content data entity. Whenever the content determination and targeting system generates content, the content data model classifies the generated content in terms of a product or a service category. For example, an offer for a milk product such as “10% off on Milk” is classified under a dairy category and a milk sub-category. The content data model links the classified milk product to other products which are related to “milk”. In an embodiment, the content determination and targeting system stores unresolved content in the unresolved content data entity of the content data model.

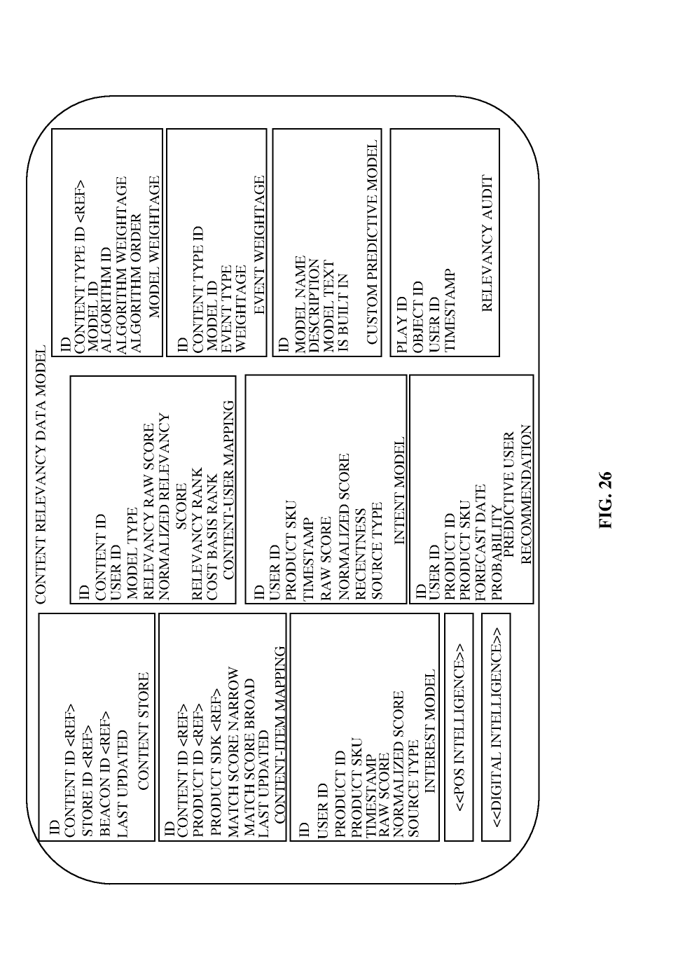

FIG. 26 exemplarily illustrates a content relevancy data model. The content relevancy data model generates personalized relevant content and services on a per user basis. The content relevancy data model receives inputs, for example, from the point of sale (POS) intelligence data model, a digital intelligence data model, a predictive weightage data model, an event weightage, a content to item relationship data model, a content definition data model, etc. The content relevancy data model uses the received inputs to generate, for example, a content store data entity, a content to item mapping data entity, an interest data entity, an intent data entity, a content to user mapping data entity, a predictive user recommendation data entity, a model weightage data entity, an event weightage data entity, a custom predictive data entity, and a relevancy audit data entity. The interest data entity comprises, for example, information associated with user behavior older than 1 week. The intent data entity comprises, for example, information associated with user behavior not older than 1 week. Each of the data entities of the content relevancy data model generate an item relevancy score and an item relevancy priority for an item which gets translated to a content relevancy score via an item to content mapping algorithm.

FIG. 27 exemplarily illustrates a targeting data model. The targeting data model maintains configuration information of control groups, records user activities, user-content associations, and user targeting logs. The table below exemplarily illustrates targeting settings defined in the targeting data model:

| Name | Value | | Description |
|---|---|---|---|
| Targeting start time | 9:00 | am | Do not sent any notifications |
| | | | before this time |
| Targeting end time | 7:00 | pm | Do not send any notification |
| | | | after this time |
| Daily maximum | 1 | | A maximum number of emails |
| emails | | | per user to be sent daily |
| Daily maximum | 1 | | A maximum number of advertisements |
| advertisements | | | per user to be sent daily |
| Daily maximum | 1 | | A maximum number of push |
| push notifications | | | notifications per user to be sent daily |
| Daily maximum | 1 | | A maximum number of passes |
| passes | | | per user to be sent daily |
| Daily maximum | 1 | | A maximum number of SMS messages |
| SMS messages | | | per user to be sent daily |
| Minimum time gap | 1 | hour | A wait time before sending another |
| | | | notification |
| Retire after send | 3 | | Do not send the same content after |
| count | | | sending these many times |
| Retire after open | 3 | | Do not send the same content once |
| count | | | a user opens the content. |

| | | |
|---|---|---|
| Time zone | PST | Use the time setting with respect |
| | | to this time zone |
| Active Control | −1 | Use this control group |
| Group | | configuration for targeting |

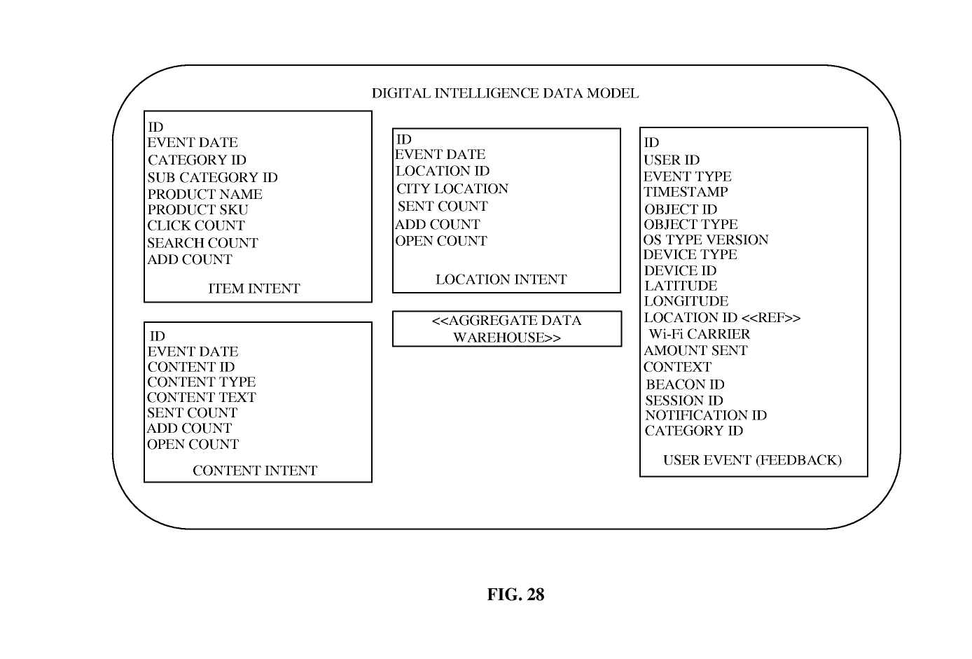

FIG. 28 exemplarily illustrates a digital intelligence data model. The digital intelligence data model is a feedback intelligence data model that is generated by user intelligence collected via interacting with merchant applications or performing user activities, for example, opening, clicking, etc., offers, advertisements, services, etc., sent via targeting channels. The digital intelligence data model comprises multiple data entities comprising, for example, item intent, content intent, location intent, user event, etc.

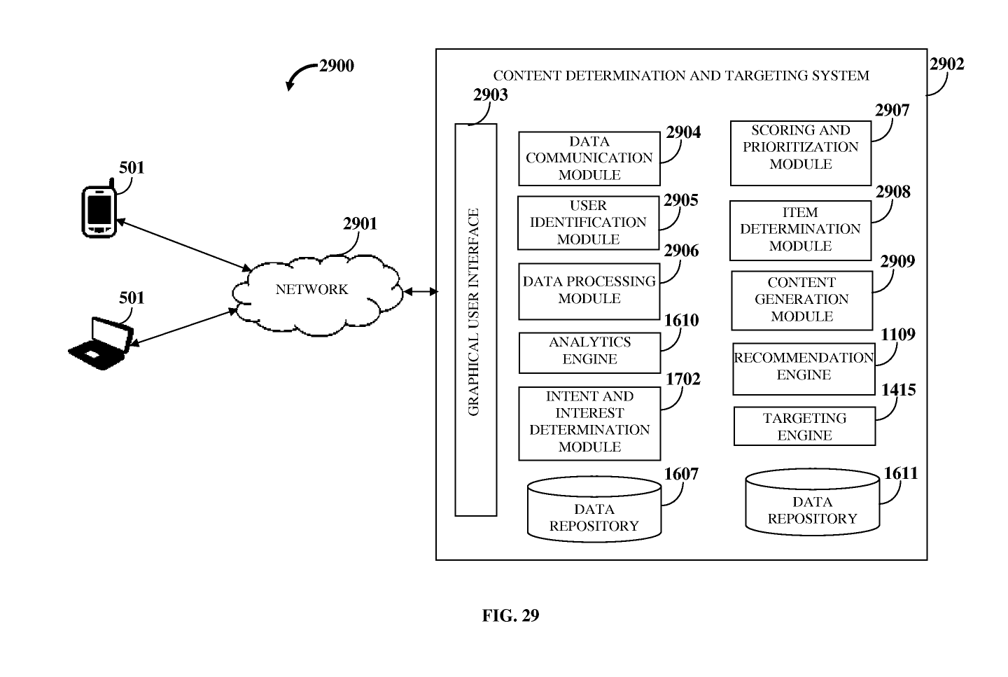

FIG. 29 exemplarily illustrates a computer implemented system 2900 for dynamically targeting time, event and inventory based, location-specific, and behavior relevant content and services to users in an omnichannel environment. The computer implemented system 2900 disclosed herein comprises the content determination and targeting system 2902 communicating with user devices 501 via a network 2901. The user devices 501 are electronic devices, for example, personal computers, tablet computing devices, mobile computers, mobile phones, smart phones, portable computing devices, laptops, personal digital assistants, touch centric devices, wearable devices such as Google Glass of Google Inc., workstations, client devices, portable electronic devices, network enabled computing devices, interactive network enabled communication devices, televisions, image capture devices, gaming devices, any other suitable computing equipment, combinations of multiple pieces of computing equipment, etc. The electronic device may also be a hybrid electronic device that combines the functionality of multiple devices. Examples of a hybrid electronic device comprise a cellular telephone that includes a media player functionality, a gaming device that includes a wireless communications capability, a cellular telephone that includes gaming and electronic mail (email) functions, and a portable device that receives email, supports mobile telephone calls, has music player functionality, and supports web browsing. Computing equipment may be used to implement applications such as media playback applications, for example, iTunes® from Apple Inc., a web browser, a mapping application, an email application, a calendar application, etc. Computing equipment, for example, one or more servers may be associated with one or more online services.

The network 2901 is, for example, the internet, an intranet, a wireless network, a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, etc., a local area network, a wide area network, an internet connection network, an infrared communication network, etc., or a network formed from any combination of these networks.

The content determination and targeting system 2902 is accessible to users, for example, through a broad spectrum of technologies and devices such as personal computers with access to the internet, internet enabled cellular phones, tablet computing devices, etc. In an embodiment, the content determination and targeting system 2902 is configured as a web based platform, for example, a website hosted on a server or a network of servers. In another embodiment, the content determination and targeting system 2902 is configured to operate as a software as a service (SaaS). In another embodiment, the content determination and targeting system 2902 is configured to operate, for example, as a platform as a service (PaaS) implemented in a cloud computing environment. The content determination and targeting system 2902 is a cloud computing based platform implemented as a service for dynamically targeting time, event and inventory based, location-specific, and behavior relevant content and services to users in an omnichannel environment. The content determination and targeting system 2902 is developed, for example, using the Google App engine cloud infrastructure of Google Inc., Amazon Web Services® of Amazon Technologies, Inc., the Amazon elastic compute cloud EC2® web service of Amazon Technologies, Inc., the Google® Cloud platform of Google Inc., the Microsoft® Cloud platform of Microsoft Corporation, etc.

The content determination and targeting system 2902 disclosed herein comprises a non-transitory computer readable storage medium and at least one processor communicatively coupled to the non-transitory computer readable storage medium. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium is configured to store computer program instructions defined by modules, for example, 2904, 2905, 2906, 2907, 2908, 2909, 1610, 1702, 1109, 1415, etc., of the content determination and targeting system 2902. The processor is configured to execute the defined computer program instructions.

The content determination and targeting system 2902 further comprises a graphical user interface (GUI) 2903, a data communication module 2904, a user identification module 2905, a data processing module 2906, an analytics engine 1610, an intent and interest determination module 1702, a scoring and prioritization module 2907, an item determination module 2908, a content generation module 2909, a recommendation engine 1109, a targeting engine 1415, and one or more data repositories 1607 and 1611. Users, for example, merchants, customers, etc., access the content determination and targeting system 2902 via the GUI 2903. The GUI 2903 is, for example, a webpage of a website hosted by the content determination and targeting system 2902, an online web interface, a web based downloadable application interface, a mobile based downloadable application interface, etc. The data communication module 2904 dynamically receives user characteristic information, item information of multiple items engaged by the users, and event information from multiple information sources in the omnichannel environment. In an embodiment, the data processing module 2906 cleanses the dynamically received user characteristic information, the item information, and the event information by identifying and correcting discrepancies in the dynamically received user characteristic information, the item information, and the event information.

The user identification module 2905 identifies one or more target users for dynamically targeting the time, event and inventory based, location-specific, and behavior relevant content and services using the dynamically received user characteristic information, the item information, and the event information. In an embodiment, the data processing module 2906 extracts data elements from the dynamically received user characteristic information, the item information, and the event information, and assigns a weight to each extracted data element based on one or more content selection parameters.

The analytics engine 1610 analyzes the dynamically received user characteristic information, the item information, and the event information using one or more of multiple analytical parameters. The intent and interest determination module 1702 determines user intent dimensions, user interest dimensions, and global interest dimensions based on the analysis of the dynamically received user characteristic information, the item information, and the event information. In an embodiment, the user identification module 2905 categorizes the users based on the analyzed user characteristic information, the analyzed item information, the analyzed event information, user feedback associated with the items received by the data communication module 2904, the determined user intent dimensions, the determined user interest dimensions, and the determined global interest dimensions for the identification of the target users for the dynamic targeting of the time, event and inventory based, location-specific, and behavior relevant content and services.

The scoring and prioritization module 2907 generates an item relevancy score and an item relevancy priority for each of the items based on the analysis of the dynamically received user characteristic information, the item information, the event information, the determined user intent dimensions, the determined user interest dimensions, and the determined global interest dimensions. In an embodiment, the scoring and prioritization module 2907 normalizes the generated item relevancy score and the generated item relevancy priority for each item for facilitating the generation of the recommendations for dynamically targeting the relevant content associated with a target item and services to the identified target users. In an embodiment, the scoring and prioritization module 2907 is incorporated in the analytics engine 1610 for generating the item relevancy score and the item relevancy priority. The item determination module 2908 determines a target item for dynamically targeting the time, event and inventory based, location-specific, and behavior relevant content and services to the identified target users based on the generated item relevancy score and the generated item relevancy priority of each item. The content generation module 2909 generates and associates relevant content with the determined target item and determines service information of multiple services to be provided to the identified target users, in communication with one or more of multiple content sources. The scoring and prioritization module 2907 generates a content relevancy score and a content relevancy priority for the generated relevant content associated with the determined target item based on the analysis of the dynamically received user characteristic information, the item information, the event information, the determined user intent dimensions, the determined user interest dimensions, and the determined global interest dimensions.

The recommendation engine 1109 dynamically generates recommendations for dynamically targeting the generated relevant content associated with the determined target item and the determined service information of the services to the identified target users based on the generated content relevancy score, the generated content relevancy priority, one or more of multiple targeting triggers, and the analysis of the dynamically received user characteristic information, the item information, and the event information using one or more of multiple content selection parameters. The targeting engine 1415 dynamically targets the generated relevant content associated with the determined target item and the determined service information of the services to the identified target users in the omnichannel environment based on the dynamically generated recommendations. In an embodiment, the data communication module 2904 transmits notifications to the identified target users in the omnichannel environment for indicating the targeting of the generated relevant content. In an embodiment, the analytics engine 1610 dynamically analyzes inventory information associated with the items stored in one or more inventory management systems 1609 exemplarily illustrated in FIG. 16. In this embodiment, the content generation module 2909 regenerates the relevant content associated with the determined target item based on the dynamic analysis of the inventory information. Furthermore, the scoring and prioritization module 2907 updates the generated content relevancy score and the generated content relevancy priority for the regenerated relevant content associated with the determined target item for the dynamic generation of the recommendations for the dynamic targeting of the regenerated relevant content associated with the determined target item to the identified target users.

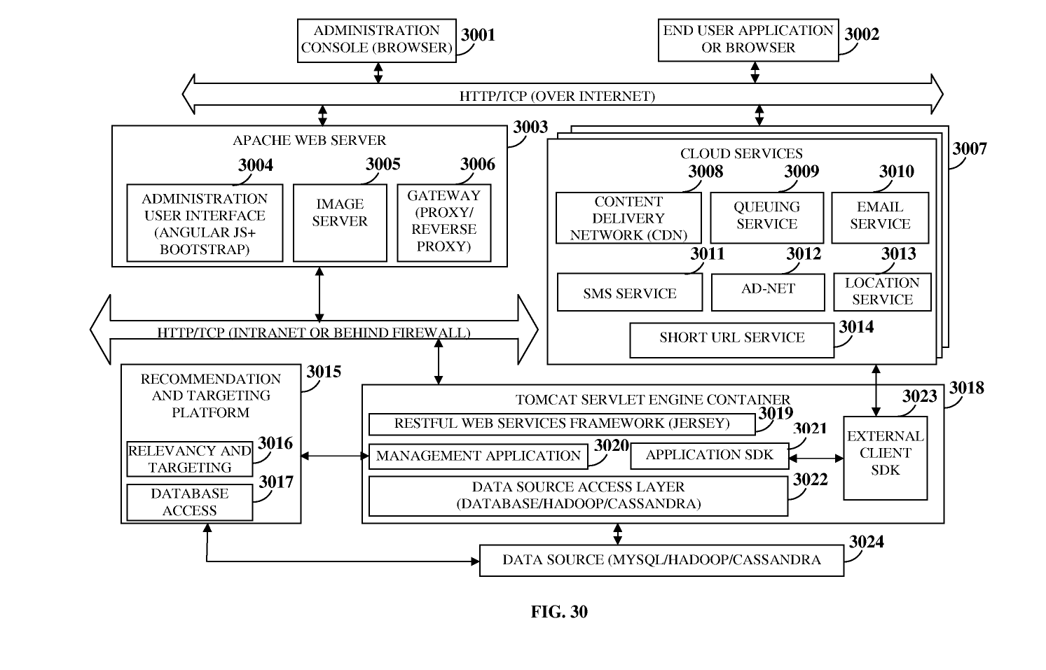

FIG. 30 exemplarily illustrates an implementation of the hardware architecture of the content determination and targeting system 2902 exemplarily illustrated in FIG. 29, employed for dynamically targeting time, event and inventory based, location-specific, and behavior relevant content and services to users in an omnichannel environment. As exemplarily illustrated in FIG. 30, the hardware architecture of the content determination and targeting system 2902 comprises an administration console 3001, an end user application or browser 3002, an Apache web server 3003, a cloud services platform 3007, a recommendation and targeting platform 3015, an Apache Tomcat™ servlet engine container 3018 or any J2EE Servlet container, and a data source 3024.

The administration console 3001 is configured as a management studio that allows merchants to create content. In an embodiment, the administration console 3001 is configured for targeting settings and external interfaces. The administration console 3001, for example, is used for generating content, for example, offers, services, advertisements, etc.; select a content channel; determining targeting settings comprising, for example, a start date, an end date, send limits, target audiences, etc.; determining global targeting settings such as how frequently a user can be targeted via a particular channel, a sum total of all channels, a targeting window and retire criteria based on a number of times a content is targeted to a given end user; determining external interface settings such as connection parameters, tokens, a secure sockets layer (SSL) configuration, file transfer protocol (FTP) settings to an external system, etc.; storing configuration settings such as adding and managing merchant stores, geo locations of the merchant stores and competitor stores, etc.; storing beacon and Wi-Fi® configuration settings such as adding and managing beacons and Wi-Fi® devices in merchant stores; configuring algorithms for dynamically targeting time, event and inventory based, location-specific, and behavior relevant content and services to users in an omnichannel environment; configuring campaign objectives, dynamic weightage criteria, etc. In an embodiment, the administration console 3001 provides various analytics to measure effectiveness of various campaigns, targeting reach limits, data conversion, and other parameters. The administration console 3001 communicates with the Apache web server 3003 via a hypertext transfer protocol (HTTP) or a transmission control protocol (TCP) over the internet.

The end user application 3002 is a merchant's end user application configured, for example, as applications for the iPhone® of Apple Inc., the iPad® of Apple Inc., Android devices, desktop applications such as browsers, etc. The end user application 3002 of merchants integrates with an application software development kit (SDK) to provide multiple functionalities comprising, for example, capturing of user interactions such as information associated with which item a user is viewing, clicking, adding as a favorite, buying, etc., and transmitting the captured user interactions as feedback events to the recommendation and targeting platform 3015 for further analysis; capturing change of location and providing location based notifications based on proximity to a merchant's store or a competitor's store, and dispatching location based events to the recommendation and targeting platform 3015 via a platform SDK, where the recommendation and targeting platform 3015 uses information associated with time, place, inventory level, discretionary or non-discretionary spending habits, item lifetime, dynamic pricing and other algorithms to determine relevant content and an optimal channel to engage target users in real time; capturing beacon proximity to determine relevant content based on one or more of dynamic selected and configured targeting algorithms; displaying notifications and relevant content such as advertisements to target users, etc. The end user application 3002 communicates with the cloud services platform 3007 via a hypertext transfer protocol (HTTP) or a transmission control protocol (TCP) over the internet.

The cloud services platform 3007 comprises a content delivery network 3008 and provides services comprising, for example, a queuing service 3009, an electronic mail (email) service 3010, a short message service (SMS) 3011, an advertising network (ad-net) 3012, a location service 3013, a short uniform resource locator (URL) service 3014, etc. The Apache web server 3003 comprises an administration user interface 3004, an image server 3005 for managing and storing images, and a gateway 3006. In an embodiment, the Apache web server 3003 can be any web server with similar compatible functionalities. The Apache web server 3003 is used to serve static content comprising, for example, hypertext markup language 5 (HTML5) and JavaScript® based user interface that is built, for example, using a JavaScript® framework such as AngularJS, cascading style sheets (CSS), HTML, JavaScript® preprocessing utilities such as less, grunt, node.js, etc. The Apache web server 3003 is used to serve, for example, static web pages, images, CSS files, JavaScript® files, etc. The gateway 3006 of the Apache web server 3003 is used as a proxy or a reverse proxy gateway 3006. In an embodiment, the Apache web server 3003 receives Rest requests from various user interfaces and forwards the received Rest requests to a Restful web services framework 3019 of the Tomcat servlet engine container 3018 via a hypertext transfer protocol (HTTP) or a transmission control protocol (TCP) using an intranet or behind a firewall.

The Tomcat servlet engine container 3018 or any compatible J2EE servlet container hosts, for example, Jersey as the Restful web services framework 3019 and provides an execution container for all business logic for managing end user activities. The Restful web services framework 3019 receives forward requests from the Apache web server 3003, the administration console 3001 and the end user application or browser 3002. The business logic implemented in the Tomcat servlet engine container 3018 serves user requests which are typically lightweight. The Tomcat servlet engine container 3018, for example, is configured to provide user interface (UI) content for displaying relevant content to target users. The Tomcat servlet engine container 3018 comprises an application software development kit (SDK) 3021 configured to receive SDK events, save the received SDK events, add the received SDK events to a message queue, etc. In an embodiment, the Tomcat servlet engine container 3018 further comprises an external client SDK 3023 that communicates with the cloud services platform 3007. The SDK events added to the message queue are picked by one of the multiple platform engines running on multiple nodes. The business logic executed in the Tomcat servlet engine container 3018 connects to various external interfaces via their corresponding SDKs comprising, for example, a message queue SDK such as the Apache message queue manager (MQM) or the Amazon simple queue service (SQS), electronic mail (email) services such as Amazon simple email service (SES), a short message service (SMS) such as Twilio® of Twilio, Inc., a multimedia messaging service (MMS), a short uniform resource locator (URL) service such as Google short URL service, tiny.cc, etc., a geo-location service such as the Google geo location service, a content delivery service such as Amazon cloud front, multiple advertising network (ad-net) services, etc. In an embodiment, the business logic of the Tomcat servlet engine container 3018 connects to persistent storage media via a corresponding SDK. The persistent connectivity is abstracted out to support any kind of data source such as a relational database using a Java persistence application programming interface (API) (JPA), native Java database connectivity (JDBC), a big data stack such as Hadoop®, Cassandra, and Apache Spark via their native drivers.

The recommendation and targeting platform 3015 comprises a relevancy and targeting module 3016 and a database access module 3017. The recommendation and targeting platform 3015 communicates with a management application 3020 of the Tomcat servlet engine container 3018. The recommendation and targeting platform 3015 comprises multiple Java processes running on one or many nodes and is optimized for various data sources 3024, for example, MySQL®, Hadoop®, Cassandra, etc. For example, for a small to medium deployment, Hadoop® and MySQL® or other relational databases are used for data storage and the recommendation and targeting platform 3015 comprises native implementations for relational databases and pushdowns to perform tasks in real time, thereby providing a low cost deployment strategy. For medium to large deployment, where relational databases are not an optimal choice, a data source access layer 3022 comprising, for example, Hadoop®, Cassandra, Apache Spark, etc., is used. In an embodiment, the recommendation and targeting platform 3015 comprises a location resolver (not shown), the item resolver 1103 exemplarily illustrated in FIG. 11, the analytics engine 1610 for dashboards, the recommendation engine 1109, and the targeting engine 1415 as exemplarily illustrated in FIG. 29.

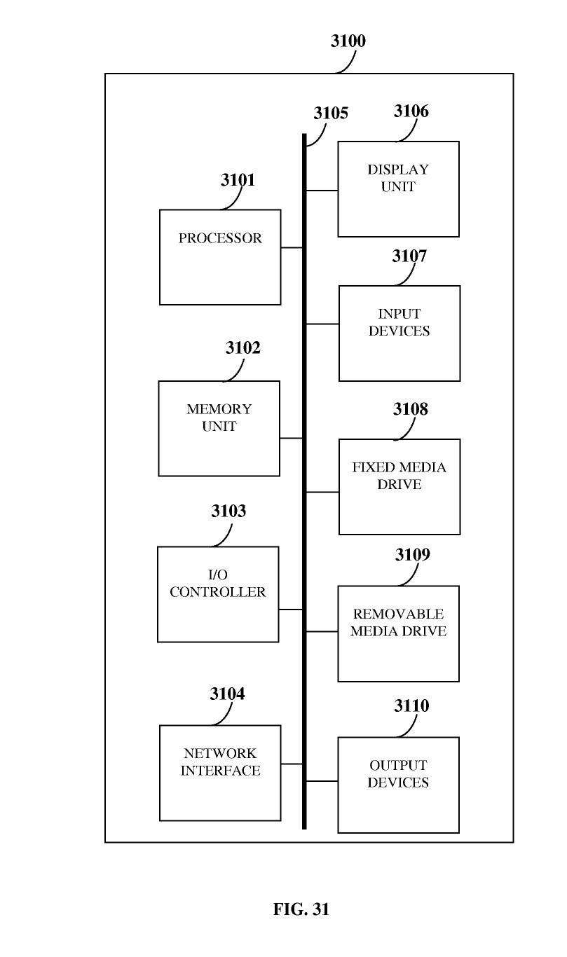

FIG. 31 exemplarily illustrates the hardware architecture 3100 of the content determination and targeting system 2902 exemplarily illustrated in FIG. 29, employed for dynamically targeting time, event and inventory based, location-specific, and behavior relevant content and services to users in an omnichannel environment. The content determination and targeting system 2902 is a computer system that is programmable using a high level computer programming language. The content determination and targeting system 2902 may be implemented using programmed and purposeful hardware. The content determination and targeting system 2902 communicates with user devices 501 exemplarily illustrated in FIG. 29, of each of the users, for example, customers, retailers, merchants, etc., registered with the content determination and targeting system 2902 via a network 2901 exemplarily illustrated in FIG. 29, for example, a short range network or a long range network.

As exemplarily illustrated in FIG. 31, the hardware architecture 3100 of the content determination and targeting system 2902 comprises a processor 3101, a non-transitory computer readable storage medium such as a memory unit 3102 for storing programs and data, an input/output (I/O) controller 3103, a network interface 3104, a data bus 3105, a display unit 3106, input devices 3107, a fixed media drive 3108 such as a hard drive, a removable media drive 3109 for receiving removable media, output devices 3110, etc. The processor 3101 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 3101 may also be implemented as a processor set comprising, for example, a general purpose microprocessor and a math or graphics co-processor. The processor 3101 is selected, for example, from the Intel® processors such as the Itanium® microprocessor or the Pentium® processors, Advanced Micro Devices)(AMD® processors such as the Athlon® processor, UltraSPARC® processors, microSPARC® processors, HP® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The content determination and targeting system 2902 disclosed herein is not limited to employing a processor 3101. The content determination and targeting system 2902 may also employ a controller or a microcontroller. The processor 3101 executes the modules, for example, 2904, 2905, 2906, 2907, 2908, 2909, 1610, 1702, 1109, 1415, etc., of the content determination and targeting system 2902.

The memory unit 3102 is used for storing programs, applications, and data. For example, the data communication module 2904, the user identification module 2905, the data processing module 2906, the analytics engine 1610, the intent and interest determination module 1702, the scoring and prioritization module 2907, the item determination module 2908, the content generation module 2909, the recommendation engine 1109, the targeting engine 1415, etc., exemplarily illustrated in FIG. 29, are stored in the memory unit 3102 of the content determination and targeting system 2902. The memory unit 3102 is, for example, a random access memory (RAM) or another type of dynamic storage device that stores information and instructions for execution by the processor 3101. The memory unit 3102 also stores temporary variables and other intermediate information used during execution of the instructions by the processor 3101. The content determination and targeting system 2902 further comprises a read only memory (ROM) or another type of static storage device that stores static information and instructions for the processor 3101. The I/O controller 3103 controls input actions and output actions performed by the content determination and targeting system 2902.

The network interface 3104 enables connection of the content determination and targeting system 2902 to the network 2901. In an embodiment, the network interface 3104 is provided as an interface card also referred to as a line card. The network interface 3104 comprises, for example, one or more of an infrared (IR) interface, an interface implementing Wi-Fi®, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 3105 permits communications between the modules, for example, 2903, 2904, 2905, 2906, 2907, 2908, 2909, 1607, 1610, 1611, 1702, 1109, 1415, etc., of the content determination and targeting system 2902.

The display unit 3106, via the graphical user interface (GUI) 2903 exemplarily illustrated in FIG. 29, displays information, display interfaces, user interface elements such as text fields, checkboxes, text boxes, windows, etc., for allowing merchants, retailers, etc., to enter information associated with content for items such as offers on items sold by merchants, retailers, etc., to enter point of sale data associated with their stores, etc. The display unit 3106 comprises, for example, a liquid crystal display, a plasma display, an organic light emitting diode (OLED) based display, etc. The input devices 3107 are used for inputting data into the content determination and targeting system 2902. Administrators of the content determination and targeting system 2902 use the input devices 3107 to provide inputs to the content determination and targeting system 2902. For example, an administrator may enter content information and weightages assigned to items, etc., using the input devices 3107. The input devices 3107 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the content determination and targeting system 2902. The programs are loaded onto the fixed media drive 3108 and into the memory unit 3102 of the content determination and targeting system 2902 via the removable media drive 3109. In an embodiment, the computer applications and programs may be loaded directly via the network 2901. Computer applications and programs are executed by double clicking a related icon displayed on the display unit 3106 using one of the input devices 3107. The output devices 3110 output the results of operations performed by the content determination and targeting system 2902. For example, the content determination and targeting system 2902 provides customized reports to users using the output devices 3110. The content determination and targeting system 2902 displays the generated reports using the output devices 3110.

The processor 3101 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of BlackBerry Limited, the iOS operating system of Apple Inc., the Symbian™ operating system of Symbian Foundation Limited, etc. The content determination and targeting system 2902 employs the operating system for performing multiple tasks. The operating system is responsible for management and coordination of activities and sharing of resources of the content determination and targeting system 2902. The operating system further manages security of the content determination and targeting system 2902, peripheral devices connected to the content determination and targeting system 2902, and network connections. The operating system employed on the content determination and targeting system 2902 recognizes, for example, inputs provided by the users using one of the input devices 3107, the output display, files, and directories stored locally on the fixed media drive 3108. The operating system on the content determination and targeting system 2902 executes different programs using the processor 3101. The processor 3101 and the operating system together define a computer system for which application programs in high level programming languages are written.

The processor 3101 of the content determination and targeting system 2902 retrieves instructions defined by the data communication module 2904, the user identification module 2905, the data processing module 2906, the analytics engine 1610, the intent and interest determination module 1702, the scoring and prioritization module 2907, the item determination module 2908, the content generation module 2909, the recommendation engine 1109, the targeting engine 1415, etc., for performing respective functions disclosed in the detailed description of FIG. 29. The processor 3101 retrieves instructions for executing the modules, for example, 2904, 2905, 2906, 2907, 2908, 2909, 1610, 1702, 1109, 1415, etc., of the content determination and targeting system 2902 from the memory unit 3102. A program counter determines the location of the instructions in the memory unit 3102. The program counter stores a number that identifies the current position in the program of each of the modules, for example, 2904, 2905, 2906, 2907, 2908, 2909, 1610, 1702, 1109, 1415, etc., of the content determination and targeting system 2902. The instructions fetched by the processor 3101 from the memory unit 3102 after being processed are decoded. The instructions are stored in an instruction register in the processor 3101. After processing and decoding, the processor 3101 executes the instructions, thereby performing one or more processes defined by those instructions.

At the time of execution, the instructions stored in the instruction register are examined to determine the operations to be performed. The processor 3101 then performs the specified operations. The operations comprise arithmetic operations and logic operations. The operating system performs multiple routines for performing a number of tasks required to assign the input devices 3107, the output devices 3110, and memory for execution of the modules, for example, 2904, 2905, 2906, 2907, 2908, 2909, 1610, 1702, 1109, 1415, etc., of the content determination and targeting system 2902. The tasks performed by the operating system comprise, for example, assigning memory to the modules, for example, 2904, 2905, 2906, 2907, 2908, 2909, 1610, 1702, 1109, 1415, etc., of the content determination and targeting system 2902, and to data used by the content determination and targeting system 2902, moving data between the memory unit 3102 and disk units, and handling input/output operations. The operating system performs the tasks on request by the operations and after performing the tasks, the operating system transfers the execution control back to the processor 3101. The processor 3101 continues the execution to obtain one or more outputs. The outputs of the execution of the modules, for example, 2904, 2905, 2906, 2907, 2908, 2909, 1610, 1702, 1109, 1415, etc., of the content determination and targeting system 2902 are displayed to the user on the display unit 3106.

For purposes of illustration, the detailed description refers to the content determination and targeting system 2902 being run locally as a single computer system; however the scope of the computer implemented method and the content determination and targeting system 2902 disclosed herein is not limited to the content determination and targeting system 2902 being run locally as a single computer system via the operating system and the processor 3101, but may be extended to run remotely over the network 2901 by employing a web browser and a remote server, a mobile phone, or other electronic devices. One or more portions of the content determination and targeting system 2902 may be distributed across one or more computer systems (not shown) coupled to the network 2901.

Disclosed herein is also a computer program product comprising a non-transitory computer readable storage medium that stores computer program codes comprising instructions executable by at least one processor 3101 for dynamically targeting time, event and inventory based, location-specific, and behavior relevant content and services to users in an omnichannel environment. The computer program product disclosed herein comprises a first computer program code for dynamically receiving user characteristic information, item information of multiple items engaged by users, and event information from multiple information sources in an omnichannel environment; a second computer program code for identifying one or more target users from the users for dynamically targeting time, event and inventory based, location-specific, and behavior relevant content and services using the dynamically received user characteristic information, the item information, and the event information; a third computer program code for analyzing the dynamically received user characteristic information, the item information, and the event information using one or more of multiple analytical parameters; a fourth computer program code for determining user intent dimensions, user interest dimensions and global interest dimensions based on the analysis of the dynamically received user characteristic information, the item information, and the event information; a fifth computer program code for generating an item relevancy score and an item relevancy priority for each of the items based on the analysis of the dynamically received user characteristic information, the item information, the event information, the determined user intent dimensions, the determined user interest dimensions, and the determined global interest dimensions.

The computer program product disclosed herein further comprises a sixth computer program code for determining a target item from the items for dynamically targeting the time, event and inventory based, location-specific, and behavior relevant content and services to the identified target users based on the generated item relevancy score and the generated item relevancy priority of each item; a seventh computer program code for generating and associating relevant content with the determined target item and determining service information of multiple services to be provided to the identified target users, in communication with one or more of multiple content sources; an eighth computer program code for generating a content relevancy score and a content relevancy priority for the generated relevant content associated with the determined target item based on the analysis of the dynamically received user characteristic information, the item information, the event information, the determined user intent dimensions, the determined user interest dimensions, and the determined global interest dimensions; a ninth computer program code for dynamically generating recommendations for dynamically targeting the generated relevant content associated with the determined target item and the determined service information of the services to the identified target users based on the generated content relevancy score, the generated content relevancy priority, one or more of multiple targeting triggers, and the analysis of the dynamically received user characteristic information, the item information, and the event information using one or more of multiple content selection parameters; and a tenth computer program code for dynamically targeting the generated relevant content associated with the determined target item and the determined service information of the services to the identified target users in the omnichannel environment based on the dynamically generated recommendations.

The computer program product disclosed herein further comprises one or more additional computer program codes for performing additional steps that may be required and contemplated for dynamically targeting time, event and inventory based, location-specific, and behavior relevant content and services to users in an omnichannel environment. In an embodiment, a single piece of computer program code comprising computer executable instructions performs one or more steps of the computer implemented method disclosed herein for dynamically targeting time, event and inventory based, location-specific, and behavior relevant content and services to users in an omnichannel environment. The computer program codes comprising computer executable instructions are embodied on the non-transitory computer readable storage medium. The processor 3101 of the content determination and targeting system 2902 retrieves these computer executable instructions and executes them. When the computer executable instructions are executed by the processor 3101, the computer executable instructions cause the processor 3101 to perform the steps of the computer implemented method for dynamically targeting time, event and inventory based, location-specific, and behavior relevant content and services to users in an omnichannel environment.

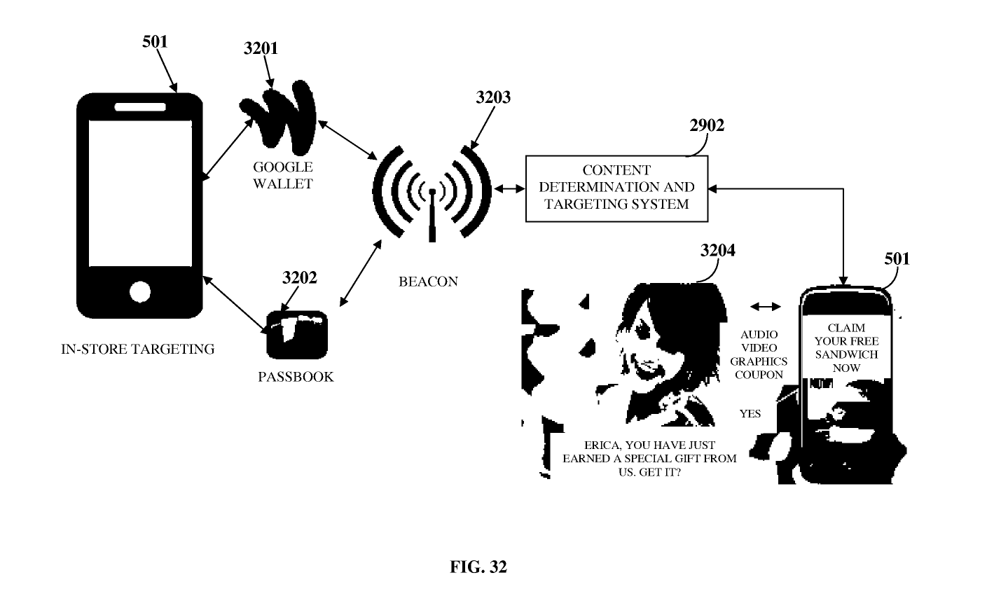

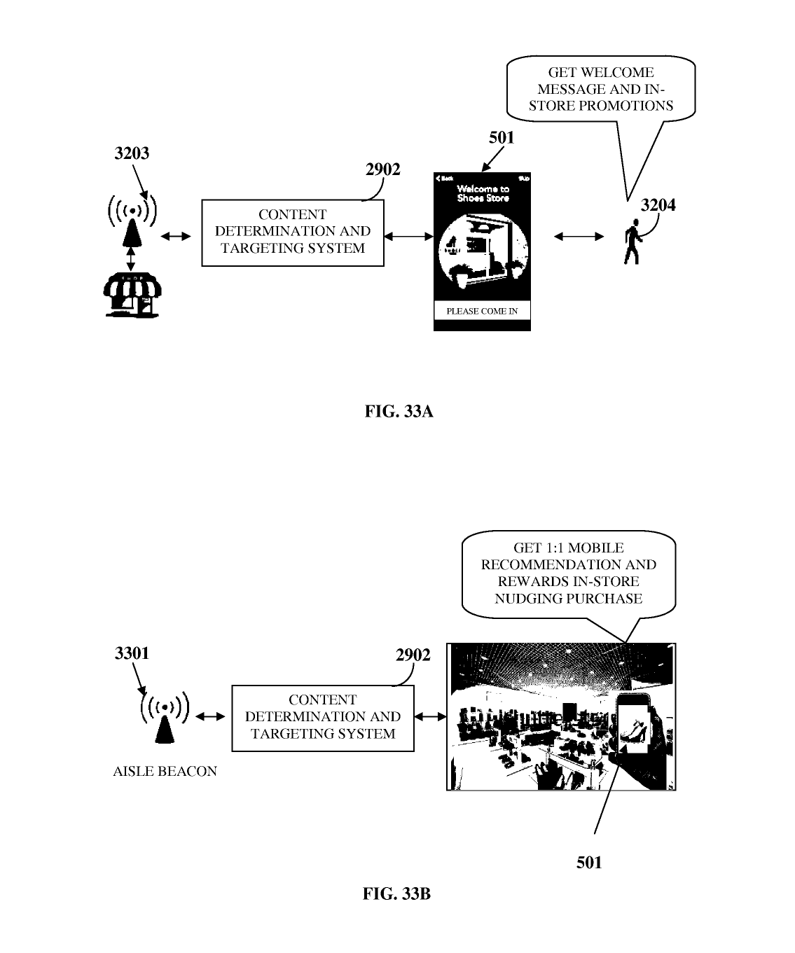

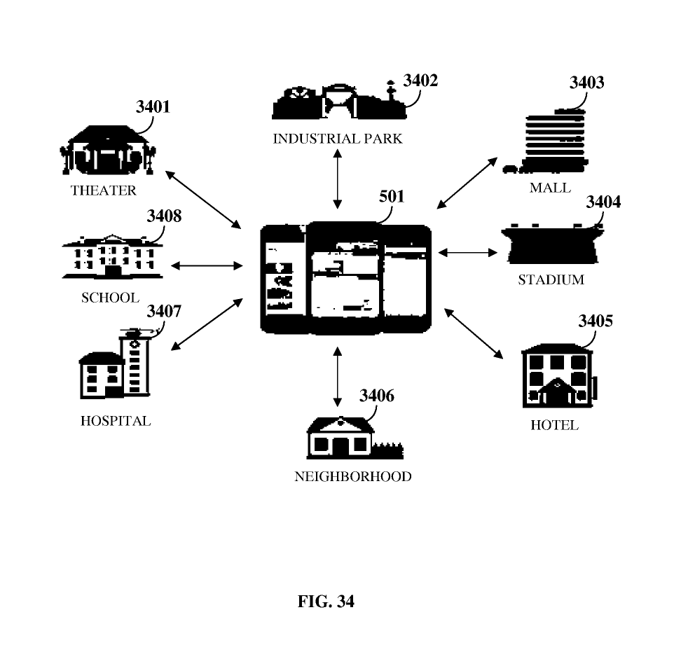

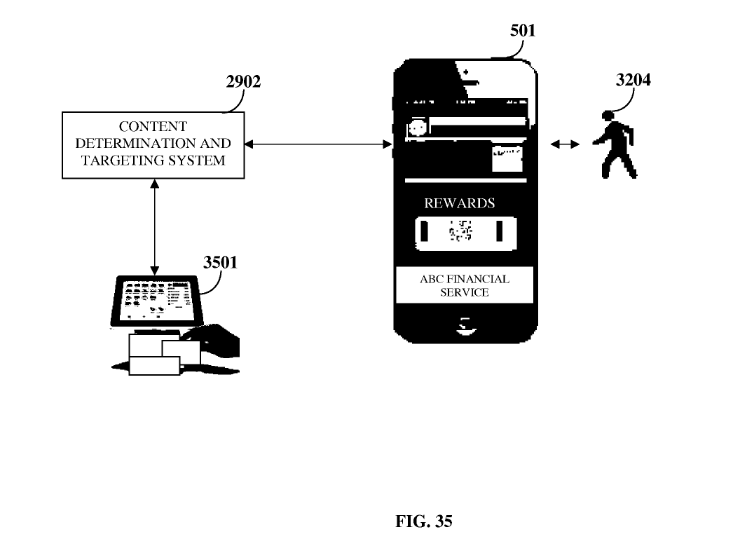

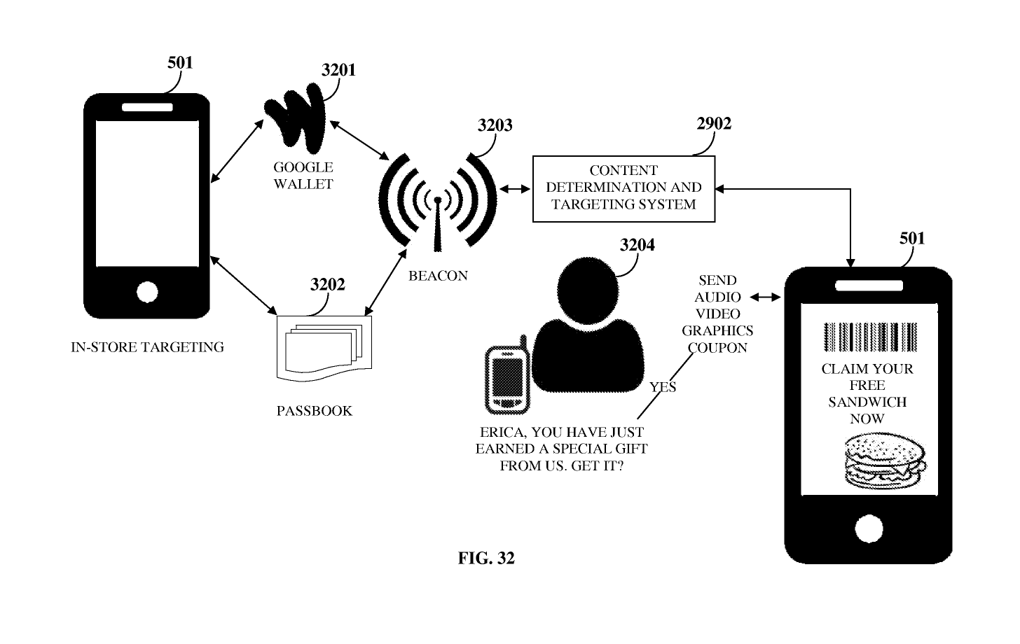

FIG. 32 exemplarily illustrates dynamic targeting of relevant content and services by the content determination and targeting system 2902 to a target user 3204 in a merchant store. The content determination and targeting system 2902 invokes, for example, personalized offers and services when a user 3204 is walking near an aisle based on an interaction of a user device 501 with devices of the merchant store such as a beacon 3203, Wi-Fi®, etc. In an example, in the case of grocery stores, the content determination and targeting system 2902 targets relevant content comprising, for example, relevant products and/or offers to users at the right time and at the right location via right channels based on buying patterns and algorithms implemented by the content determination and targeting system 2902.

Consider an example where a user 3204 named Erica is shopping in a grocery store. Erica has installed Google Wallet 3201 or Apple's Passbook 3202 in her mobile phone. When Erica passes by a food items aisle in the grocery store, the beacon 3203 in the grocery store identifies Erica's location through her mobile phone and transmits the location information to the content determination and targeting system 2902. The content determination and targeting system 2902 verifies Erica's user characteristic information stored in the data repository 1607 exemplarily illustrated in FIGS. 16-17 and FIG. 29, for identifying Erica as the target user 3204. The content determination and targeting system 2902 extracts data elements comprising, for example, latitude and longitude information, time information, etc., from the received location information to determine an exact location of Erica in the grocery store. The content determination and targeting system 2902 assigns a weight to the extracted data elements to prioritize triggering of relevant content and services to Erica based on the extracted time information. The content determination and targeting system 2902 queries the data repositories 1607 and 1611 exemplarily illustrated in FIGS. 16-18 and FIG. 29, for stored information associated with Erica's spending habits. The content determination and targeting system 2902 determines user interest dimensions for Erica for categorizing Erica in a cluster based on Erica's spending habits. The content determination and targeting system 2902 determines that Erica is a medium spending customer with a recurring purchasing probability for food items. Hence, the content determination and targeting system 2902 determines that Erica shops more frequently for food items.

The content determination and targeting system 2902 further analyzes item information associated with multiple food items such as burgers, sandwiches, cakes, etc., and generates a preliminary score for each food item by employing the K-means clustering algorithm. The content determination and targeting system 2902 generates a preliminary score of 66, 1005, and 8 for burgers, sandwiches, and cakes respectively based on recentness and frequency of purchases made by Erica for each food item. The content determination and targeting system 2902 normalizes the preliminary scores in a range, for example, from 0 to 100. In this example, the content determination and targeting system 2902 generates an item relevancy score for burgers, sandwiches, and cakes as 30, 80, and 10 respectively. The content determination and targeting system 2902 generates an item relevancy priority for burgers, sandwiches, and cakes as 100, 200, and 50. The content determination and targeting system 2902 determines that Erica's probability of purchasing an item at the grocery store is highest for sandwiches based on the generated item relevancy score and the generated item relevancy priority. The content determination and targeting system 2902 generates and associates relevant content with sandwiches by acquiring item information associated with sandwiches from an item catalog. A location trigger transmits a triggering notification to the recommendation engine 1109 of the content determination and targeting system 2902 exemplarily illustrated in FIG. 29, for targeting the generated relevant content in the form of a coupon to Erica's mobile phone immediately that can allow her to claim a free sandwich from the grocery store's fast food outlet.

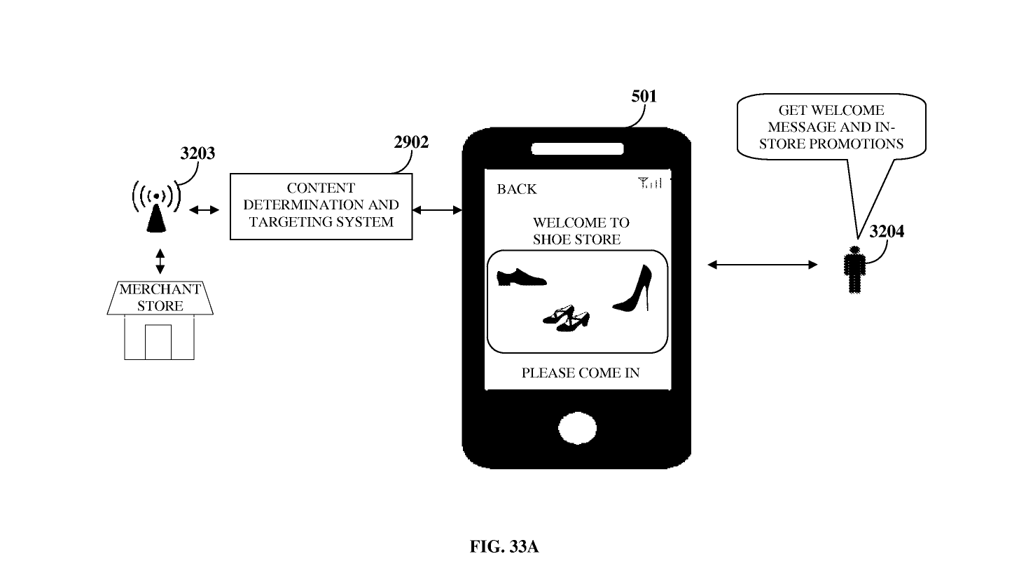

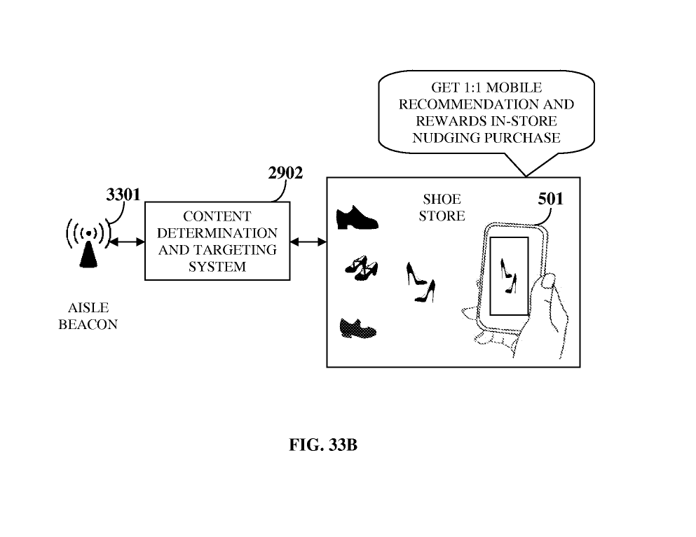

FIGS. 33A-33B exemplarily illustrate dynamic targeting of messages by the content determination and targeting system 2902 to a user 3204 in a merchant store. In an example, the content determination and targeting system 2902 exemplarily illustrated in FIG. 29, in communication with a beacon 3203 in the merchant store, triggers personalized welcome messages when the user 3204 enters the merchant store based on recommendations generated by the recommendation engine 1109 of the content determination and targeting system 2902 exemplarily illustrated in FIG. 29. For example, when a user 3204 enters a shoe store, the content determination and targeting system 2902 sends a welcome message displaying “Welcome to the Shoe Store” to the user's 3204 user device 501 as exemplarily illustrated in FIG. 33A. In another example, when the user 3204 enters a particular shoe aisle, the content determination and targeting system 2902 sends a purchase nudging message to the user 3204 as exemplarily illustrated in FIG. 33B, to encourage the user 3204 to buy shoes from that shoe aisle based on the user's 3204 location information received from a beacon 3301 of the shoe store that communicates with the user device 501.

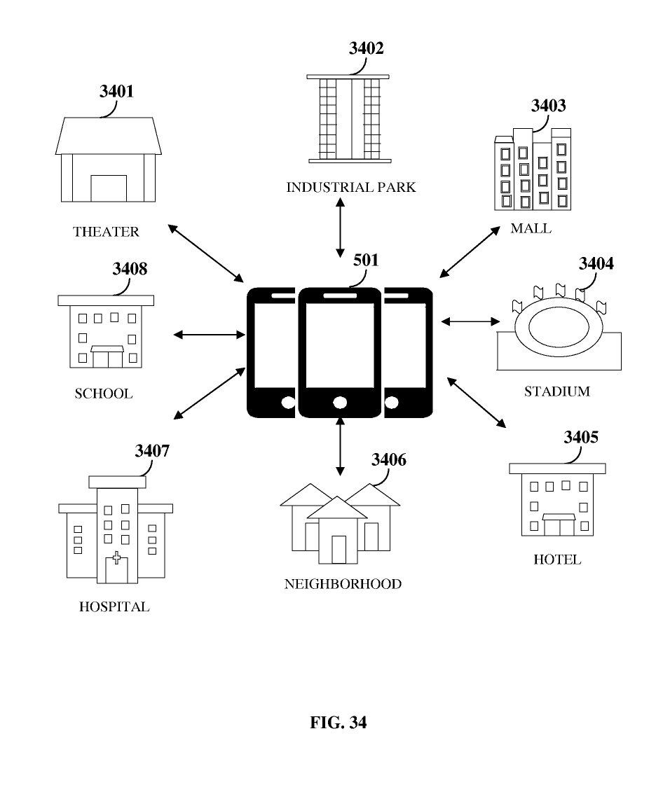

FIG. 34 exemplarily illustrates dynamic targeting of relevant content and services by the content determination and targeting system 2902 exemplarily illustrated in FIG. 29, to users to encourage a visit to merchant stores in their vicinity. The content determination and targeting system 2902 transmits relevant content associated with a target item and service information of services to users, for example, when they are driving around a merchant store, going closer to a competitive store, a theatre 3401, an industrial park 3402, a mall 3403, a stadium 3404, a hotel 3405, a neighborhood 3406, a hospital 3407, or a school 3408, or when they are at home webrooming via their user devices 501 based on the time of a day, location, and recommendations generated by the content determination and targeting system 2902.

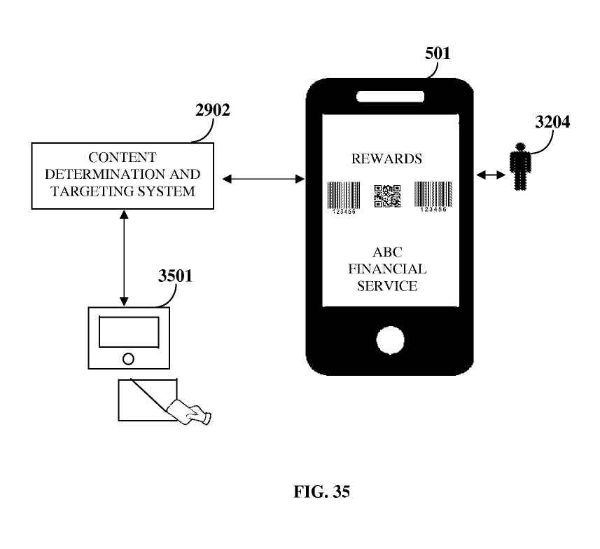

FIG. 35 exemplarily illustrates an implementation of the content determination and targeting system 2902 for encouraging users 3204 to purchase items recommended in the relevant content targeted to the users 3204. The content determination and targeting system 2902 transmits relevant content to the users 3204, for example, via geo-targeting, geo-conquest based targeting, beacon based targeting, Wi-Fi® based targeting, etc., to influence the users 3204 to convert the targeted relevant content and purchase items. The content determination and targeting system 2902 implements an end-to-end closed loop user path to facilitate purchasing of items recommended in the relevant content.

Consider an example where a user 3204 enters a shoe store. An owner of the shoe store has employed the content determination and targeting system 2902 for dynamically targeting time, event and inventory based, location-specific, and behavior relevant content and services to users 3204 in an omnichannel environment. The content determination and targeting system 2902 receives user characteristic information of users 3204, for example, customers at the shoe store, item information of all the items of the shoe store, and event information associated with the items that affect purchasing probability of the items at the shoe store from a point of sale (POS) database of the shoe store. The content determination and targeting system 2902 identifies one or more target users 3204 based on the received POS data. The content determination and targeting system 2902 extracts data elements such as number of visits made by each customer, frequency of visits made by each customer, etc., from the received POS data and assigns weights to each extracted data element. In an embodiment, the content determination and targeting system 2902 analyzes the received point of sale (POS) data in an ascending order of the assigned weights. The content determination and targeting system 2902 analyzes the received POS data, for example, based on discretionary or non-discretionary (DND) spending habits of customers of the shoe store. The content determination and targeting system 2902 generates a purchase periodicity score for each customer. The content determination and targeting system 2902 normalizes the generated purchase periodicity score to generate a DND score for each customer and generates an item relevancy priority for each customer. The item relevancy priority is a priority determined for each customer that defines an average amount of money spent by each customer on different categories of items. The content determination and targeting system 2902 receives content associated with items from an item catalog managed by the shoe store. The content determination and targeting system 2902 receives the content, for example, by performing keyword matching. The content determination and targeting system 2902 maps the received content with the identified target users 3204 and target items based on a content relevancy score assigned to the content associated with the identified target users 3204. The content determination and targeting system 2902 determines relevant content for each customer based on the generated content relevancy score and the generated content relevancy priority. The content determination and targeting system 2902 targets an offer to a customer to purchase shoe items from the shoe store in order to earn rewards that can be redeemed for future purchases at the shoe store. The content determination and targeting system 2902 generates a loyalty card for a user 3204 that the user 3204 can swipe at a point of sale (POS) machine 3501 to redeem the earned rewards.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Examples of programming languages that can be used comprise Objective-C®, C, C++, C#, Java®, JavaScript®, Fortran, Ruby, Perl®, Python®, Visual Basic®, hypertext preprocessor (PHP), Microsoft® .NET, Scala, database stored procedures, etc. Other object-oriented, functional, scripting, and/or logical programming languages may also be used. The computer program codes or software programs may be stored on or in one or more mediums as object code. Various aspects of the method and the content determination and targeting system 2902 disclosed herein exemplarily illustrated in FIG. 29, may be implemented in a non-programmed environment comprising documents created, for example, in a hypertext markup language (HTML), an extensible markup language (XML), or other format that render aspects of a graphical user interface (GUI) 2903 exemplarily illustrated in FIG. 29, or perform other functions, when viewed in a visual area or a window of a browser program. Various aspects of the method and the content determination and targeting system 2902 disclosed herein may be implemented as programmed elements, or non-programmed elements, or any suitable combination thereof. The computer program product disclosed herein comprises one or more computer program codes for implementing the processes of various embodiments.

Where databases are described such as the discretionary or non-discretionary database 901 exemplarily illustrated in FIG. 9, the item lifetime database 1001 exemplarily illustrated in FIG. 10, the data repositories 1607 and 1611 exemplarily illustrated in FIGS. 16-18 and FIG. 29, etc., it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the content determination and targeting system 2902, the databases may be integrated to communicate with each other for enabling simultaneous updates of data linked across the databases, when there are any updates to the data in one of the databases.

The method and the content determination and targeting system 2902 disclosed herein can be configured to work in a network environment comprising one or more computers that are in communication with one or more devices via a network 2901 exemplarily illustrated in FIG. 29. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to the network 2901. Each of the computers and the devices executes an operating system, examples of which are disclosed above. While the operating system may differ depending on the type of computer, the operating system provides the appropriate communications protocols to establish communication links with the network 2901. Any number and type of machines may be in communication with the computers.

The method and the content determination and targeting system 2902 disclosed herein are not limited to a particular computer system platform, processor, operating system, or network. One or more aspects of the method and the content determination and targeting system 2902 disclosed herein may be distributed among one or more computer systems, for example, servers configured to provide one or more services to one or more client computers, or to perform a complete task in a distributed system. For example, one or more aspects of the method and the content determination and targeting system 2902 disclosed herein may be performed on a client-server system that comprises components distributed among one or more server systems that perform multiple functions according to various embodiments. These components comprise, for example, executable, intermediate, or interpreted code, which communicate over a network 2901 using a communication protocol. The method and the content determination and targeting system 2902 disclosed herein are not limited to be executable on any particular system or group of systems, and is not limited to any particular distributed architecture, network, or communication protocol.

The foregoing examples have been provided merely for the purpose of explanation and are in no way to be construed as limiting of the method and the content determination and targeting system 2902 disclosed herein. While the method and the content determination and targeting system 2902 have been described with reference to various embodiments, it is understood that the words, which have been used herein, are words of description and illustration, rather than words of limitation. Further, although the method and the content determination and targeting system 2902 have been described herein with reference to particular means, materials, and embodiments, the method and the content determination and targeting system 2902 are not intended to be limited to the particulars disclosed herein; rather, the method and the content determination and targeting system 2902 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the content determination and targeting system 2902 disclosed herein in their aspects.

We claim:

1. A computer implemented method for dynamically targeting time, event and inventory based, location-specific, and behavior relevant content and services to users in an omnichannel environment, said method employing a content determination and targeting system comprising at least one processor configured to execute computer program instructions for performing said method, said method comprising:
dynamically receiving user characteristic information, item information of a plurality of items engaged by said users, and event information from a plurality of information sources in said omnichannel environment by said content determination and targeting system;
identifying one or more target users from said users for dynamically targeting said time, event and inventory based, location-specific, and behavior relevant content and said services by said content determination and targeting system using said dynamically received user characteristic information, said item information, and said event information;
analyzing said dynamically received user characteristic information, said item information, and said event information by said content determination and targeting system using one or more of a plurality of analytical parameters;
determining user intent dimensions, user interest dimensions, and global interest dimensions by said content determination and targeting system based on said analysis of said dynamically received user characteristic information, said item information, and said event information;
generating an item relevancy score and an item relevancy priority for each of said items by said content determination and targeting system based on said analysis of said dynamically received user characteristic information, said item information, said event information, said determined user intent dimensions, said determined user interest dimensions, and said determined global interest dimensions;
determining a target item from said items for dynamically targeting said time, event and inventory based, location-specific, and behavior relevant content and said services to said identified one or more target users by said content determination and targeting system based on said generated item relevancy score and said generated item relevancy priority of said each of said items;
generating and associating relevant content with said determined target item and determining service information of a plurality of said services to be provided to said identified one or more target users by said content determination and targeting system, in communication with one or more of a plurality of content sources;
generating a content relevancy score and a content relevancy priority for said generated relevant content associated with said determined target item based on said analysis of said dynamically received user characteristic information, said item information, said event information, said determined user intent dimensions, said determined user interest dimensions, and said determined global interest dimensions;
dynamically generating recommendations for dynamically targeting said generated relevant content associated with said determined target item and said determined service information of said services to said identified one or more target users by said content determination and targeting system based on said generated content relevancy score, said generated content relevancy priority, one or more of a plurality of targeting triggers, and said analysis of said dynamically received user characteristic information, said item information, and said event information using one or more of a plurality of content selection parameters; and
dynamically targeting said generated relevant content associated with said determined target item and said determined service information of said services to said identified one or more target users in said omnichannel environment by said content determination and targeting system based on said dynamically generated recommendations.

2. The computer implemented method of claim 1, further comprising extracting data elements from said dynamically received user characteristic information, said item information, and said event information and assigning a weight to each of said extracted data elements based on one or more of said content selection parameters by said content determination and targeting system.

3. The computer implemented method of claim 1, wherein said analytical parameters comprise a purchase activity predictability parameter, a purchase periodicity predictability parameter, an item lifetime predictability parameter, a predictability parameter based on one of a discretionary customer habit and a non-discretionary customer habit, a purchase behavior pattern predictability parameter, personal attributes, location attributes, and any combination thereof.

4. The computer implemented method of claim 1, wherein said content selection parameters comprise campaign goals, a campaign selection parameter, a location analysis parameter, an event analysis parameter, an inventory analysis parameter, a targeting history parameter, and any combination thereof.

5. The computer implemented method of claim 1, further comprising categorizing said users based on said analyzed user characteristic information, said analyzed item information, said analyzed event information, user feedback associated with said items received by said content determination and targeting system, said determined user intent dimensions, said determined user interest dimensions, and said determined global interest dimensions by said content determination and targeting system for said identification of said one or more target users for said dynamic targeting of said time, event and inventory based, location-specific, and behavior relevant content and said services.

6. The computer implemented method of claim 1, further comprising normalizing said generated item relevancy score and said generated item relevancy priority for said each of said items by said content determination and targeting system for facilitating said generation of said recommendations for said dynamic targeting of said generated relevant content associated with said determined target item and said determined service information of said services to said identified one or more target users.

7. The computer implemented method of claim 1, further comprising:
dynamically analyzing inventory information associated with said items stored in one or more inventory management systems by said content determination and targeting system;
regenerating said relevant content associated with said determined target item by said content determination and targeting system based on said dynamic analysis of said inventory information; and
updating said generated content relevancy score and said generated content relevancy priority for said regenerated relevant content associated with said determined target item by said content determination and targeting system for said dynamic generation of said recommendations for said dynamic targeting of said regenerated relevant content associated with said determined target item to said identified one or more target users.

8. The computer implemented method of claim 1, wherein said targeting triggers comprise time triggers, geolocation triggers, in-store triggers, manual target now triggers, user activity triggers, and any combination thereof.

9. The computer implemented method of claim 1, wherein said user characteristic information comprises user demographic information, user behavior, user preferences, user intent, user interests, location history, activity information associated with a plurality of user activities in said omnichannel environment, time information associated with said user activities, and any combination thereof.

10. The computer implemented method of claim 1, wherein said content comprises one or more of advertisements, offers, and promotional information associated with said items.

11. The computer implemented method of claim 1, wherein said information sources comprise user devices, a plurality of sensor devices, point of sale databases, electronic commerce platforms, social networking platforms, online activity databases, data repositories managed by said content determination and targeting system, one or more inventory management systems, and any combination thereof.

12. A content determination and targeting system for dynamically targeting time, event and inventory based, location-specific, and behavior relevant content and services to users in an omnichannel environment, said content determination and targeting system comprising:
a non-transitory computer readable storage medium configured to store computer program instructions defined by modules of said content determination and targeting system;
at least one processor communicatively coupled to said non-transitory computer readable storage medium, said at least one processor configured to execute said defined computer program instructions; and
said modules of said content determination and targeting system comprising:
a data communication module configured to dynamically receive user characteristic information, item information of a plurality of items engaged by said users, and event information from a plurality of information sources in said omnichannel environment;
a user identification module configured to identify one or more target users from said users for dynamically targeting said time, event and inventory based, location-specific, and behavior relevant content and said services using said dynamically received user characteristic information, said item information, and said event information;
an analytics engine configured to analyze said dynamically received user characteristic information, said item information, and said event information using one or more of a plurality of analytical parameters;
an intent and interest determination module configured to determine user intent dimensions, user interest dimensions, and global interest dimensions based on said analysis of said dynamically received user characteristic information, said item information, and said event information;
a scoring and prioritization module configured to generate an item relevancy score and an item relevancy priority for each of said items based on said analysis of said dynamically received user characteristic information, said item information, said event information, said determined user intent dimensions, said determined user interest dimensions, and said determined global interest dimensions;
an item determination module configured to determine a target item from said items for dynamically targeting said time, event and inventory based, location-specific, and behavior relevant content and said services to said identified one or more target users based on said generated item relevancy score and said generated item relevancy priority of said each of said items;
a content generation module configured to generate and associate relevant content with said determined target item and determine service information of a plurality of said services to be provided to said identified one or more target users, in communication with one or more of a plurality of content sources;
said scoring and prioritization module further configured to generate a content relevancy score and a content relevancy priority for said generated relevant content associated with said determined target item based on said analysis of said dynamically received user characteristic information, said item information, said event information, said determined user intent dimensions, said determined user interest dimensions, and said determined global interest dimensions;
a recommendation engine configured to dynamically generate recommendations for dynamically targeting said generated relevant content associated with said determined target item and said determined service information of said services to said identified one or more target users based on said generated content relevancy score, said generated content relevancy priority, one or more of a plurality of targeting triggers, and said analysis of said dynamically received user characteristic information, said item information, and said event information using one or more of a plurality of content selection parameters; and
a targeting engine configured to dynamically target said generated relevant content associated with said determined target item and said determined service information of said services to said identified one or more target users in said omnichannel environment based on said dynamically generated recommendations.

13. The content determination and targeting system of claim 12, further comprising a data processing module configured to extract data elements from said dynamically received user characteristic information, said item information, and said event information, and assign a weight to each of said extracted data elements based on one or more of said content selection parameters.

14. The content determination and targeting system of claim 12, wherein said analytical parameters comprise a purchase activity predictability parameter, a purchase periodicity predictability parameter, an item lifetime predictability parameter, a predictability parameter based on one of a discretionary customer habit and a non-discretionary customer habit, a purchase behavior pattern predictability parameter, personal attributes, location attributes, and any combination thereof.

15. The content determination and targeting system of claim 12, wherein said content selection parameters comprise campaign goals, a campaign selection parameter, a location analysis parameter, an event analysis parameter, an inventory analysis parameter, a targeting history parameter, and any combination thereof.

16. The content determination and targeting system of claim 12, wherein said user identification module is further configured to categorize said users based on said analyzed user characteristic information, said analyzed item information, said analyzed event information, user feedback associated with said items received by said data communication module, said determined user intent dimensions, said determined user interest dimensions, and said determined global interest dimensions for said identification of said one or more target users for said dynamic targeting of said time, event and inventory based, location-specific, and behavior relevant content and said services.

17. The content determination and targeting system of claim 12, wherein said scoring and prioritization module is further configured to normalize said generated item relevancy score and said generated item relevancy priority for said each of said items for facilitating said generation of said recommendations for said dynamic targeting of said generated relevant content associated with said determined target item and said determined service information of said services to said identified one or more target users.

18. The content determination and targeting system of claim 12, wherein said analytics engine is further configured to dynamically analyze inventory information associated with said items stored in one or more inventory management systems, and wherein said content generation module is further configured to regenerate said relevant content associated with said determined target item based on said dynamic analysis of said inventory information, and wherein said scoring and prioritization module is further configured to update said generated content relevancy score and said generated content relevancy priority for said regenerated relevant content associated with said determined target item for said dynamic generation of said recommendations for said dynamic targeting of said regenerated relevant content associated with said determined target item to said identified one or more target users.

19. The content determination and targeting system of claim 12, wherein said targeting triggers comprise time triggers, geolocation triggers, in-store triggers, manual target now triggers, user activity triggers, and any combination thereof.

20. The content determination and targeting system of claim 12, wherein said user characteristic information comprises user demographic information, user behavior, user preferences, user intent, user interests, location history, activity information associated with a plurality of user activities in said omnichannel environment, time information associated with said user activities, and any combination thereof.

21. The content determination and targeting system of claim 12, wherein said content comprises one or more of advertisements, offers, and promotional information associated with said items.

22. The content determination and targeting system of claim 12, wherein said information sources comprise user devices, a plurality of sensor devices, point of sale databases, electronic commerce platforms, social networking platforms, online activity databases, data repositories managed by said content determination and targeting system, one or more inventory management systems, and any combination thereof.

23. A computer program product comprising a non-transitory computer readable storage medium, said non-transitory computer readable storage medium storing computer program codes that comprise instructions executable by at least one processor, said computer program codes comprising:
a first computer program code for dynamically receiving user characteristic information, item information of a plurality of items engaged by users, and event information from a plurality of information sources in an omnichannel environment;
a second computer program code for identifying one or more target users from said users for dynamically targeting time, event and inventory based, location-specific, and behavior relevant content and services using said dynamically received user characteristic information, said item information, and said event information;
a third computer program code for analyzing said dynamically received user characteristic information, said item information, and said event information using one or more of a plurality of analytical parameters, wherein said analytical parameters comprise a purchase activity predictability parameter, a purchase periodicity predictability parameter, an item lifetime predictability parameter, a predictability parameter based on one of a discretionary customer habit and a non-discretionary customer habit, a purchase behavior pattern predictability parameter, personal attributes, location attributes, and any combination thereof;
a fourth computer program code for determining user intent dimensions, user interest dimensions, and global interest dimensions based on said analysis of said dynamically received user characteristic information, said item information, and said event information;
a fifth computer program code for generating an item relevancy score and an item relevancy priority for each of said items based on said analysis of said dynamically received user characteristic information, said item information, said event information, said determined user intent dimensions, said determined user interest dimensions, and said determined global interest dimensions;
a sixth computer program code for determining a target item from said items for dynamically targeting said time, event and inventory based, location-specific, and behavior relevant content and said services to said identified one or more target users based on said generated item relevancy score and said generated item relevancy priority of said each of said items;
a seventh computer program code for generating and associating relevant content with said determined target item and determining service information of a plurality of said services to be provided to said identified one or more target users, in communication with one or more of a plurality of content sources;
an eighth computer program code for generating a content relevancy score and a content relevancy priority for said generated relevant content associated with said determined target item based on said analysis of said dynamically received user characteristic information, said item information, said event information, said determined user intent dimensions, said determined user interest dimensions, and said determined global interest dimensions;
a ninth computer program code for dynamically generating recommendations for dynamically targeting said generated relevant content associated with said determined target item and said determined service information of said services to said identified one or more target users based on said generated content relevancy score, said generated content relevancy priority, one or more of a plurality of targeting triggers, and said analysis of said dynamically received user characteristic information, said item information, and said event information using one or more of a plurality of content selection parameters, wherein said content selection parameters comprise campaign goals, a campaign selection parameter, a location analysis parameter, an event analysis parameter, an inventory analysis parameter, a targeting history parameter, and any combination thereof; and
a tenth computer program code for dynamically targeting said generated relevant content associated with said determined target item and said determined service information of said services to said identified one or more target users in said omnichannel environment based on said dynamically generated recommendations.
